(19) United States
(12) Patent Application Publication
(10) Pub. No.: US 2005/0219229 A1
(43) Pub. Date: Oct. 6, 2005

(54) Image display device and method of driving image display device

(75) Inventor: Kazunori Yamaguchi, Kanagawa (JP)

Correspondence Address: RADER FISHMAN & GRAUER PLLC, LION BUILDING, 1233 20TH STREET N.W., SUITE 501, WASHINGTON, DC, 20036, US

(73) Assignee: Sony Corporation, Tokyo (JP)

(21) Appl. No.: 11/092,961

(22) Filed: Mar. 30, 2005

(30) Foreign Application Priority Data
Apr. 1, 2004 (JP) P2004-109323
Apr. 6, 2004 (JP) P2004-112518

(51) Int. Cl. G09G 5/00

(52) U.S. Cl. 345/173

(57) ABSTRACT

There is provided an image display device and a method of driving an image display device, which enable detecting an object position and the like without image degradation using a simple structure while ensuring convenience. The image display device includes: a plurality of light-emitting/photo-detection devices each having both light-emitting and photo-detection functions; light-emission driving section driving the light-emitting/photo-detection devices for light emission in accordance with image data; photo-detection driving section driving one or more light-emitting/photo-detection devices for photo-detection, other than a light-emitting/photo-detection device which is emitting light in accordance with the image data, so that the one or more light-emitting/photo-detection devices detect light emitted from the light-emitting/photo-detection device and reflected from a target object; and detecting section detecting the target object in accordance with one or more photo-detection signals obtained from the one or more light-emitting/photo-detection devices.

### CROSS REFERENCES TO RELATED APPLICATIONS

The present invention contains subject matter related to Japanese Patent Applications JP 2004-109323 filed in the Japanese Patent Office on Apr. 1, 2004, and JP 2004-112518 filed in the Japanese Patent Office on Apr. 6, 2004, the entire contents of which being incorporated herein by reference.

### BACKGROUND OF THE INVENTION

1. Field of the Invention

The invention relates to an image display device including the capability of detecting an object position and the like, and a method of driving an image display device.

2. Description of the Related Art

Techniques for detecting the position and other conditions of an object in contact with or in close proximity to a display device have been heretofore known. Of these techniques, representative and general techniques include a display device including a touch panel.

There are various types of touch panels. General types include the type of touch panel configured to sense capacitance. With the touch of a finger on the touch panel, this type of touch panel detects a change in surface charge of the panel, thereby detecting an object position and the like. This enables users to perform intuitive operation.

Recently, there have been also proposed various types of techniques for, without the use of the touch panels, detecting an object position and the like relative to a display device and thus enabling intuitive operation.

For example, Japanese Unexamined Patent Application Publication No. Hei 11-149348 discloses an infrared finger entry pointer device. Specifically, the pointer device includes a flat pad which permits finger movement thereon, and light-emitting and photo-detection devices for infrared or other light, which are arranged on one end of the flat pad. The pointer is controlled only by moving a finger.

### SUMMARY OF THE INVENTION

However, this technique has the problem of raising product cost, which is caused by a component count rising due to the need for input and other devices aside from a display device. The technique also has the problem of impairing intuitive operation, as compared to the display device including the touch panel.

Moreover, the display device including the touch panel has the problem of raising product cost, which is caused by a component count rising due to the attachment of the touch panel to a display screen. This display device also has the problem of image degradation, which is caused by a change in light, which occurs when the light from the display screen passes through the touch panel.

Furthermore, the general type of touch panel configured to sense capacitance, as mentioned above, has the problem of providing less-than-great convenience for users, because of detecting the position of only one point on the display screen at a time.

In other words, the techniques of the related art have the problem of having difficulty in detecting an object position and the like without image degradation using a simple structure while ensuring convenience.

The invention is designed to overcome the foregoing problems. It is desirable to provide an image display device and a method of driving an image display device, which enable detecting an object position and the like without image degradation using a simple structure while ensuring convenience.

According to an embodiment of the present invention, there is provided an image display device including a plurality of light-emitting/photo-detection devices each having both light-emitting and photo-detection functions; light-emission driving section driving the light-emitting/photo-detection devices for light emission in accordance with image data; photo-detection driving section driving one or more light-emitting/photo-detection devices for photo-detection, other than a light-emitting/photo-detection device which is emitting light in accordance with the image data, so that the one or more light-emitting/photo-detection devices detect light emitted from the light-emitting/photo-detection device and reflected from a target object; and detecting section detecting the target object in accordance with one or more photo-detection signals obtained from the one or more light-emitting/photo-detection devices.

According to an embodiment of the present invention, there is provided a method of driving an image display device including arranging a plurality of light-emitting/photo-detection devices each having both light-emitting and photo-detection functions; driving the light-emitting/photo-detection devices for light emission in accordance with image data; driving one or more light-emitting/photo-detection devices for photo-detection, other than a light-emitting/photo-detection device which is emitting light in accordance with the image data, so that the one or more light-emitting/photo-detection devices detect light emitted from the light-emitting/photo-detection device and reflected from a target object; and detecting the target object in accordance with one or more photo-detection signals obtained from the one or more light-emitting/photo-detection devices.

In the image display device and the method of driving an image display device according to an embodiment of the present invention, the light-emitting/photo-detection device emits light in accordance with image data. Another or other light-emitting/photo-detection devices detect light emitted from the light-emitting/photo-detection device and reflected from the target object, and output the photo-detection signal(s). The target object is detected in accordance with the photo-detection signal. A plurality of target objects may be detected in accordance with the photo-detection signal even when a plurality of target objects are placed simultaneously. As employed herein, the phrase “XX are placed simultaneously” refers to, for example, situations where a plurality of fingers are together in contact with or in close proximity to a display of the image display device.

According to an embodiment of the present invention, there is provided an image display device including a plurality of light-emitting devices; a plurality of photo-detection devices; light-emission driving section driving the light-emitting devices in accordance with image data; photo-detection driving section driving the photo-detection devices so as to detect light emitted from one or more light-emitting devices and reflected from a target object; and detecting section detecting the target object in accordance with one or more photo-detection signals obtained from one or more photo-detection devices.

According to an embodiment of the present invention, there is provided a method of driving an image display device including arranging a plurality of light-emitting devices and a plurality of photo-detection devices; driving the light-emitting devices in accordance with image data; driving the photo-detection devices so as to detect light emitted from one or more light-emitting devices and reflected from a target object; and detecting the target object in accordance with one or more photo-detection signals obtained from one or more photo-detection devices.

In the image display device and the method of driving an image display device according to an embodiment of the present invention, the light-emitting device emits light in accordance with image data. The photo-detection device detects light emitted from the light-emitting device and reflected from the target object, and outputs the photo-detection signal. The target object is detected in accordance with the photo-detection signal. A plurality of target objects may be detected in accordance with the photo-detection signal even when a plurality of target objects are placed simultaneously. As employed herein, the phrase “XX are placed simultaneously” refers to, for example, situations where a plurality of fingers are together in contact with or in close proximity to the display of the image display device.

The image display device according to an embodiment of the present invention may be configured to set a threshold according to the properties of the target object or the purpose of detection or accuracy of detection so as to detect the target object in forms according to these applications by comparing the photo-detection signal to the set threshold. As employed herein, the phrase “the properties of the target object” refers to, for example, the size of the object, the surface state thereof (e.g., reflectivity, a color, roughness, etc.), and so on. The phrase “the purpose of detection” refers to, for example, the detection of an object position, the detection of an object size, the detection of an object color, and so on. The phrase “the accuracy of detection” refers to detection resolution.

The image display device according to an embodiment of the present invention may be configured to determine the intensity of ambient light in accordance with one or more photo-detection signals, which are obtained when black display occurs in the absence of the target object near the light-emitting/photo-detection devices (or the photo-detection devices), so as to perform detection of the target object allowing for the effect of the ambient light. In this instance, detection of the target object does not depend on the effect of ambient light. As employed herein, the term “black display” refers to situations where all of the light-emitting/photo-detection devices (or the light-emitting devices) of the image display device emit light with the lowest brightness. The term “ambient light” refers to light with which the image display device is irradiated from all around, such as sunlight or light emitted from room lights.

The image display device according to an embodiment of the present invention may be configured to replace part of input image data with mark data for displaying a predetermined mark and thereby superimpose the image data so that one or more light beams emitted from one or more light-emitting/photo-detection devices (or one or more light-emitting devices) according to the mark data are detected by one or more light-emitting/photo-detection devices (or one or more photo-detection devices) located corresponding to the one or more light-emitting/photo-detection devices (or the one or more light-emitting devices) driven according to the mark data. In this instance, detection is performed as to whether or not the target object is close to the displayed mark. In this case, the image display device may be configured to move the mark when an image is displayed, or to move the mark according to movement of a picture pattern, for example. As employed herein, the term “input image data” refers to as-inputted yet-to-be-superimposed raw image data in the image display device. The term “mark data” refers to a mark represented by, for example, any graphic or character form, brightness, a color, and so on.

For example, the image display device according to an embodiment of the present invention may have the configuration in which the plurality of light-emitting/photo-detection devices (or the plurality of light-emitting devices and the plurality of photo-detection devices) are arranged to form a matrix so as to drive the light-emitting/photo-detection devices (or the light-emitting devices) in a line-sequential fashion, and so as to drive light-emitting/photo-detection devices other than the light-emitting/photo-detection devices which are emitting light (or the photo-detection devices) in a line-sequential fashion in synchronization with line-sequential light-emitting operation. As employed herein, the term “matrix” refers to situations where a matrix of a plurality of light-emitting/photo-detection devices (or a plurality of light-emitting devices and a plurality of photo-detection devices) is formed over the whole surface of the display of the image display device along the horizontal and vertical lines of the screen. Each of elements forming the matrix is referred to as a “picture element”. The terms “line-sequential light-emitting operation” and “line-sequential photo-detection operation” refer to operation modes in which the light-emitting/photo-detection devices (or the light-emitting devices and the photo-detection devices) included in picture elements for one horizontal line perform light-emitting operation and photo-detection operation in sequence for each horizontal line. Performing these operations throughout the display of the image display device allows displaying a screenful of image data and performing photo-detection for a screenful of picture elements.

In this case, the image display device according to an embodiment of the present invention may be configured to perform the line-sequential light-emitting operation and the line-sequential photo-detection operation in different timings or to perform these operations in the same timing. As employed herein, the term “the same timing” is not necessarily limited to physically strictly the same time but implies a time lag within acceptable limits.

The image display device and the method of driving an image display device according to an embodiment of the present invention is designed to arrange a plurality of light-emitting/photo-detection devices each having both light-emitting and photo-detection functions; drive the light-emitting/photo-detection devices in accordance with image data; drive one or more light-emitting/photo-detection devices, other than a light-emitting/photo-detection device which is emitting light in accordance with the image data, so that the one or more light-emitting/photo-detection devices detect light emitted from the light-emitting/photo-detection device and reflected from a target object; and detect the target object in accordance with one or more photo-detection signals obtained from the one or more light-emitting/photo-detection devices. Thus, the device and the method according to an embodiment of the present invention enable detecting an object position and the like without image degradation using a simple structure while ensuring convenience.

The image display device and the method of driving an image display device according to an embodiment of the present invention is designed to arrange a plurality of light-emitting devices and a plurality of photo-detection devices; drive the light-emitting devices in accordance with image data; drive the photo-detection devices so as to detect light emitted from one or more light-emitting devices and reflected from a target object; and detect the target object in accordance with one or more photo-detection signals obtained from one or more photo-detection devices. Thus, the device and the method of the second invention enable detecting an object position and the like without image degradation using a simple structure while ensuring convenience.

Other and further objects, features and advantages of the invention will appear more fully from the following description.

### BRIEF DESCRIPTION OF THE DRAWINGS

FIG. 1 is a block diagram showing the general configuration of an image display device according to a first embodiment of the invention;

FIG. 2 is a block diagram showing an example of the configuration of a display shown in FIG. 1;

FIG. 3 is a sectional view schematically illustrating an example of the arrangement of light-emitting/photo-detection cells of the display shown in FIG. 1;

FIG. 4 is a circuit diagram showing the configuration of the light-emitting/photo-detection cell shown in FIG. 2;

FIG. 5 is a schematic illustration showing an example of a process for detecting a target object, which is executed by the image display device shown in FIG. 1;

FIGS. 6A to 6C are illustrations showing an example of line-sequential light-emitting operation and line-sequential photo-detection operation, which are performed by the image display device shown in FIG. 1;

FIGS. 7A to 7E are timing charts of the process for detecting the target object, which is executed by the image display device shown in FIG. 1;

FIG. 8 is a block diagram showing the general configuration of an image display device according to a second embodiment of the invention;

FIGS. 9A to 9C are illustrations showing an example of line-sequential light-emitting operation and line-sequential photo-detection operation, which are performed by the image display device shown in FIG. 8;

FIGS. 10A to 10E are timing charts of a process for detecting the target object, which is executed by the image display device shown in FIG. 8;

FIG. 11 is a block diagram showing the general configuration of an image display device according to a modified example 1;

FIGS. 12A to 12E are timing charts of a process for detecting the target object, which is executed by the image display device shown in FIG. 11;

FIG. 13 is a block diagram showing the general configuration of an image display device according to a modified example 2;

FIGS. 14A to 14G are timing charts of a process for detecting the target object, which is executed by the image display device shown in FIG. 13;

FIG. 15 is a block diagram showing another example of the general configuration of the image display device according to the modified example 2;

FIG. 16 is an illustration showing an example of the distribution of the amount of photo-detection signal;

FIGS. 17A to 17C are schematic illustrations of the distribution of the amount of photo-detection signal shown in FIG. 16, showing situations where a threshold is set to varying values;

FIG. 18 is a block diagram showing the general configuration of an image display device according to a modified example 3;

FIGS. 19A to 19G are timing charts of a process for detecting the target object, which is executed by the image display device shown in FIG. 18;

FIG. 20 is a block diagram showing the general configuration of an image display device according to a modified example 4;

FIGS. 21A to 21D are schematic illustrations showing an example of a process for eliminating the effect of ambient light, which is executed by the image display device shown in FIG. 20;

FIGS. 22A to 22G are timing charts of the process for eliminating the effect of ambient light;

FIG. 23 is a block diagram showing the general configuration of an image display device according to a modified example 5;

FIG. 24 is a schematic illustration of the image display device shown in FIG. 23, illustrating detection of a plurality of objects placed simultaneously at arbitrary positions;

FIG. 25 is a schematic illustration of the image display device shown in FIG. 23, illustrating movements of predetermined marks;

FIG. 26 is a block diagram showing the general configuration of an image display device according to a third embodiment of the invention;

FIG. 27 is a block diagram showing an example of the configuration of a display shown in FIG. 26;

FIG. 28 is a plan view schematically showing an example of the arrangement of light-emitting cells and photo-detection cells of the display shown in FIG. 26;

FIG. 29 is a plan view schematically showing an example of the arrangement of light-emitting cells and photo-detection cells of the display shown in FIG. 26;

FIG. 30 is a plan view schematically showing an example of the arrangement of light-emitting cells and photo-detection cells of the display shown in FIG. 26;

FIG. 31 is a plan view schematically showing an example of the arrangement of light-emitting cells and photo-detection cells of the display shown in FIG. 26;

FIG. 32 is a sectional view schematically showing an example of the arrangement of light-emitting cells and photo-detection cells of the display shown in FIG. 26;

FIG. 33 is a sectional view schematically showing an example of the arrangement of light-emitting cells and photo-detection cells of the display shown in FIG. 26;

FIG. 34 is a sectional view schematically showing an example of the arrangement of light-emitting cells and photo-detection cells of the display shown in FIG. 26;

FIG. 35 is a circuit diagram showing the configuration of a light-emitting/photo-detection cell shown in FIG. 27;

FIG. 36 is a schematic illustration showing an example of a process for detecting a target object, which is executed by the image display device shown in FIG. 26;

FIG. 37 is an illustration showing an example of line-sequential light-emitting operation, which is performed by the image display device shown in FIG. 26;

FIG. 38 is an illustration showing an example of line-sequential light-emitting operation, which is performed by the image display device shown in FIG. 26;

FIG. 39 is an illustration showing an example of line-sequential light-emitting operation and line-sequential photo-detection operation, which are performed by the image display device shown in FIG. 26;

FIGS. 40A to 40E are timing charts of a process for detecting a target object, which is executed by the image display device shown in FIG. 26;

FIG. 41 is a block diagram showing the general configuration of an image display device according to a modified example 6;

FIGS. 42A to 42E are timing charts of a process for detecting a target object, which is executed by the image display device shown in FIG. 41;

FIG. 43 is a block diagram showing the general configuration of an image display device according to a modified example 7;

FIGS. 44A to 44E are timing charts of a process for detecting a target object, which is executed by the image display device shown in FIG. 43;

FIG. 45 is a block diagram showing the general configuration of an image display device according to a modified example 8;

FIGS. 46A to 46E are timing charts of a process for detecting a target object, which is executed by the image display device shown in FIG. 45;

FIG. 47 is a block diagram showing the general configuration of an image display device according to a modified example 9;

FIGS. 48A to 48F are timing charts of a process for detecting a target object, which is executed by the image display device shown in FIG. 47;

FIG. 49 is a block diagram showing the general configuration of an image display device according to a fourth embodiment of the invention;

FIG. 50 is a block diagram showing an example of the configuration of a display shown in FIG. 49;

FIG. 51 is a circuit diagram showing the configuration of a light-emitting/photo-detection cell shown in FIG. 50;

FIGS. 52A to 52D are timing charts of a process for detecting a target object, which is executed by the image display device shown in FIG. 49;

FIG. 53 is a block diagram showing the general configuration of an image display device according to a fifth embodiment of the invention;

FIG. 54 is a block diagram showing an example of the configuration of a display shown in FIG. 53;

FIG. 55 is a circuit diagram showing the configuration of a light-emitting/photo-detection cell shown in FIG. 54;

FIGS. 56A to 56D are timing charts of a process for detecting a target object, which is executed by the image display device shown in FIG. 53;

FIG. 57 is a block diagram showing the general configuration of an image display device according to a modified example 10;

FIGS. 58A to 58G are timing charts of a process for detecting a target object, which is executed by the image display device shown in FIG. 57;

FIG. 59 is a block diagram showing another example of the general configuration of the image display device according to the modified example 10;

FIG. 60 is a block diagram showing the general configuration of an image display device according to a modified example 11;

FIGS. 61A to 61G are timing charts of a process for detecting a target object, which is executed by the image display device shown in FIG. 60;

FIG. 62 is a block diagram showing the general configuration of an image display device according to a modified example 12;

FIGS. 63A to 63D are schematic illustrations showing an example of a process for eliminating the effect of ambient light, which is executed by the image display device shown in FIG. 62;

FIGS. 64A to 64G are timing charts of the process for eliminating the effect of ambient light; and

FIG. 65 is a block diagram showing the general configuration of an image display device according to a modified example 13.

### DETAILED DESCRIPTION OF THE PREFERRED EMBODIMENTS

Best modes for carrying out the invention (hereinafter referred to simply as an “embodiment”) will be described in detail below with reference to the drawings.

### First embodiment

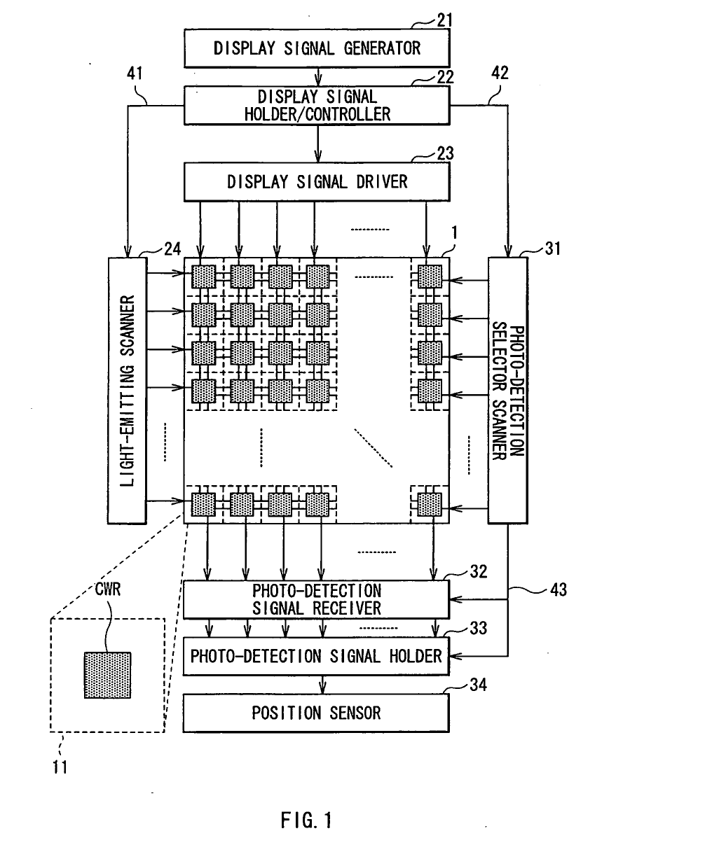

FIG. 1 shows the general configuration of an image display device according to a first embodiment of the invention.

The image display device of the first embodiment includes a display 1, a display signal generator 21, a display signal holder/controller 22, a display signal driver 23, a light-emitting scanner 24, a photo-detection signal selector scanner 31, a photo-detection signal receiver 32, a photo-detection signal holder 33, and a position sensor 34.

For example, the display 1 includes an organic or inorganic EL (electroluminescence) display or LCD (liquid crystal display) including a matrix of a plurality of picture elements 11 over the whole surface. The display 1 provides display of a predetermined graphic or character image or other images, while performing line-sequential operation as will be described later. Each picture element 11 includes a light-emitting/photo-detection cell CWR including one light-emitting/photo-detection device. Each picture element has both the function of light-emitting operation and the function of photo-detection operation, as will be described later.

Upon receipt of feed of data generated by a CPU (central processing unit) or the like (not shown), the display signal generator 21 generates a display signal for, for example, each frame (or each field), based on the fed data. The display signal generator 21 outputs the display signal to the display signal holder/controller 22.

The display signal holder/controller 22 has both the functions of holding and controlling as given below. Upon receipt of the display signal outputted by the display signal generator 21, the display signal holder/controller 22 stores and holds the display signal for each frame (or each field) in a field memory including an SRAM (static random access memory) or the like, for example. The display signal holder/controller 22 also controls the light-emitting scanner 24, the display signal driver 23, and the photo-detection signal selector scanner 31 so that they operate in conjunction with one another. Incidentally, the scanner 24 and the driver 23 act to drive each light-emitting/photo-detection cell CWR for light emission, and the scanner 31 acts to drive each cell CWR for photo-detection. Specifically, the display signal holder/controller 22 outputs a light-emission timing control signal 41 and a photo-detection timing control signal 42 to the light-emitting scanner 24 and the photo-detection signal selector scanner 31, respectively. The display signal holder/controller 22 also outputs a display signal for one horizontal line to the display signal driver 23 in accordance with a control signal and the display signal held in the field memory. These control and display signals allow line-sequential operation, as will be described later.

The light-emitting scanner 24 has the function of selecting the light-emitting/photo-detection cell CWR to be driven for light emission in accordance with the light-emission timing control signal 41 outputted by the display signal holder/controller 22. As will be specifically described later, the light-emitting scanner 24 controls a first switch by feeding a select signal via a light-emitting gate line connected to each picture element 11 of the display 1. Specifically, when the select signal is fed to apply a voltage to turn on the first switch of a picture element, the picture element performs light-emitting operation with brightness according to the voltage fed from the display signal driver 23.

The display signal driver 23 has the function of feeding display data to the light-emitting/photo-detection cell CWR to be driven for light emission in accordance with the display signal for one horizontal line outputted by the display signal holder/controller 22. As will be specifically described later, the display signal driver 23 feeds a voltage for the display data to the picture element 11 selected by the light-emitting scanner 24 as mentioned above, via a data feed line connected to each picture element 11 of the display 1. The light-emitting scanner 24 and the display signal driver 23 operate in conjunction with each other to perform line-sequential operation, so that the display 1 provides display of an image corresponding to any display data.

The photo-detection signal selector scanner 31 has the function of selecting as given below. The photo-detection signal selector scanner 31 selects the light-emitting/photo-detection cell CWR to be driven for photo-detection by switching the driving mode of the cell CWR between light emission mode and photo-detection mode in accordance with the photo-detection timing control signal 42 outputted by the display signal holder/controller 22. As will be specifically described later, the photo-detection signal selector scanner 31 controls second and third switches by feeding a switch signal via a switch line connected to each picture element 11 of the display 1. Specifically, the switch signal is fed to apply a voltage to turn off the second switch, of a picture element, which is selected for light-emission driving, and moreover, the switch signal is fed to apply a voltage to turn on the third switch, of the picture element, which is selected for photo-detection driving. As a result, a photo-detection signal detected by the picture element is outputted to the photo-detection signal receiver 32. Thus, a different light-emitting/photo-detection cell CWR can detect light emitted from a light-emitting/photo-detection cell CWR and reflected from an object in contact with or in close proximity to the display device. The photo-detection signal selector scanner 31 also has the function of controlling as given below. The photo-detection signal selector scanner 31 outputs a photo-detection block control signal 43 to the photo-detection signal receiver 32 and the photo-detection signal holder 33 so as to control these blocks which contribute to photo-detection operation.

The photo-detection signal receiver 32 has the function of obtaining the photo-detection signal for one horizontal line outputted by each light-emitting/photo-detection cell CWR in accordance with the photo-detection block control signal 43 outputted by the photo-detection signal selector scanner 31. The photo-detection signal receiver 32 outputs the obtained photo-detection signal for one horizontal line to the photo-detection signal holder 33.

The photo-detection signal holder 33 has the following function. Upon receipt of the photo-detection signal outputted by the photo-detection signal receiver 32, the photo-detection signal holder 33 reconfigures the photo-detection signal to form a photo-detection signal for each frame (or each field) in accordance with the photo-detection block control signal 43 outputted by the photo-detection signal selector scanner 31. The photo-detection signal holder 33 then stores and holds the photo-detection signal for each frame (or each field) in a field memory including an SRAM or the like, for example. The photo-detection signal holder 33 outputs the stored photo-detection signal data to the position sensor 34. Incidentally, the photo-detection signal holder 33 may include any storage device other than the memory. For example, the photo-detection signal holder 33 can hold the photo-detection signal data as analog data. Hereinafter, it is understood that the photo-detection signal is held as analog data unless otherwise specified in the first embodiment.

The position sensor 34 has the following function. The position sensor 34 determines where an object detected by the light-emitting/photo-detection cell CWR is situated, by performing signal processing based on the photo-detection signal data outputted by the photo-detection signal holder 33. This makes it possible to determine the position of an object in contact with or in close proximity to the display device. When the photo-detection signal holder 33 stores the photo-detection signal data as analog data as mentioned above, the position sensor 34 performs signal processing after performing analog-to-digital conversion (hereinafter referred to as “A/D conversion”).

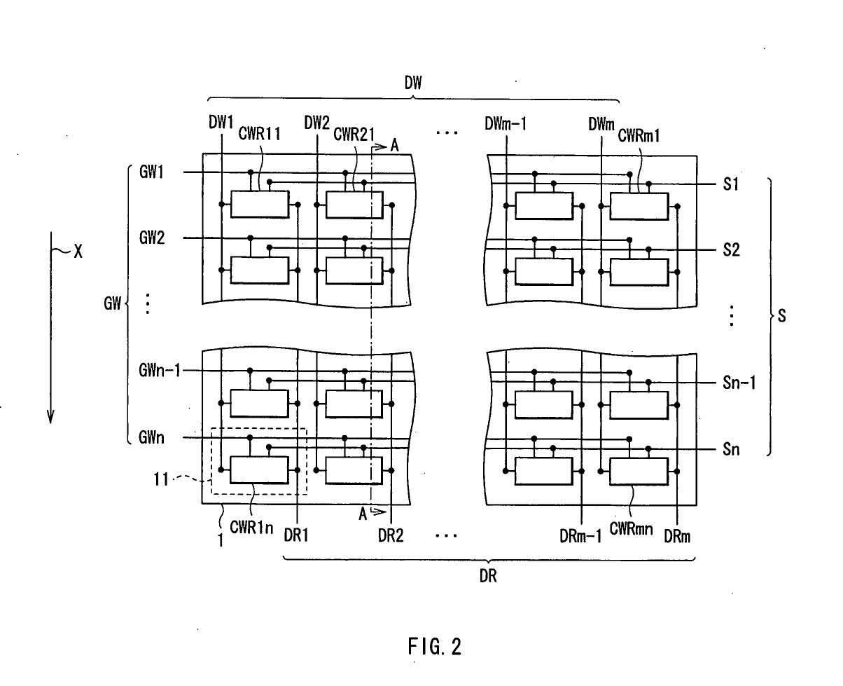

FIG. 2 shows an example of the configuration of the display 1 shown in FIG. 1. The display 1 is configured to have a matrix with a total of (m×n) picture elements 11, in which m picture elements 11 are arranged along each horizontal line and n picture elements 11 are arranged along each vertical line. For example when the display 1 is based on XGA (eXtended Graphics Array) standards which are general standards for displays for PCs (personal computers) and the like, the display 1 has a matrix with a total of 2,359,296 picture elements, in which m(=1024×3(RGB)) picture elements are arranged along each horizontal line and n(=768) picture elements are arranged along each vertical line.

As shown in FIG. 2, the display 1 includes a total of (m×n) picture elements 11, light-emitting/photo-detection cells CWR11 to CWRmn as mentioned above, each of which is included in the picture element 11, m data feed lines DW (DW1 to DWm) and m data read lines DR (DR1 to DRm) which are connected to the corresponding number of picture elements 11, and n light-emitting gate lines GW (GW1 to GWn) and n switch lines S (S1 to Sn) which are connected to the corresponding number of picture elements 11.

The data feed line DW, the data read line DR, the light-emitting gate line GW and the switch line S are connected to the display signal driver 23, the photo-detection signal receiver 32, the light-emitting scanner 24 and the photo-detection signal selector scanner 31 so that the display, select and switch signals are fed to each light-emitting/photo-detection cell CWR and that the photo-detection signal is outputted by each light-emitting/photo-detection cell CWR. As shown in FIG. 2, one each of the data feed line DW, the data read line DR, the light-emitting gate line GW and the switch line S is connected to each light-emitting/photo-detection cell CWR. For example, one data feed line DW1 and one data read line DR1 are common and connected to the light-emitting/photo-detection cells from CWR11 to CWR1n belonging to one vertical line. For example, one light-emitting gate line GW and one switch line S are common and connected to the light-emitting/photo-detection cells from CWR11 to CWRm1 belonging to one horizontal line. Incidentally, the arrow X of FIG. 2 indicates the scan direction of the light-emitting gate line GW and the switch line S, as will be described later.

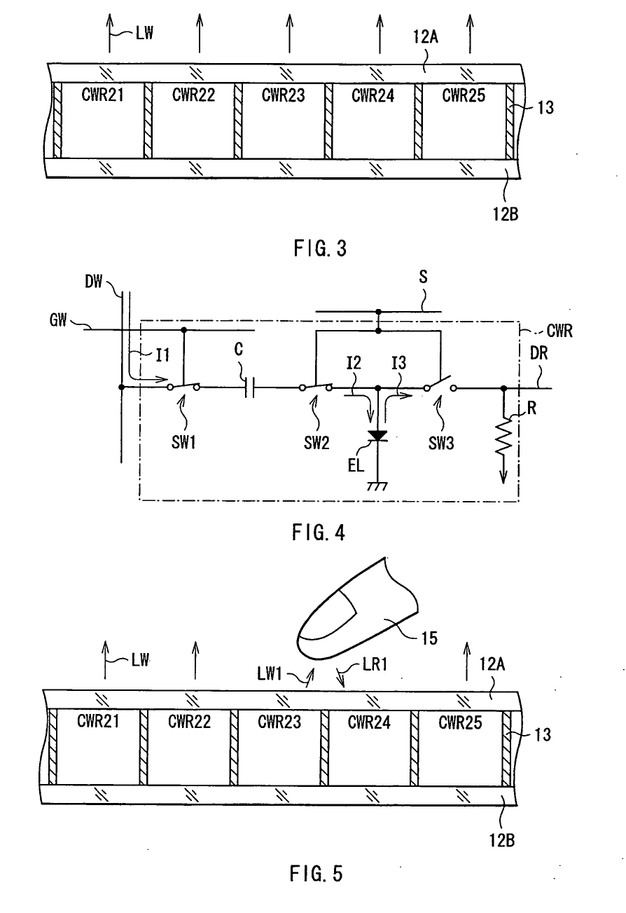

FIG. 3 schematically illustrates, in sectional view, an example of the arrangement of the light-emitting/photo-detection cell CWR of the display 1 shown in FIG. 1. In the example of FIG. 3, the light-emitting/photo-detection device included in the light-emitting/photo-detection cell CWR is an organic EL device, and an organic EL layer is sandwiched in between a pair of transparent substrates. In FIG. 3, the reference character i indicative of the position represents a given natural number. For example when the display is based on XGA standards as previously set forth (m=1024×3(RGB), n=768), i=1536 for, for instance, a vertical line at the center of the display.

The sectional view of FIG. 3 corresponds to a vertical section of the display 1, taken along the arrowed line A-A of FIG. 2 and viewed in the direction of the arrow A. The display 1 includes a pair of transparent substrates 12A and 12B, and a plurality of light-emitting/photo-detection cells CWR (CWR21, CWR22, CWR23, CWR24, CWR25, and so on) which are sandwiched in between the transparent substrates 12A and 12B and separated from one another by partitions 13 as mentioned above. The light-emitting/photo-detection cell CWR includes the organic EL device which acts as the light-emitting/photo-detection device, as described above. In FIG. 3, there is also shown light LW emitted from the light-emitting/photo-detection device included in each light-emitting/photo-detection cell CWR. Incidentally, other layers of a general organic EL display are not shown but omitted in FIG. 3. Hereinafter, the same goes for FIG. 5.

The arrangement of the light-emitting/photo-detection cell CWR of the display 1 according to the first embodiment is not limited to the arrangement shown in the sectional view of FIG. 3 but may be any other arrangement. In the example shown in the sectional view of FIG. 3, a light-emitting/photo-detection device EL includes the organic EL device. However, the light-emitting/photo-detection device may include any other device, provided that the device has the function of light emission and the function of photo-detection. For example, the light-emitting/photo-detection device may include an LED (light emitting diode) device or the like.

FIG. 4 shows the circuit configuration of the light-emitting/photo-detection cell CWR shown in FIG. 2.

The light-emitting/photo-detection cell CWR is configured to include one light-emitting/photo-detection device EL and to have connections to the light-emitting gate line GW, the data feed line DW, the switch line S and the data read line DR. In other words, the light-emitting/photo-detection cell CWR has an added gate line and an added data line for use in photo-detection, as compared to a cell for one picture element, including a typical light-emitting device. The light-emitting/photo-detection cell CWR also includes one light-emitting/photo-detection device EL, a capacitor C, a resistor R, a first switch SW1 which provides selective conduction between the data feed line DW and one end of the capacitor C in accordance with the select signal fed via the light-emitting gate line GW, a second switch SW2 which provides selective conduction between the other end of the capacitor C and one end of the light-emitting/photo-detection device EL in accordance with the switch signal fed via the switch line S, and a third switch SW3 which provides selective conduction between one end of the light-emitting/photo-detection device EL and the data read line DR in accordance with the switch signal fed via the switch line S as in the case of the second switch SW2. The other end of the light-emitting/photo-detection device EL is grounded. One end of the resistor R is connected to the data read line DR, and the other end of the resistor R is grounded or connected to a negative bias point (not shown).

The specific description is now given with regard to how each component operates for light-emitting operation and photo-detection operation. Firstly, the properties of the light-emitting/photo-detection device EL, as given below, are exploited for the light-emitting and photo-detection operations. Specifically, the light-emitting/photo-detection device of the first embodiment, such as the organic EL device or LED device, has the properties of emitting light upon application of a forward bias and the properties of detecting light and producing a current upon application of a reverse bias. Thus, it is difficult for the light-emitting/photo-detection device EL to perform the light-emitting and photo-detection operations simultaneously and it is necessary to be time-shared in order to perform both the operations, as will be described later.

The light-emitting operation involves turning on the first and second switches SW1 and SW2 and turning off the third switch SW3 in accordance with the select signal fed via the light-emitting gate line GW and the switch signal fed via the switch line S as described above; applying a forward bias to the light-emitting/photo-detection device EL; charging the capacitor C by feeding a current along a path I1 via the data feed line DW; and feeding a current through the light-emitting/photo-detection device EL along a path I2, thereby emitting light with brightness according to the display signal.

The photo-detection operation involves turning off the second switch SW2 and turning on the third switch SW3 in accordance with the switch signal fed via the switch line S as described above; applying a reverse bias to the light-emitting/photo-detection device EL; and feeding a current to the data read line DR along a path I3 according to the amount of light detected by the light-emitting/photo-detection device EL. When neither of the light-emitting and photo-detection operations takes place, all of the first, second and third switches SW1, SW2 and SW3 are off so that the data feed line DW and the data read line DR are disconnected from the light-emitting/photo-detection device EL. Incidentally, the resistor R connected to the data read line DR has the function of producing a potential difference across the resistor R according to the current fed to the data read line DR along the path I3 as mentioned above, thereby outputting the photo-detection signal.

Next, the description is given with regard to how the image display device configured as mentioned above operates to detect an object in contact with or in close proximity to the display device.

Firstly, the description is given with reference to FIG. 5 with regard to how the image display device configured as mentioned above operates to detect an object in contact with or in close proximity to the display device. FIG. 5 shows an example of a process for detecting a target object, which is executed by the image display device shown in FIG. 1. FIG. 5 corresponds to FIG. 3 showing the example of the structure in which the light-emitting/photo-detection cells CWR, each of which includes the organic EL device which is the light-emitting/photo-detection device, are separated by the partitions 13. In FIG. 5, the same structural components as the components shown in FIG. 3 are designated by the same reference characters, and the description of the same components is appropriately omitted.

As shown in FIG. 5, for example when a target object 15 such as a finger is brought into contact or close proximity with the display 1, light LW1 emitted from the light-emitting/photo-detection cell CWR23, for example, is reflected by the target object 15. In this case, a light-emitting/photo-detection device is incapable of detecting reflected light while emitting light, because the light-emitting/photo-detection device EL must be time-shared to perform the light-emitting and photo-detection operations as previously set forth. Thus, light emitted from the light-emitting/photo-detection device belonging to a horizontal line can be detected by performing the photo-detection operation by applying a reverse bias to the light-emitting/photo-detection device belonging to a different horizontal line. For example, reflected light LR1 enters into the light-emitting/photo-detection cell, such as CWR24 or CWR25, belonging to the horizontal line located near the light-emitting/photo-detection cell CWR23, but the reflected light does not enter into the light-emitting/photo-detection cell belonging to the horizontal line located far away from the light-emitting/photo-detection cell CWR3. Thus, the photo-detection signal is obtained from only the light-emitting/photo-detection cell CWR located near a target object 15. For example, driving is performed in such timing that light, which is emitted from the light-emitting/photo-detection cell CWR belonging to the horizontal line driven for light emission and is reflected from the target object 15, is detected by the light-emitting/photo-detection device belonging to the horizontal line adjacent to the horizontal line which is emitting the light. The photo-detection signal is detected by the light-emitting/photo-detection device belonging to the horizontal line close to the target object 15, whereas the photo-detection signal is not detected in the other regions. This makes it possible to sense where the target object 15 is situated on the display 1. Sequential execution of such light-emission driving and photo-detection driving for each horizontal line (hereinafter referred to as “line-sequential driving”) enables detecting the target object 15 while displaying an image throughout the display 1.

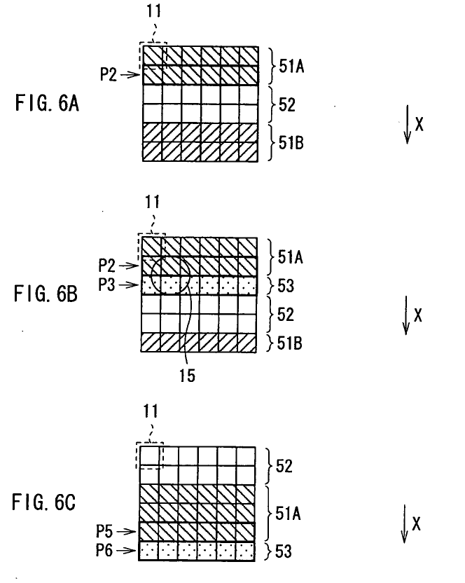

FIGS. 6A to 6C show an example of line-sequential light-emitting operation and line-sequential photo-detection operation, which are performed by the image display device shown in FIG. 1. Each of squares shown in FIGS. 6A to 6C represents the picture element 11 of the display 1.

In the example of line-sequential light-emitting operation shown in FIG. 6A, one horizontal line at the position indicated by the arrow P2, for example, performs light-emitting operation in sequence in the scan direction X. In this example, one horizontal line at the position indicated by the arrow P2 is kept in a light-emitting state until a given time elapses after rendering of display data on a screen, that is, during a given period of time before next image data is fed by the display signal driver 23. Thus, the overall display 1 is divided into light-emitting regions 51A and 51B and a non-emitting region 52. In this instance, when one horizontal line at the position indicated by the arrow P2 performs line-sequential light-emitting operation, the whole or great part of the display 1 can act as the light-emitting region to display image data throughout the display 1 within the given time during which the horizontal line is kept in the light-emitting state. The time period during which the horizontal line is kept in the light-emitting state is determined by, for example, the capacitance value of the capacitor C in the circuit configuration of the light-emitting/photo-detection cell CWR shown in FIG. 4, and the time period can be optionally set. In the example shown in FIG. 6A, the non-emitting region 52 is present in the display 1. However, the presence of the non-emitting region 52 presents no problem, because the non-emitting region 52 also moves in a line-sequential fashion and is not visually identified due to the effect of an afterimage phenomenon.

In the example of line-sequential light-emitting operation and line-sequential photo-detection operation shown in FIGS. 6B and 6C, one horizontal line at the position indicated by each of the arrows P2 and P5, for example, performs light-emitting operation in sequence in the scan direction X. Moreover, one horizontal line at the position indicated by each of the arrows P3 and P6 performs line-sequential photo-detection operation in the scan direction X so as to detect light emitted from the light-emitting region 51A and reflected from the target object 15. As mentioned above, one horizontal line performs line-sequential light-emitting operation, and one adjacent horizontal line always performs line-sequential photo-detection operation to detect light emitted from the light-emitting region and reflected from the target object. Thus, the whole display 1 can act as both the light-emitting and photo-detection regions to allow not only displaying image data throughout the display 1, but also detecting the presence or absence of the target object 15 close to the display 1 and detecting the position of the target object 15 if the target object 15 is present, in accordance with the photo-detection signal detected by the photo-detection device. Also in this instance, light-emitting operation is maintained until a given time elapses after rendering of display data on the screen, that is, during a given period of time before next photo-detection operation. Thus, the overall display 1 is divided into the light-emitting regions 51A and 51B and the non-emitting region 52.

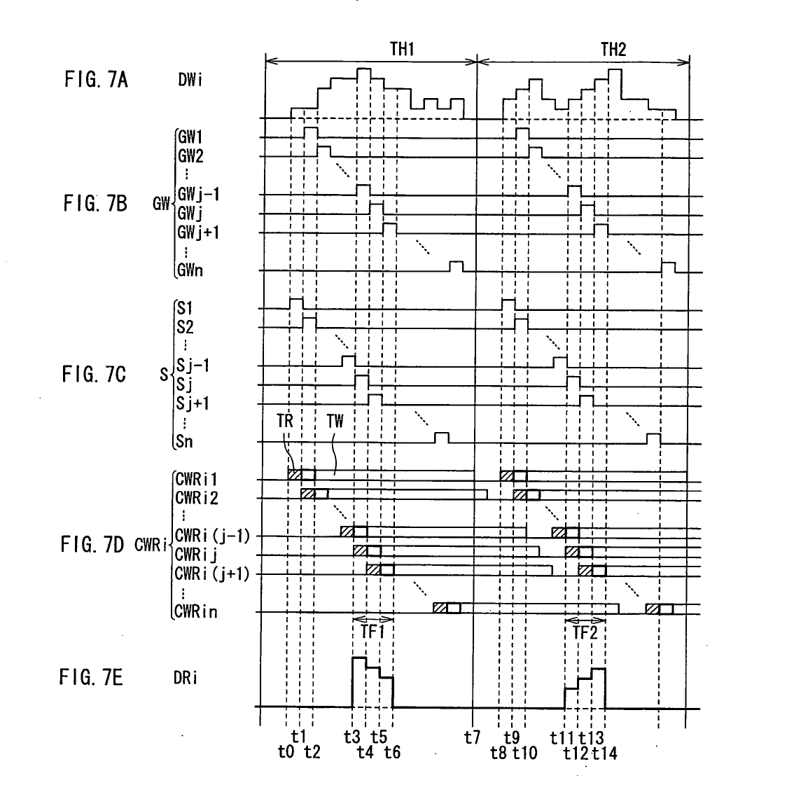

Next, the description is given with reference to FIGS. 2, 4, 5 and 7A to 7E with regard to the details of the process for detecting the target object 15, which is executed by the image display device shown in FIG. 1. FIGS. 7A to 7E show the process for detecting the target object 15, which is executed by the image display device shown in FIG. 1. FIG. 7D shows one vertical line of light-emitting/photo-detection cells CWRi (CWRi1 to CWRin). FIG. 7A shows a signal on a data feed line DWi connected to the cells CWRi. FIG. 7B shows signals on light-emitting gate lines GW (GW1 to GWn) connected to the cells CWRi. FIG. 7C shows signals on switch lines S (S1 to Sn) connected to the cells CWRi. FIG. 7E shows a signal on a data read line DRi connected to the cells CWRi. In FIGS. 7A to 7E, each of the reference characters i and j indicating the position represents a given natural number. For example when the display is based on XGA standards as previously set forth (m=1024×3(RGB), n=768), i=1536 and j=384 for, for instance, the center of the display. The same goes for the following timing charts.

In FIGS. 7A to 7E, the horizontal axis indicates time, and vertical periods TH1 and TH2 represent the time required to scan the whole screen of the display 1, specifically the time required for the light-emitting scanner 24 and the photo-detection signal selector scanner 31 to scan the light-emitting gate lines GW1 to GWn and the switch lines S1 to Sn, respectively. Assuming that the target object 15 is situated near the light-emitting/photo-detection cells CWRij, CWRi(j+1) and CWRi(j+2) of the display 1, the photo-detection signal is detected during the corresponding time period, specifically a time period between time t3 and t6 in the vertical period TH1 (i.e., a photo-detection signal detection period TF1), and the photo-detection signal is detected during a photo-detection signal detection period TF2 in the vertical period TH2. In FIGS. 7A to 7C and 7E, the vertical axis indicates the voltage of each signal shown in FIGS. 7A to 7C and 7E at each time. In this instance, the signal on the data feed line DWi shown in FIG. 7A is display data corresponding to any brightness for each picture element 11, and thus the display 1 provides display of any image. In FIG. 7D, there are shown a light-emission period TW and a photo-detection period TR of each light-emitting/photo-detection cell CWRi. Any time period other than the light-emission period TW and the photo-detection period TR is an inactive period. In the light-emission period TW, an initial section (shown by the thick lines) is a time period during which driving for light emission takes place based on image data (i.e., a time period during which the first switch SW1 shown in FIG. 4 is on), and any time period other than this time period is a time period during which the light-emitting state is maintained by the capacitor C shown in FIG. 4.

In this instance, the signal on the data read line DRi shown in FIG. 7E is stored as analog data in the photo-detection signal holder 33. However, the signal may be stored as digital data in the photo-detection signal holder 33, as previously set forth.

First, none of the light-emitting gate lines GW and switch lines S provides output of the select signal. Thus, all of the first, second and third switches SW1, SW2 and SW3 of each light-emitting/photo-detection cell CWR are off, so that the data feed line DW and the data read line DR are disconnected from the light-emitting/photo-detection device EL. Thus, during this time period, each light-emitting/photo-detection cell CWR is in an inactive state.

At time to, the switch line S1 (see FIG. 7C) provides output of the switch signal. Thus, the third switches SW3 of the light-emitting/photo-detection cells from CWR1 1 to CWRm1 connected to the switch line S1 are turned on at a time, so that photo-detection operation occurs in these light-emitting/photo-detection cells. The first and second switches SW1 and SW2 of these light-emitting/photo-detection cells remain off. During the photo-detection period TR shown in FIG. 7D, the light-emitting/photo-detection cell CWRi (see FIG. 7D) performs the photo-detection operation by feeding a current to the data read line DRi (see FIG. 7E) along the path I3 according to the amount of light detected by the light-emitting/photo-detection device EL shown in FIG. 4. During this time period (i.e., a time period between time t0 and t1), the photo-detection signal resulting from the target object 15 is not detected, and thus the data read line DRi (see FIG. 7E) does not provide an output signal.

At time t1, the light-emitting gate line GW1 (see FIG. 7B) and the switch line S2 (see FIG. 7C) then provide output of the select signal and the switch signal. Thus, the first and second switches SW1 and SW2 of the light-emitting/photo-detection cells from CWR11 to CWRm1 connected to the light-emitting gate line GW1 (see FIG. 7B) are turned on at a time. Moreover, the third switches SW3 thereof, which have been on during the time period between time t0 and t1, are turned off at a time. Thus, light-emitting operation occurs in these light-emitting/photo-detection cells. Likewise, the photo-detection signal resulting from the target object 15 is not detected, and thus the data read line DRi (see FIG. 7E) does not provide an output signal.

At time t2 and thereafter, in the same manner as above described, the light-emitting gate line GW2 (see FIG. 7B) and the switch line S3 (see FIG. 7C), the light-emitting gate line GW3 (see FIG. 7B) and the switch line S4 (see FIG. 7C), and so on, provide output in sequence so that the light-emitting and photo-detection operations take place in a line-sequential fashion. Likewise, the photo-detection signal resulting from the target object 15 is not detected, and thus the data read line DRi (see FIG. 7E) does not provide an output signal. Incidentally, each light-emitting/photo-detection cell CWRi is kept in a state of the light-emission period TW during a given period of time, as previously set forth.

During the time period between time t3 and t6, the light-emitting/photo-detection cells CWRij, CWRi(j+1) and CWRi(j+2) (see FIG. 7D) then detect light reflected from the target object 15, convert a current into a voltage according to the amount of light detected as shown in FIGS. 7A to 7E, and output a signal to the data read line DRi (see FIG. 7E) (the photo-detection signal detection period TF1). In this case, the light-emitting/photo-detection cells CWRij, CWRi(j+1) and CWRi(j+2) (see FIG. 7D) mainly detect light which is emitted from the cells CWRi(j−1), CWRij and CWRi(j+1) belonging to an adjacent horizontal line and is reflected from the target object 15. Thus, the signal outputted to the data read line DRi (see FIG. 7E) has a value according to the signal on the data feed line DWi (see FIG. 7A).

At time t6 and thereafter, as in the case of the time period between time t1 and t3, the light-emitting gate line GWj+2 (see FIG. 7B) and the switch line Sj+3 (see FIG. 7C), the light-emitting gate line GWj+3 (see FIG. 7B) and the switch line Sj+4 (see FIG. 7C), and so on, the light-emitting gate line GWn−1 (see FIG. 7B) and the switch line Sn (see FIG. 7C) provide output in sequence so that the light-emitting and photo-detection operations take place in a line-sequential fashion. Likewise, the photo-detection signal resulting from the target object 15 is not detected, and thus the data read line DRi (see FIG. 7E) does not provide an output signal.

In this manner, in the vertical period TH1, the presence of the target object 15 near the light-emitting/photo-detection cells CWRij, CWRi(j+1) and CWRi(j+2) can be detected. In the vertical period TH2 and thereafter, the same operation takes place. For example during the photo-detection signal detection period TF2 in the vertical period TH2, the data read line DRi (see FIG. 7E) provides an output signal. Likewise, this results in detection of the presence of the target object 15 near the light-emitting/photo-detection cells CWRij, CWRi(j+1) and CWRi(j+2).

As described above, according to the image display device and the method of driving an image display device of the first embodiment, the image display device includes the display 1 having an arrangement of a plurality of light-emitting/photo-detection cells CWR, each of which includes one light-emitting/photo-detection device EL. The light-emitting scanner 24 and the display signal driver 23 drive the light-emitting/photo-detection devices EL in accordance with image data generated by the display signal generator 21. The photo-detection signal selector scanner 31 drives a different light-emitting/photo-detection device EL to detect light emitted from the light-emitting/photo-detection device and reflected from the target object 15. The position sensor 34 detects the target object 15 in accordance with a photo-detection signal which the photo-detection signal receiver 32 obtains from the different photo-detection device. This eliminates the need for adding a separate component such as a touch panel or an input device and thus provides a simple structure, and also eliminates the need for the passage of light emitted from the display 1 through a separate component such as a touch panel and thus prevents image degradation. Therefore, the device and the method of the first embodiment enable detecting an object position and the like without image degradation, while ensuring a simple structure.

According to the image display device and the method of driving an image display device of the first embodiment, each light-emitting/photo-detection cell CWR performs both line-sequential light-emitting operation and line-sequential photo-detection operation. This allows not only displaying image data by normal light-emitting operation, but also detecting an object position and the like.

According to the image display device and the method of driving an image display device of the first embodiment, when a target object such as a finger is brought into contact or close proximity with the display 1, the detecting process takes place to detect its position and the like. This enables users to conveniently operate the device through the same operation as touch panel operation.

According to the image display device and the method of driving an image display device of the first embodiment, the light-emitting/photo-detection cell CWR including one light-emitting/photo-detection device EL is time-shared to perform both light-emitting and photo-detection operations. This eliminates the need for providing a light-emitting device independently of a photo-detection device, thus allowing the use of a simple device structure for the light-emitting and photo-detection operations, and also allowing the simplification of a manufacturing process.

In the first embodiment, each picture element repeats a transition to photo-detection, then light emission, and then light shutoff (“photo-detection→light emission→light shutoff”), or repeats a transition to photo-detection and then light emission (“photo-detection→light emission”), thereby performing display operation concurrently with object detection operation which involves sensing light emitted from an adjacent picture element. However, the picture element is not limited to operating in this manner. For example, the picture element may repeat a transition to light emission, then photo-detection, and then light shutoff (“light emission→photo-detection→light shutoff”) to sense light emitted from an adjacent picture element.

### Second Embodiment

Next, the description is given with regard to a second embodiment of the invention.

By referring to the above-mentioned first embodiment, the description has been given with regard to the image display device configured to maintain light-emitting operation during a given period of time before next photo-detection operation. By referring to the second embodiment, the description is given with regard to an image display device configured to perform light-emitting operation until a time immediately before next photo-detection operation.

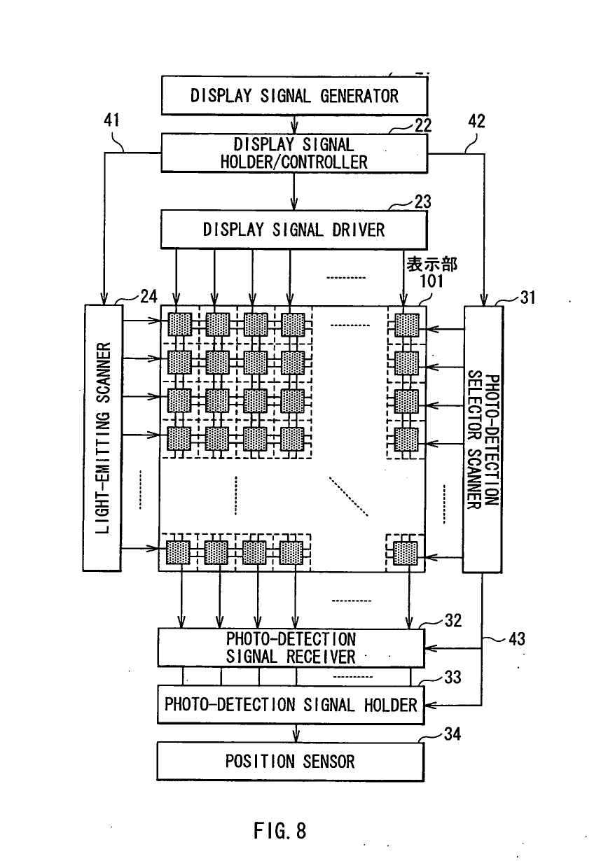

FIG. 8 shows the general configuration of the image display device according to the second embodiment of the invention. In FIG. 8, the same structural components as the components shown in FIG. 1 are designated by the same reference characters, and the description of the same components is appropriately omitted. The image display device of the second embodiment includes a display 101, a display signal generator 21, a display signal holder/controller 22, a display signal driver 23, a light-emitting scanner 24, a photo-detection signal selector scanner 31, a photo-detection signal receiver 32, a photo-detection signal holder 33, and a position sensor 34. In short, the image display device includes the display 101 in place of the display 1 of the first embodiment shown in FIG. 1.

The display 101 is the same as the display 1 in that the display 101 includes a matrix of a plurality of picture elements 11 over the whole surface, and in that the display 101 provides display of a predetermined graphic or character image or other images while performing line-sequential operation. The display 101 is different from the display 1 in that the display 101 is configured to perform light-emitting operation until a time immediately before next photo-detection operation, as described above. In other words, the display 101 is different from the display 1 in that the display 101 is configured to extend the light-emission period by changing, for example, the capacitance value of the capacitor C in the circuit configuration of the light-emitting/photo-detection cell CWR, as previously set forth.

Next, the description is given with regard to how the image display device configured as mentioned above operates to detect an object in contact with or in close proximity to the display device.

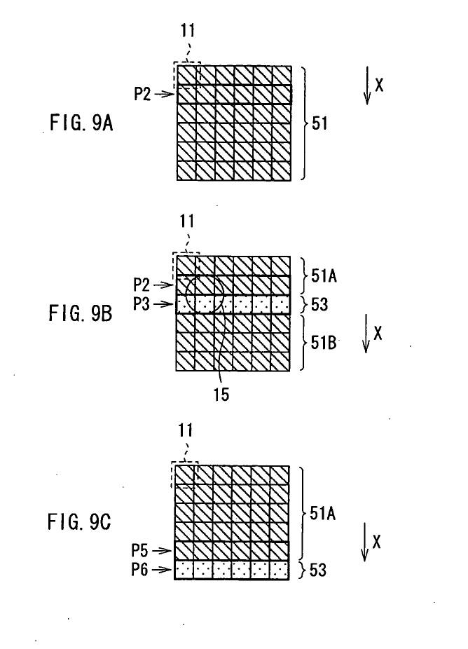

FIGS. 9A to 9C show an example of line-sequential light-emitting operation and line-sequential photo-detection operation, which are performed by the image display device shown in FIG. 8. FIGS. 9A to 9C correspond to FIGS. 6A to 6C for the first embodiment. In FIGS. 9A to 9C, the same structural components as the components shown in FIGS. 6A to 6C are designated by the same reference characters, and the description of the same components is appropriately omitted.

The example of line-sequential light-emitting operation shown in FIG. 9A is the same as the example shown in FIG. 6A in that one horizontal line at the position indicated by the arrow P2, for example, performs light-emitting operation in sequence in the scan direction X. The example shown in FIG. 9A is different from the example shown in FIG. 6A in the following respect. One horizontal line at the position indicated by the arrow P2 is kept in a state of light-emitting operation until the completion of a round of rendering of display data on the screen, that is, until next image data is fed by the display signal driver 23. Thus, the overall display 1 acts as a light-emitting region 51. As mentioned above, when one horizontal line at the position indicated by the arrow P2 performs line-sequential light-emitting operation, the whole display 1, except for a photo-detection line, can act as the light-emitting region to display image data throughout the display 1.

The example of line-sequential light-emitting operation and line-sequential photo-detection operation shown in FIGS. 9B and 9C is the same as the example shown in FIGS. 6B and 6C in the following respect. One horizontal line at the position indicated by each of the arrows P2 and P5, for example, performs light-emitting operation in sequence in the scan direction X. Moreover, one horizontal line at the position indicated by each of the arrows P3 and P6 performs line-sequential photo-detection operation in the scan direction X so as to detect light emitted from the light-emitting region and reflected from the target object 15. However, the example shown in FIGS. 9B and 9C is different from the example shown in FIGS. 6B and 6C in the following respect. One horizontal line at the position indicated by each of the arrows P3 and P6 detects not only light emitted from the upper light-emitting region 51A and reflected from the target object 15, but also light emitted from the lower light-emitting region 51B and reflected from the target object 15. As mentioned above, the light-emission period is extended by changing, for example, the capacitance value of the capacitor C in the circuit configuration of the light-emitting/photo-detection cell CWR. Thus, when one horizontal line performs line-sequential photo-detection operation to detect an object position and the like, light emitted from one upper horizontal line and one lower horizontal line relative to the horizontal line driven for photo-detection can be always used as a light source.

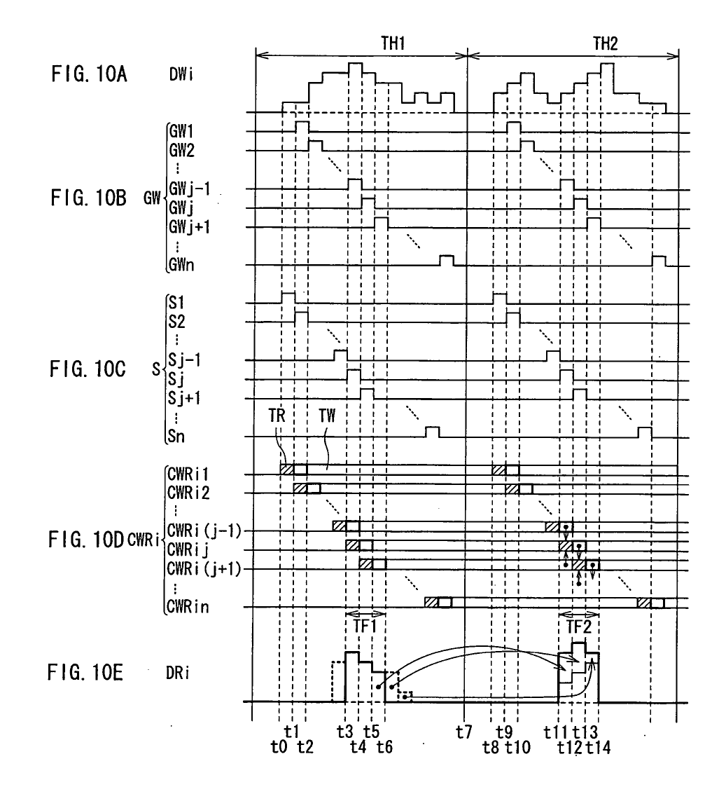

FIGS. 10A to 10E show a process for detecting the target object 15, which is executed by the image display device shown in FIG. 8. Since the basic operation of a method of driving an image display device of the second embodiment is the same as that of the method of driving an image display device of the first embodiment, the description of the basic operation is omitted, and the description is given with regard to only operation associated with an extension of the light-emission period TW.

In the vertical period TH1, the operation takes place as in the case of the first embodiment shown in FIGS. 7A to 7E. In the vertical period TH2, each light-emitting/photo-detection cell CWR is in a state of the light-emission period TW until immediately before the photo-detection period TR, as described above. Specifically, in the second embodiment, the light-emitting/photo-detection cell CWRi1, for example, is in the state of the light-emission period TW during a time period between time t7 and t8, although in the first embodiment (see FIG. 7D) the cell CWRi1 is in a state of the inactive period during the time period between time t7 and t8. As a result, the light-emission period TW extends from time t1 to time t8 (that is, until immediately before the photo-detection period TR). Taking as an example the light-emitting/photo-detection cell CWRij, both the light-emitting/photo-detection cells CWRi(j−1) and CWRi(j+1) belonging to upper and lower horizontal lines, respectively, relative to the cell CWRij are in the state of the light-emission period TW during a time period between time t11 and t12. In short, light emitted from the light-emitting/photo-detection devices belonging to two upper and lower horizontal lines relative to the light-emitting/photo-detection cell driven for photo-detection can be used as a light source. In other words, the state of one light-emitting/photo-detection device repeats a transition to light emission, then photo-detection, then light emission, and then photo-detection (“light emission”→“photo-detection”→“light emission”→“photo-detection”) without a light shutoff period therebetween, and the light-emitting/photo-detection device belonging to the horizontal line driven for photo-detection receives the entry of light which is emitted from the light-emitting/photo-detection devices belonging to upper and lower horizontal lines located with the driven horizontal line therebetween and is reflected from the target object 15. This yields an increase in the sum total of emitted light for use in the light source. Thus, the second embodiment, as shown in FIG. 10E, increases the amount of photo-detection signal on the data read line DRi, thus improving photosensitivity, as compared to the first embodiment (see FIG. 7E). In this case, although display data (e.g., video or picture data) varying among fields may cause the problem that the photo-detection signal does not correspond to original display data, this problem can be avoided by successfully preventing display of data varying too greatly among fields. Incidentally, typical video signals have such characteristics (that is, video or picture data vary little among fields), and thus the characteristics are exploited for, for example, MPEG (Motion Picture Experts Group) to compress data.

As described above, according to the image display device and the method of driving an image display device of the second embodiment, light-emitting operation takes place until a time immediately before next photo-detection operation. Therefore, the second embodiment allows increasing the amount of emitted light for use in the light source, thus achieving an increase in the amount of photo-detection signal, thus an increase in a signal-to-noise (S/N) ratio, and thus an improvement in detectivity, as well as the advantageous effects of the first embodiment.

In the second embodiment, each picture element may repeat, for example, a transition to light emission, then photo-detection, and then light shutoff (“light emission→photo-detection→light shutoff”) to sense light emitted from an adjacent picture element, as in the case of the first embodiment mentioned above.

The description is given below with regard to some modified examples of the first and second embodiments. Although these modified examples are applicable to both of the first and second embodiments, the following description is given based on the first embodiment.

### MODIFIED EXAMPLE 1

Firstly, the description is given with regard to a modified example 1 common to the first and second embodiments. In the modified example 1, the first embodiment is adapted so that thinned-out driving for photo-detection takes place relative to driving for light emission.

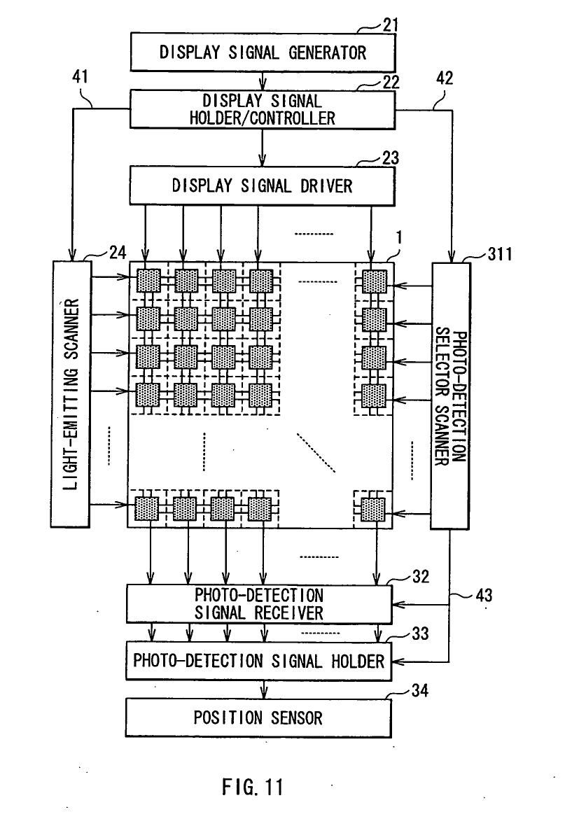

FIG. 11 shows the general configuration of an image display device according to the modified example 1. FIG. 11 corresponds to FIG. 1 for the first embodiment. In FIG. 11, the same structural components as the components shown in FIG. 1 are designated by the same reference characters, and the description of the same components is appropriately omitted. The image display device of the modified example 1 includes a display 1, a display signal generator 21, a display signal holder/controller 22, a display signal driver 23, a light-emitting scanner 24, a photo-detection signal selector scanner 311, a photo-detection signal receiver 32, a photo-detection signal holder 33, and a position sensor 34. In short, the image display device includes the photo-detection signal selector scanner 311 in place of the photo-detection signal selector scanner 31 of the first embodiment shown in FIG. 1.

The photo-detection signal selector scanner 311 has the same function as the photo-detection signal selector scanner 31. Specifically, the photo-detection signal selector scanner 311 selects the light-emitting/photo-detection cell CWR to be driven for photo-detection by switching the driving mode of the cell CWR between light emission mode and photo-detection mode in accordance with the photo-detection timing control signal 42 outputted by the display signal holder/controller 22. The photo-detection signal selector scanner 311 is different from the photo-detection signal selector scanner 31 in that the photo-detection scanner 311 performs thinned-out driving relative to the light-emitting scanner 24, as mentioned above. As will be specifically described later, the light-emitting scanner 24 scans the light-emitting gate lines GW, namely, from GW1 to GWn, as in the case of the first embodiment, whereas the photo-detection signal selector scanner 311 scans the switch lines S, namely, from S2 to Sn, every other line and does not scan the other switch lines from S1 to Sn-1. Incidentally, n denotes an even number, taking it into account that the display 1 is based on, for example, XGA standards as previously set forth (m=1024×3(RGB), n=768). For the sake of convenience, j denotes an odd number.

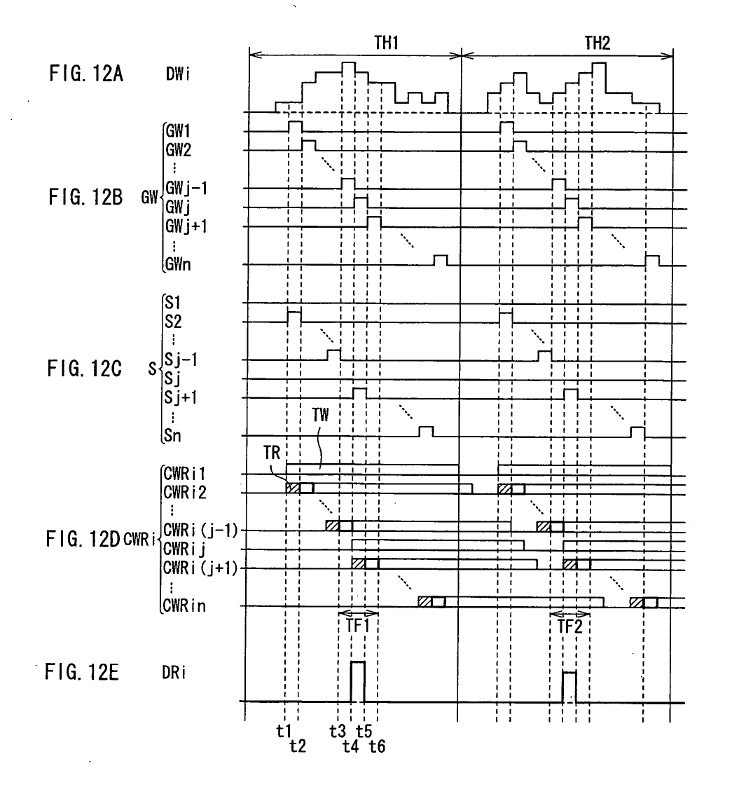

FIGS. 12A to 12E show a process for detecting the target object 15, which is executed by the image display device shown in FIG. 11. FIGS. 12A to 12E correspond to FIGS. 7A to 7E for the first embodiment. Since the basic operation of a method of driving an image display device of the modified example 1 is the same as that of the method of driving an image display device of the first embodiment, the description of the basic operation is omitted, and the description is given with regard to only operation associated with the photo-detection signal selector scanner 311.

As mentioned above, the light-emitting gate lines GW, namely, from GW1 to GWn (see FIG. 12B) provide output of the select signal as in the case of the first embodiment, whereas the switch lines S, namely, from S2 to Sn (see FIG. 12C) provide output of the switch signal every other line, and the other switch lines from S1, S3 to Sn-1 do not receive output of the switch signal. Correspondingly, the data read line DR also provides thinned-out output according to the switch lines S. Thus, the photo-detection signal is not detected during, for example, time periods between time t1 and t2, between time t3 and t4, and between time t5 and t6, and the photo-detection signal is detected during, for example, a time period between time t4 and t5. This allows reducing the amount of data of the photo-detection signal.

As described above, according to the image display device and the method of driving an image display device of the modified example 1, the photo-detection signal selector scanner 311 performs thinned-out driving relative to the light-emitting scanner 24. Thus, the modified example 1 can achieve a reduction in the amount of data of the photo-detection signal, thus a simplification of photo-detection circuits (i.e., the photo-detection signal selector scanner 311, the photo-detection signal receiver 32, and the photo-detection signal holder 33), and also a reduction in power consumption, as well as the advantageous effects of the first embodiment. Thus, the modified example 1 is especially effective when there is a desire for a simplification of the circuit configuration and a reduction in power consumption rather than the accuracy of detection of the position of an object in contact with or in close proximity to the display device.

Although the description has been given with regard to the modified example 1 where the even-numbered switch lines alone are scanned, the modified example 1 is not limited to this configuration. The modified example 1 may have any other configuration, provided that it can achieve a simplification of the photo-detection circuits and a reduction in power consumption. For example, the modified example 1 may be configured to scan only the odd-numbered switch lines instead, or to scan the switch lines every two or three lines, for instance. Other methods for “thinning-out”, such as takes place in the modified example 1, can include the approach of coupling outputs from picture elements to reduce the number of photo-detection signal scanners. For example, coupling outputs from two picture elements vertically arranged allows extracting a doubled amount of signal, thus yielding an improvement in photosensitivity.

### MODIFIED EXAMPLE 2

Next, the description is given with regard to a modified example 2 common to the first and second embodiments. In the modified example 2, the first embodiment is adapted to include a comparator 35, which is interposed between the photo-detection signal receiver 32 and the photo-detection signal holder 33.

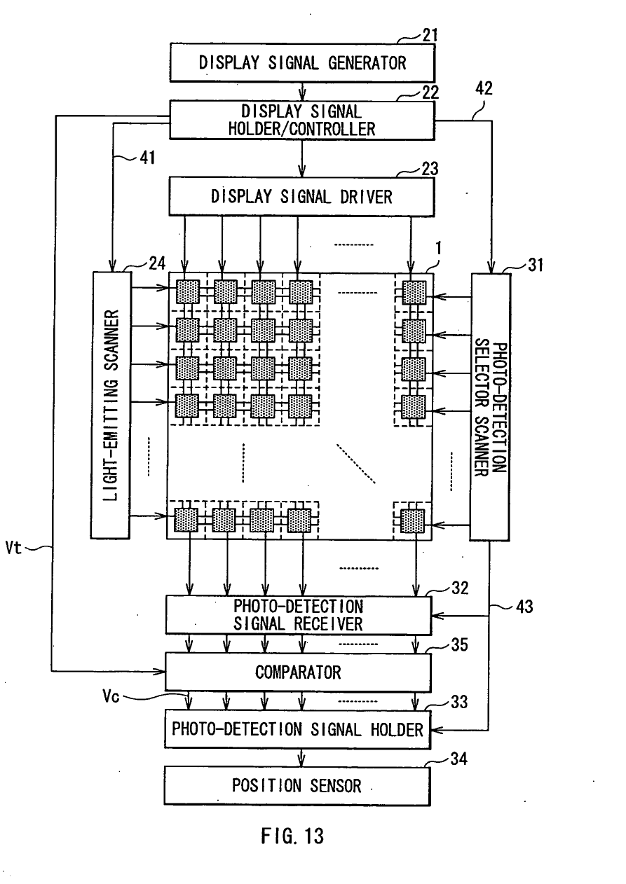

FIG. 13 shows the general configuration of an image display device according to the modified example 2. FIG. 13 corresponds to FIG. 1 for the first embodiment. In FIG. 13, the same structural components as the components shown in FIG. 1 are designated by the same reference characters, and the description of the same components is appropriately omitted. The image display device of the modified example 2 includes a display 1, a display signal generator 21, a display signal holder/controller 22, a display signal driver 23, a light-emitting scanner 24, a photo-detection signal selector scanner 31, a photo-detection signal receiver 32, a comparator 35, a photo-detection signal holder 33, and a position sensor 34.

The comparator 35 has the function of comparing and converting as given below. The comparator 35 compares the photo-detection signal outputted by the photo-detection signal receiver 32 to a threshold voltage signal Vt, which is a predetermined voltage, outputted by the display signal holder/controller 22. The comparator 35 then performs A/D conversion based on the result of comparison. As will be specifically described later, for example, the comparator 35 converts the photo-detection signal into digital data “1” when the photo-detection signal has a higher voltage than the threshold voltage signal Vt, or the comparator 35 converts the photo-detection signal into digital data “0” when the photo-detection signal has a lower voltage than the threshold voltage signal Vt. The comparator 35 outputs the digital data (i.e., a comparator output signal Vc) to the photo-detection signal holder 33.

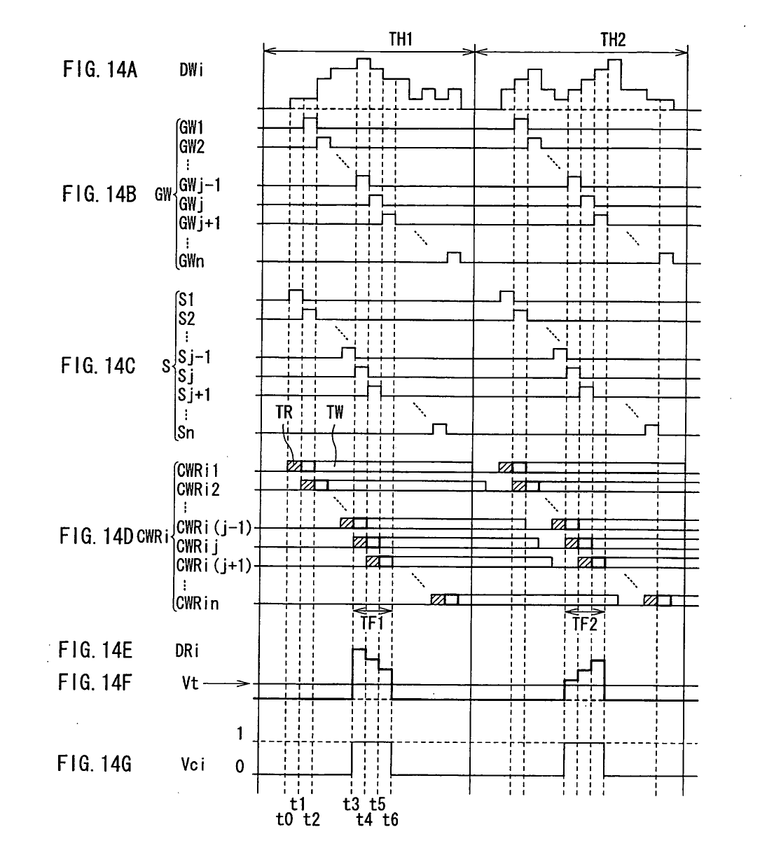

FIGS. 14A to 14G show a process for detecting the target object 15, which is executed by the image display device shown in FIG. 13. FIGS. 14A to 14E correspond to FIGS. 7A to 7E for the first embodiment. FIG. 14D shows one vertical line of light-emitting/photo-detection cells CWRi (CWRi1 to CWRin). FIG. 14A shows a signal on a data feed line DWi connected to the cells CWRi. FIG. 14B shows signals on light-emitting gate lines GW (GW1 to GWn) connected to the cells CWRi. FIG. 14C shows signals on switch lines S (S1 to Sn) connected to the cells CWRi. FIG. 14E shows a signal on a data read line DRi connected to the cells CWRi. FIG. 14F shows a threshold voltage signal Vt connected to the cells CWRi. FIG. 14G shows a comparator output signal Vci connected to the cells CWRi.

The basic operation of a method of driving an image display device of the modified example 2 is the same as that of the method of driving an image display device of the first embodiment. The modified example 2 is different from the first embodiment in the following respect. As mentioned above, the comparator 35 is interposed between the photo-detection signal receiver 32 and the photo-detection signal holder 33, so that the comparator output signal Vc is inputted as digital data to the photo-detection signal holder 33. Thus, the comparator output signal Vci (see FIG. 14G) is “1” when the amount of signal on the data read line DRi (see FIG. 14E) is larger than the predetermined threshold voltage signal Vt (see FIG. 14F), or the comparator output signal Vci (see FIG. 14G) is “0” when the amount of signal on the data read line DRi (see FIG. 14E) is smaller than the predetermined threshold voltage signal Vt (see FIG. 14F). Thus, the photo-detection signal is obtained during the photo-detection signal detection periods TH1 and TF2, as in the case of the first embodiment shown in FIG. 7D. This results in detection of the presence of the target object 15 near the light-emitting/photo-detection cells CWRij, CWRi(j+1) and CWRi(j+2).

As described above, according to the image display device and the method of driving an image display device of the modified example 2, the comparator 35 is interposed between the photo-detection signal receiver 32 and the photo-detection signal holder 33, so that digital data is inputted to and handled by the photo-detection signal holder 33 and the position sensor 34. Thus, the modified example 2 can achieve a reduction in process loads on these blocks and thus a simplification of the circuit configuration and a reduction in power consumption, as well as the advantageous effects of the first embodiment.

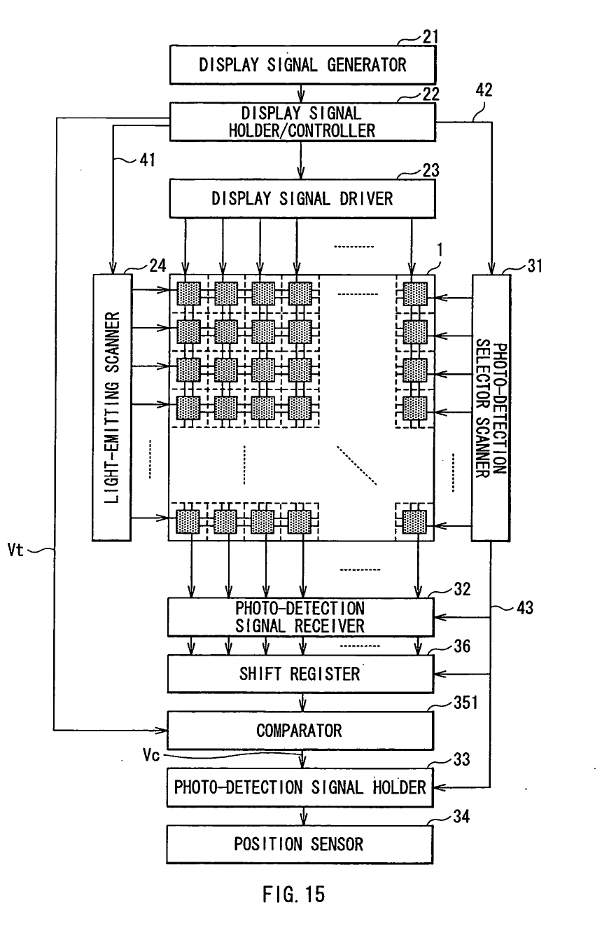

FIG. 15 shows another example of the general configuration of the image display device according to the modified example 2. In the example of FIG. 15, the modified example 2 shown in FIG. 13 is adapted to further include a shift register 36, which is interposed between the photo-detection signal receiver 32 and the comparator 35. In FIG. 15, the same structural components as the components shown in FIG. 13 are designated by the same reference characters, and the description of the same components is appropriately omitted. The image display device shown in FIG. 15 includes a display 1, a display signal generator 21, a display signal holder/controller 22, a display signal driver 23, a light-emitting scanner 24, a photo-detection signal selector scanner 31, a photo-detection signal receiver 32, a shift register 36, a comparator 351, a photo-detection signal holder 33, and a position sensor 34.

The shift register 36 has the following function. The shift register 36 selects, in order, the photo-detection signal outputted by the photo-detection signal receiver 32 in accordance with the photo-detection block control signal 43 outputted by the photo-detection signal selector scanner 31. Then, the shift register 36 performs parallel-serial conversion and outputs serial data to the comparator 351. Specifically, the shift register 36 converts the photo-detection signal, which is parallel data for m outputs, into serial data for one output, and outputs the serial data to the comparator 351. Thus, the configuration shown in FIG. 15 can reduce the number of comparators from m to 1, as compared to the configuration shown in FIG. 13.

The comparator 351 has the same function as the comparator 35. Specifically, the comparator 351 compares the photo-detection signal, which is outputted by the shift register 36 after undergoing parallel-serial conversion as mentioned above, to the threshold voltage signal Vt, which is a predetermined voltage, outputted by the display signal holder/controller 22. The comparator 351 then performs A/D conversion based on the result of comparison. The comparator 351 outputs resultant digital data (i.e., the comparator output signal Vc) to the photo-detection signal holder 33.

As described above, according to the image display device and the method of driving an image display device of the example of FIG. 15, the modified example 2 shown in FIG. 13 is adapted to further include the shift register 36, which is interposed between the photo-detection signal receiver 32 and the comparator 35. Therefore, the example of FIG. 15 can achieve a reduction in the number of comparators, thus a reduction in process loads on these blocks, and thus a further simplification of the circuit configuration and a further reduction in power consumption, as well as the advantageous effects of the modified example 2.

The description is now given with regard to the advantageous effects of varying thresholds.

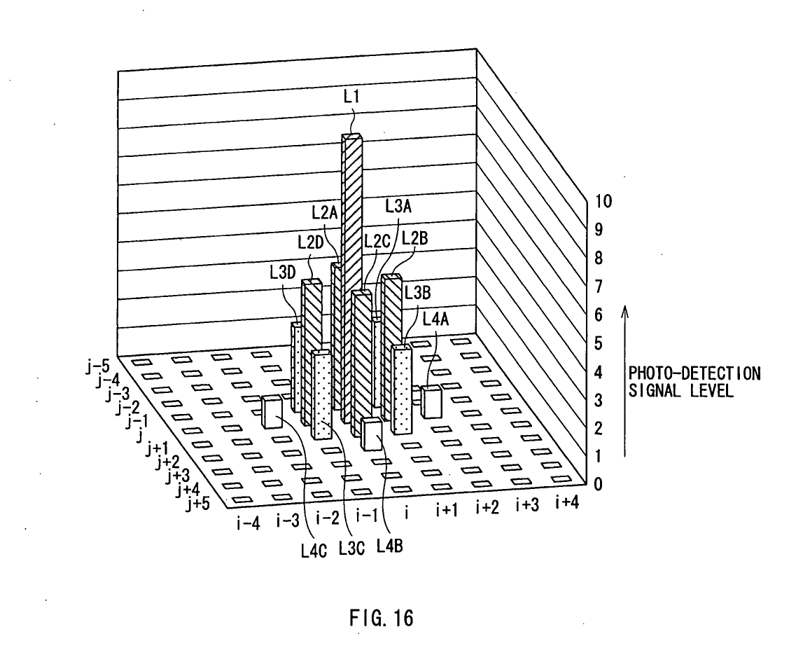

FIG. 16 shows an example of the distribution of the amount of photo-detection signal, showing a region including the light-emitting/photo-detection cell CWRij and light-emitting/photo-detection cells (CWR(i−4)(j−5) to CWR(i+4)(j+5)) around the cell CWRij.

In this example, a photo-detection signal L1 of the light-emitting/photo-detection cell CWRij has a photo-detection signal level of 9. Respective photo-detection signals L2A, L2B, L2C and L2D of the light-emitting/photo-detection cells CWR(j−1), CWR(i+1)j, CWRi(j+1) and CWR(i−1)j have a photo-detection signal level of 5. Respective photo-detection signals L3A, L3B, L3C and L3D of the light-emitting/photo-detection cells CWR(i+1)(j−1), CWR(i+1)(j+1), CWR(i−1)(j+1) and CWR(i−1)(j−1) have a photo-detection signal level of 3. Respective photo-detection signals L4A, L4B and L4C of the light-emitting/photo-detection cells CWR(i+2)j, CWRi(j+2) and CWR(i−2)j and a photo-detection signal of the light-emitting/photo-detection cell CWRi(j−2) (not shown) have a photo-detection signal level of 1. The distribution is such that the photo-detection signal level becomes lower farther away from the light-emitting/photo-detection cell CWRij. As previously mentioned, the position sensor 34 and the comparator 35 or 351 compare the amount of each photo-detection signal to a predetermined threshold voltage Vt, thereby detecting where an object in contact with or in close proximity to the display device is situated.

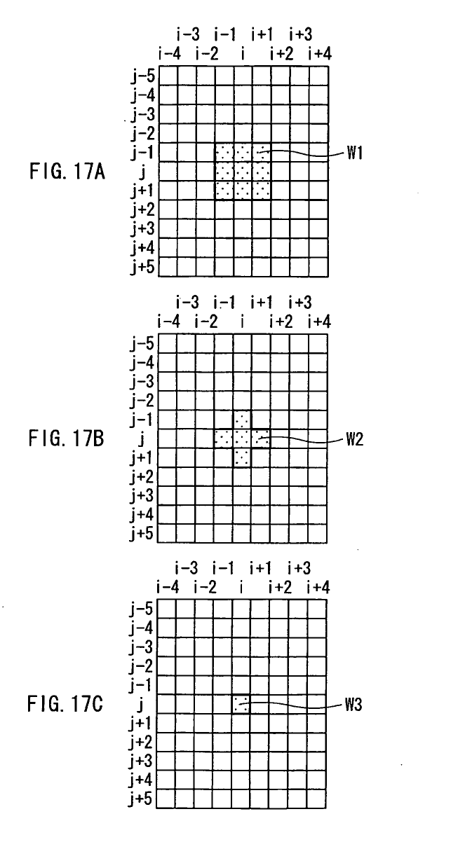

FIGS. 17A to 17C show the distribution of the amount of photo-detection signal shown in FIG. 16, showing situations where the threshold is set to varying values. FIGS. 17A, 17B, and 17C show the distribution shown in FIG. 16, showing situations where the threshold voltage Vt is set to a photo-detection signal level of 2, a photo-detection signal level of 4, and a photo-detection signal level of 6, respectively. In FIGS. 17A to 17C, each of photo-detection signal detection regions W1 to W3 is the region where the amount of photo-detection signal of the light-emitting/photo-detection cell CWR is larger than the threshold voltage Vt, and this indicates that the object is detected at the position of each region.

As can be seen from FIGS. 17A to 17C, as the photo-detection signal level of the threshold voltage is higher, the area of the region having the object detected therein is smaller around the position of the light-emitting/photo-detection cell CWRij. Thus, for example, users may optionally change the threshold voltage Vt according to the properties of the object (e.g., a size, a surface state (e.g., reflectivity, a color, roughness, and the like), etc.), the purpose of detection (e.g., position detection, size detection, color detection, and the like), the accuracy of detection, and so on, in order to realize position detection with higher accuracy and greater convenience.

### MODIFIED EXAMPLE 3

Next, the description is given with regard to a modified example 3 common to the first and second embodiments. The amount of light reflected from an object in contact with or in close proximity to the display device is large when a large amount of light is emitted from the light-emitting/photo-detection cell CWR, or the amount of reflected light is small when a small amount of light is emitted from the cell CWR. Thus, a different light-emitting/photo-detection cell detects various amounts of photo-detection signals according to what amount of light is emitted from a light-emitting/photo-detection cell CWR. In the modified example 3, the first embodiment is thus adapted to include the shift register 36, the comparator 351, and a threshold voltage generator 37, which are interposed between the photo-detection signal receiver 32 and the photo-detection signal holder 33. The threshold voltage generator 37 acts to generate the threshold voltage Vt of the comparator 351 in accordance with a display signal 45 outputted by the display signal holder/controller 22. In short, the threshold voltage generator 37 for generating the threshold voltage Vt is added to the image display device shown in FIG. 15.

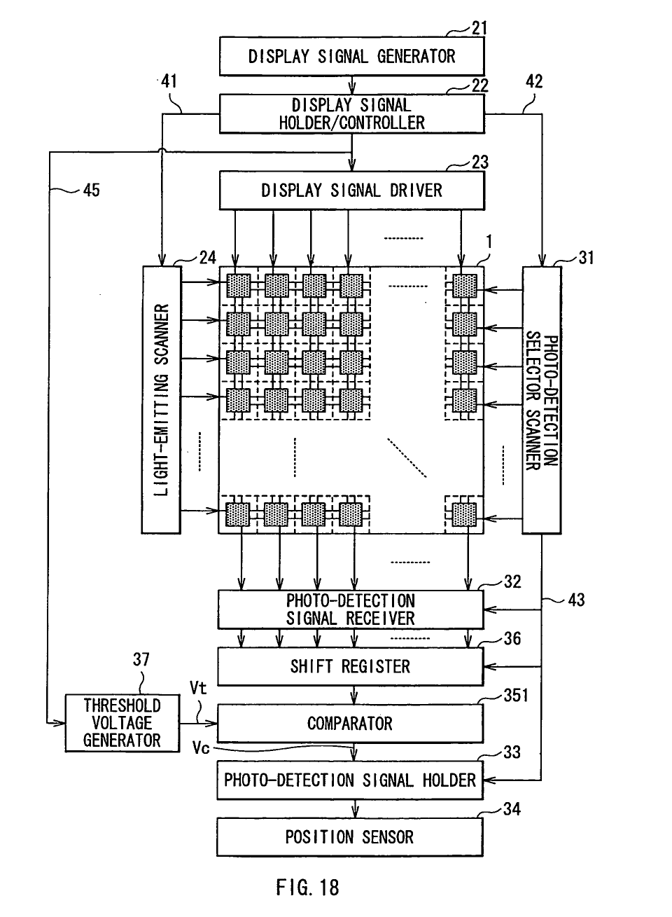

FIG. 18 shows the general configuration of an image display device according to the modified example 3. FIG. 18 corresponds to FIG. 1 for the first embodiment. In FIG. 18, the same structural components as the components shown in FIGS. 1 and 15 are designated by the same reference characters, and the description of the same components is appropriately omitted. The image display device of the modified example 3 includes a display 1, a display signal generator 21, a display signal holder/controller 22, a display signal driver 23, a light-emitting scanner 24, a photo-detection signal selector scanner 31, a photo-detection signal receiver 32, a shift register 36, a comparator 351, a threshold voltage generator 37, a photo-detection signal holder 33, and a position sensor 34.

The threshold voltage generator 37 has the following function. The threshold voltage generator 37 generates the threshold voltage Vt of the comparator 351 in accordance with the display signal 45 of each picture element 11 outputted by the display signal holder/controller 22, and outputs the threshold voltage Vt to the comparator 351. This allows the comparator 351 to set the threshold voltage Vt for each picture element according to light emitted from the light-emitting/photo-detection cell CWR of each picture element 11.

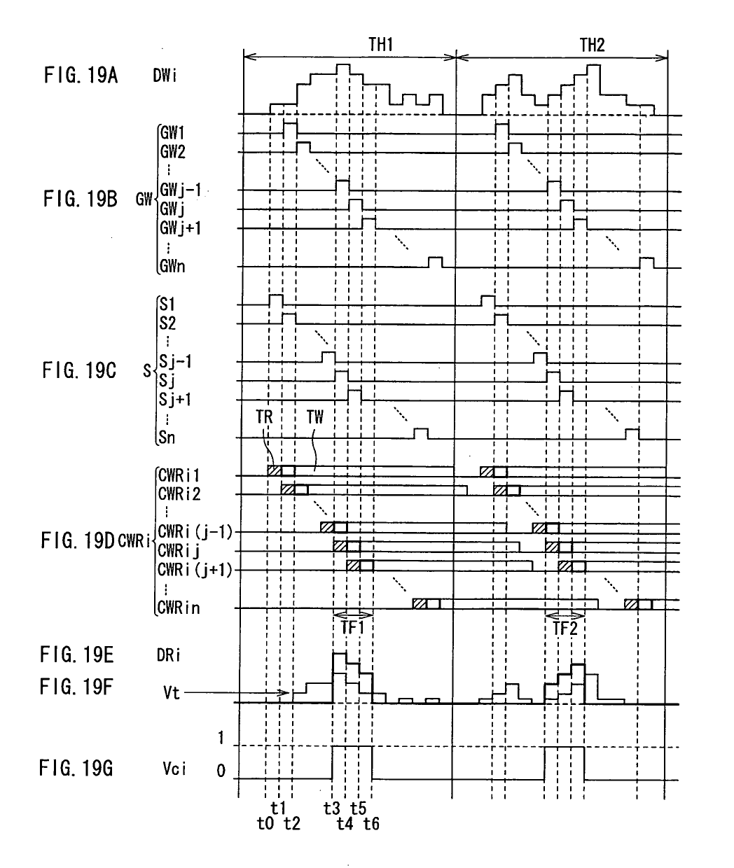

FIGS. 19A to 19G show a process for detecting the target object 15, which is executed by the image display device shown in FIG. 18. FIGS. 19A to 19E correspond to FIGS. 7A to 7E for the first embodiment, and FIGS. 19A to 19G correspond to FIGS. 14A to 14G for the modified example 2. FIG. 19D shows one vertical line of light-emitting/photo-detection cells CWRi (CWRi1 to CWRin), as in the case of FIG. 14D. FIG. 19A shows a signal on a data feed line DWi connected to the cells CWRi, as in the case of FIG. 14A. FIG. 19B shows signals on light-emitting gate lines GW (GW1 to GWn) connected to the cells CWRi, as in the case of FIG. 14B. FIG. 19C shows signals on switch lines S (S1 to Sn) connected to the cells CWRi, as in the case of FIG. 14C. FIG. 19E shows a signal on a data read line DRi connected to the cells CWRi, as in the case of FIG. 14E. FIG. 19F shows a threshold voltage signal Vt connected to the cells CWRi, as in the case of FIG. 14F. FIG. 19G shows a comparator output signal Vci connected to the cells CWRi, as in the case of FIG. 14G. Since the basic operation of a method of driving an image display device of the modified example 3 is the same as the operation shown in FIGS. 14A to 14G, the description of the same operation is omitted, and the description is given with regard to only operation associated with the threshold voltage generator 37 and the comparator 351.

The basic operation of the method of driving an image display device of the modified example 3 is the same as that of the driving method of the modified example 2 shown in FIGS. 14A to 14G. The modified example 3 is different from the modified example 2 in that the threshold voltage generator 37 generates the threshold voltage Vt of the comparator 351 in accordance with the display signal 45 of each picture element 11 outputted by the display signal holder/controller 22, as mentioned above. Thus, in the modified example 3, the threshold voltage signal Vt is variable according to the data feed line DWi (see FIG. 19A), although the threshold voltage Vt is fixed in the modified example 2 shown in FIG. 14F. Of course, also in this case, the comparator output signal Vci (see FIG. 19G) is “1” when the amount of signal on the data read line DRi (see FIG. 19E) is larger than the predetermined threshold voltage signal Vt (see FIG. 19F), or the comparator output signal Vci (see FIG. 19G) is “0” when the amount of signal on the data read line DRi (see FIG. 19E) is smaller than the predetermined threshold voltage signal Vt (see FIG. 19F). Thus, the photo-detection signal is obtained during the photo-detection signal detection periods TF1 and TF2, as in the case of the first embodiment shown in FIG. 7D. This results in detection of the presence of the target object 15 near the light-emitting/photo-detection cells CWRij, CWRi(j+1) and CWRi(j+2).

As described above, according to the image display device and the method of driving an image display device of the modified example 3, the threshold voltage generator 37 is added to the image display device shown in FIG. 15 so as to change the threshold voltage Vt of the comparator 351 according to the display signal of each picture element, specifically so as to set a high threshold voltage when the amount of light emitted from an adjacent picture element is large, or so as to set a low threshold voltage when the amount of emitted light is small. Thus, the modified example 3 can achieve more accurate detection of the position of the object in contact with or in close proximity to the display device, as well as the advantageous effects of the image display device shown in FIG. 15.

### MODIFIED EXAMPLE 4

Next, the description is given with regard to a modified example 4 common to the first and second embodiments. The surface of the display 1 of the image display device is irradiated with and exposed to ambient light, as well as light reflected from an object in contact with or in close proximity to the display device. In the modified example 4, the first embodiment is thus adapted to include the comparator 35 and a threshold voltage generator 371, which are interposed between the photo-detection signal receiver 32 and the photo-detection signal holder 33. The threshold voltage generator 371 acts to generate the threshold voltage Vt of the comparator 35 in accordance with a photo-detection signal VR outputted by the photo-detection signal receiver 32. In short, the threshold voltage generator 371 is added to the modified example 2 shown in FIG. 13 so that a process for eliminating the effect of ambient light takes place when the light-emitting/photo-detection device EL detects the photo-detection signal.

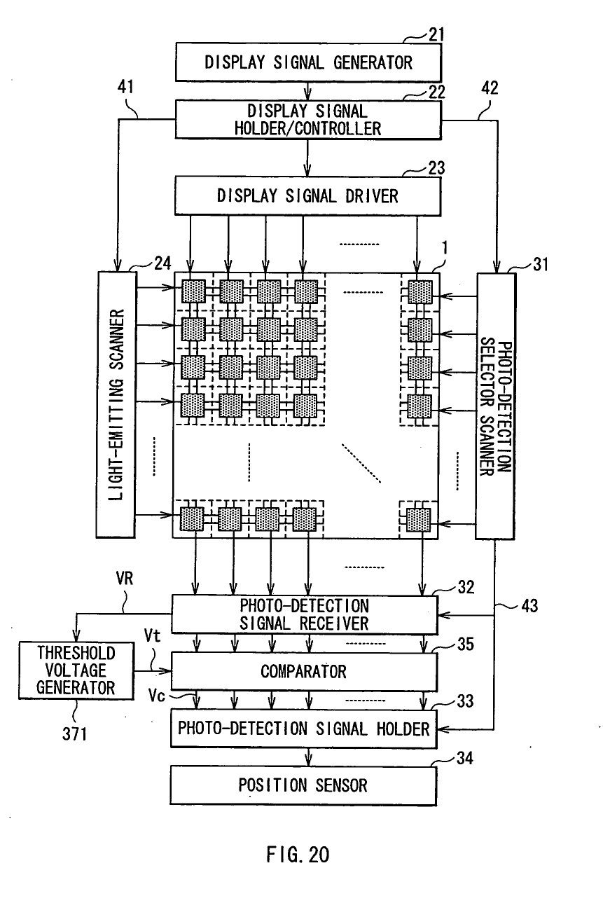

FIG. 20 shows the general configuration of an image display device according to the modified example 4. FIG. 20 corresponds to FIG. 1 for the first embodiment. In FIG. 20, the same structural components as the components shown in FIGS. 1 and 13 are designated by the same reference characters, and the description of the same components is appropriately omitted. The image display device of the modified example 4 includes a display 1, a display signal generator 21, a display signal holder/controller 22, a display signal driver 23, a light-emitting scanner 24, a photo-detection signal selector scanner 31, a photo-detection signal receiver 32, a comparator 35, a threshold voltage generator 371, a photo-detection signal holder 33, and a position sensor 34.

The threshold voltage generator 371 has the following function. The threshold voltage generator 371 generates the threshold voltage Vt of the comparator 35 in accordance with the photo-detection signal VR, outputted by the photo-detection signal receiver 32, of each of picture elements 11 constituting one horizontal line. The threshold voltage generator 371 outputs the threshold voltage Vt to the comparator 35. This allows the comparator 35 to set the threshold voltage Vt for each picture element according to light reflected onto the light-emitting/photo-detection cell CWR of each picture element 11.

The comparator 35 has the following function. The comparator 35 compares the photo-detection signal outputted by the photo-detection signal receiver 32 to the threshold voltage signal Vt outputted by the threshold voltage generator 371, and performs A/D conversion based on the result of comparison. The comparator 35 outputs resultant digital data (i.e., the comparator output signal Vc) to the photo-detection signal holder 33.

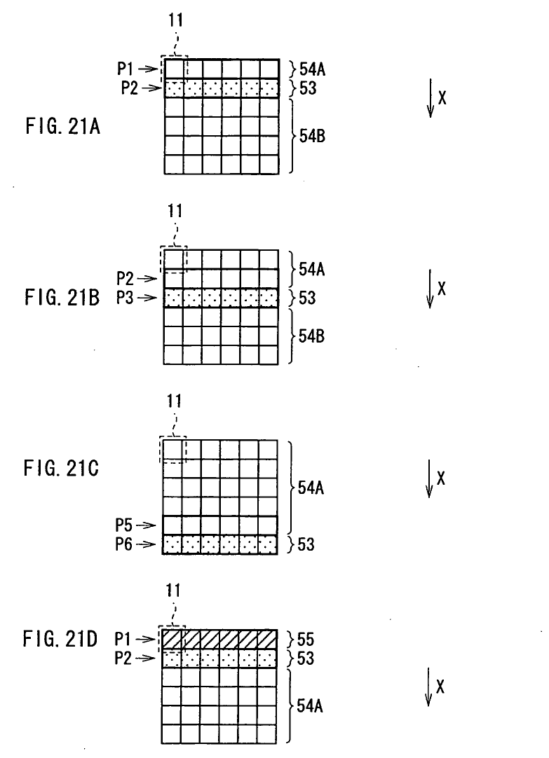

FIGS. 21A to 21D show an example of the process for eliminating the effect of ambient light, which is executed by the image display device shown in FIG. 20. This process includes processes shown in FIGS. 21A to 21D. Each of squares shown in FIGS. 21A to 21D represents the picture element 11 of the display 1, as in the case of FIGS. 6A to 6C.

Referring first to FIG. 21A, the overall display 1, except for a photo-detection region 53, is preset to black display regions 54A and 54B so that the light-emitting/photo-detection cell CWR emits light with the lowest brightness. Thus, a different light-emitting/photo-detection cell CWR detects little light emitted from the light-emitting/photo-detection cell CWR and reflected from the object in contact with or in close proximity to the display device. During a series of processes for eliminating the effect of ambient light, an object, such as reflects light, must not be placed near the image display device so that the different light-emitting/photo-detection cell CWR detects only ambient light. Under such conditions, as previously mentioned, for example, one horizontal line at the position indicated by the arrow P1 performs line-sequential light-emitting operation in the scan direction X, and one horizontal line at the position indicated by the arrow P2 performs line-sequential photo-detection operation in the scan direction X.

Then, one horizontal line at the position indicated by each of the arrows P2 and P5 and one horizontal line at the position indicated by each of the arrows P3 and P6, as shown in FIGS. 21B and 21C, perform line-sequential light-emitting operation and line-sequential photo-detection operation, respectively, in the same manner, so as to detect a screenful of light on the display 1. The photo-detection signal detected by each light-emitting/photo-detection cell CWR is outputted to the photo-detection signal receiver 32, which then outputs the photo-detection signal VR for one horizontal line to the threshold voltage generator 371. Then, the threshold voltage generator 371 generates the threshold voltage Vt of the comparator 35 in accordance with the photo-detection signal VR and outputs the threshold voltage Vt to the comparator 35, as mentioned above.

After the completion of the process for detecting a screenful of ambient light, one horizontal line at the position indicated by the arrow P1 shown in FIG. 21D starts normal display operation so that a normal display region 55 is widened in the scan direction X in the same manner, and moreover, one horizontal line at the position indicated by the arrow P2 starts normal photo-detection operation. The comparator 35 performs A/D conversion on the photo-detection signal of each picture element 11, using the threshold voltage Vt generated allowing for the photo-detection signal VR resulting from ambient light obtained through the processes shown in FIGS. 21A to 21C. This enables the elimination of the effect of ambient light.

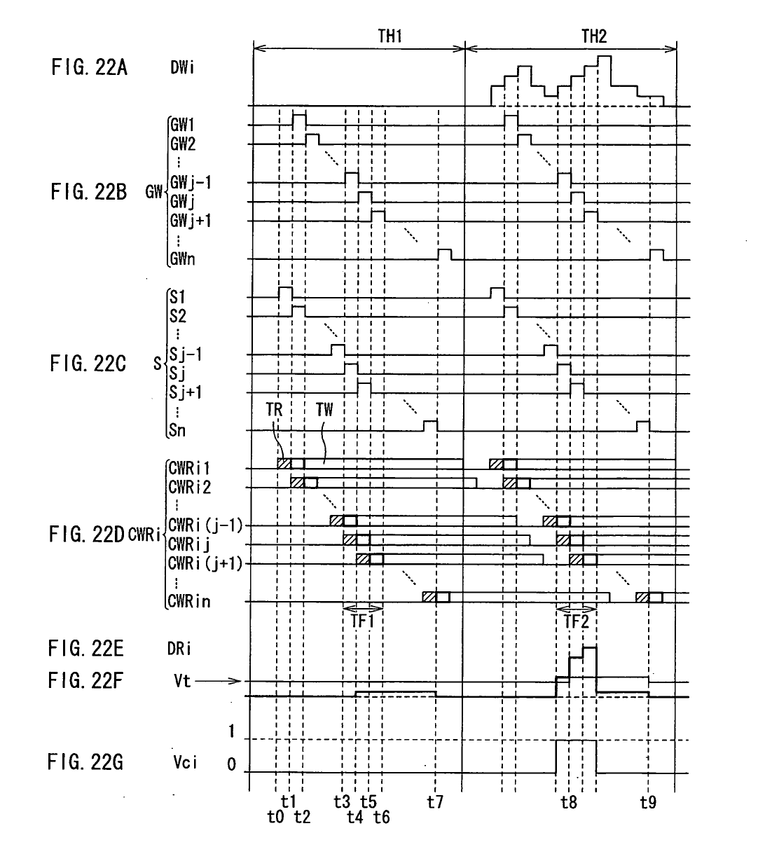

FIGS. 22A to 22G show the process for eliminating the effect of ambient light. FIGS. 22A to 22E correspond to FIGS. 7A to 7E for the first embodiment, and FIGS. 22A to 22G correspond to FIGS. 14A to 14G for the modified example 2. FIG. 22D shows one vertical line of light-emitting/photo-detection cells CWRi (CWRi1 to CWRin), as in the case of FIG. 14D. FIG. 22A shows a signal on a data feed line DWi connected to the cells CWRi, as in the case of FIG. 14A. FIG. 22B shows signals on light-emitting gate lines GW (GW1 to GWn) connected to the cells CWRi, as in the case of FIG. 14B. FIG. 22C shows signals on switch lines S (S1 to Sn) connected to the cells CWRi, as in the case of FIG. 14C. FIG. 22E shows a signal on a data read line DRi connected to the cells CWRi, as in the case of FIG. 14E. FIG. 22F shows a threshold voltage signal Vt connected to the cells CWRi, as in the case of FIG. 14F. FIG. 22G shows a comparator output signal Vci connected to the cells CWRi, as in the case of FIG. 14G. Since the basic operation of a method of driving an image display device of the modified example 4 is the same as the operation shown in FIGS. 14A to 14G, the description of the same operation is omitted, and the description is given with regard to only operation associated with the threshold voltage generator 371 and the comparator 35.

In the vertical period TH1, the black display region 54 first appears throughout the display 1 as mentioned above, and thus the amount of signal on the data feed line DWi (see FIG. 22A) has the minimum value. During a time period between time t4 and t7, the photo-detection signal outputted via the data read line DRi (see FIG. 22E) is thus regarded as the photo-detection signal resulting from ambient light. During a time period between time t8 and t9 in the vertical period TH2 corresponding to the time period between time t4 and t7 in the vertical period TH1, the threshold voltage Vt is then set higher, allowing for the photo-detection signal resulting from ambient light detected in the vertical period TH1. In this manner, the threshold is set allowing for the effect of ambient light.

As described above, according to the image display device and the method of driving an image display device of the modified example 4, the threshold voltage generator 371 is added to the modified example 2 shown in FIG. 13 so that the process for eliminating the effect of ambient light takes place when the photo-detection device detects the photo-detection signal. Thus, the modified example 4 enables detection allowing for the effect of ambient light, thus achieving more accurate detection of the position of the object in contact with or in close proximity to the display device, as well as the advantageous effects of the modified example 2.

Although the description has been given with regard to the modified example 4 where an original threshold voltage Vt has a fixed value, the modified example 4 may be applied to the configuration in which the threshold voltage Vt has a variable value generated according to the display signal 45 as in the case of the modified example 3 shown in FIG. 18 and FIGS. 19A to 19G. In this case, the threshold voltage Vt is generated according to both the display signal 45 and the photo-detection signal VR.

### MODIFIED EXAMPLE 5

Next, the description is given with regard to a modified example 5 common to the first and second embodiments. In the modified example 5, the image display device is adapted to detect a plurality of objects placed simultaneously at arbitrary positions and also to detect an object at any position which is arbitrarily shifted.

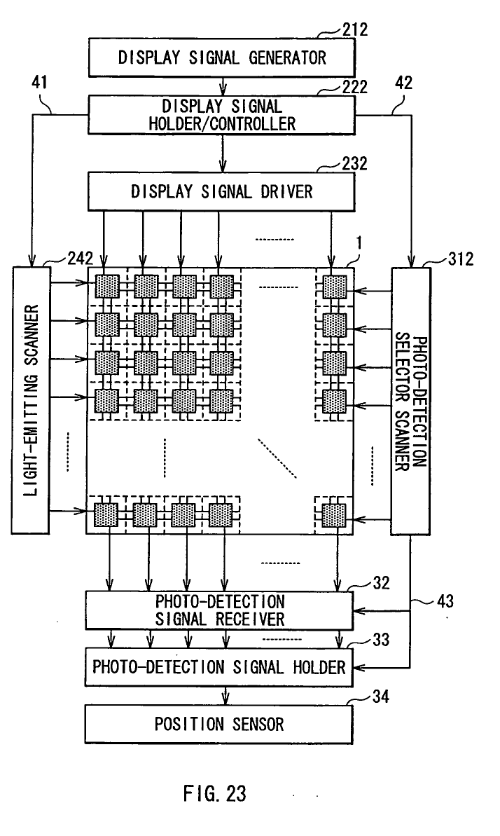

FIG. 23 shows the general configuration of an image display device according to the modified example 5. FIG. 23 corresponds to FIG. 1 for the first embodiment. In FIG. 23, the same structural components as the components shown in FIG. 1 are designated by the same reference characters, and the description of the same components is appropriately omitted. The image display device of the modified example 5 includes a display 1, a display signal generator 212, a display signal holder/controller 222, a display signal driver 232, a light-emitting scanner 242, a photo-detection signal selector scanner 312, a photo-detection signal receiver 32, a photo-detection signal holder 33, and a position sensor 34.

The description of the same operations is omitted because the basic operations of the display signal generator 212, the display signal holder/controller 222, the display signal driver 232, the light-emitting scanner 242 and the photo-detection signal selector scanner 312 are the same as those of the display signal generator 21, the display signal holder/controller 22, the display signal driver 23, the light-emitting scanner 24 and the photo-detection signal selector scanner 31 shown in FIG. 1.

The display signal generator 212 further has the following function. The display signal generator 212 replaces part of input image data with mark data for displaying a predetermined mark and superimposes the image data on a display signal, as will be described later. The display signal holder/controller 222, the display signal driver 232, the light-emitting scanner 242 and the photo-detection signal selector scanner 312 operate so that a light-emitting/photo-detection cell CWR emits light according to the mark data and a different light-emitting/photo-detection cell CWR corresponding to the position of the light-emitting/photo-detection cell CWR detects the emitted light and detects a photo-detection signal. In this manner, an object in contact with or in close proximity to the display device can be detected in a region where the predetermined mark is displayed.

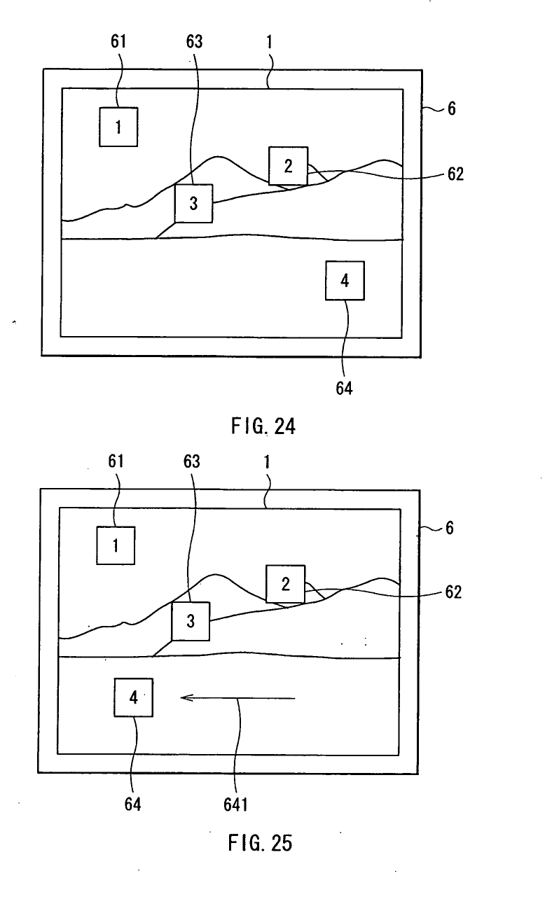

FIG. 24 shows the image display device shown in FIG. 23, illustrating detection of a plurality of objects placed simultaneously at arbitrary positions. FIG. 24 also shows a plurality of predetermined marks 61 to 64, showing a situation in which the marks 61 to 64, together with arbitrary image data, are simultaneously displayed on the display 1 of an image display device 6 corresponding to the image display device shown in FIG. 23.

In the modified example 5, light emitted from the light-emitting/photo-detection cell CWR of the display 1 is used as a light source for use in detection of reflected light. Thus, light reflected from an object in contact with or in close proximity to the display device can be detected at any position on the display 1. The modified example 5 can achieve advantageous effects comparable to those of a touch panel, for example when button-like images composed of the predetermined marks 61 to 64 are displayed at arbitrary positions on the display 1 so that light reflected from the object is detected in each mark region. The modified example 5 also enables detection of the positions of a plurality of objects placed simultaneously, because detection of an object position occurs based on the photo-detection signal reconfigured by the photo-detection signal holder 33. This enables users to detect a plurality of objects in contact with or in close proximity to the display device, which are placed simultaneously at arbitrary positions on the image display device.

FIG. 25 shows the image display device shown in FIG. 23, illustrating movements of the predetermined marks. The image display device shown in FIG. 25 corresponds to the image display device 6 shown in FIG. 24. FIG. 25 shows movement of the mark 64, of a plurality of predetermined marks 61 to 64 displayed on the image display device 6 shown in FIG. 24, in the direction of the arrow 641. In FIG. 25, the same structural components as the components shown in FIG. 24 are designated by the same reference characters, and the description of the same components is appropriately omitted.

In the modified example 5, the display signal generator 212 has the function of replacing part of input image data with mark data for displaying a predetermined mark, and superimposing the image data on a display signal, as mentioned above. When the input image data is moving image data composed of a plurality of frames, the display signal generator 212 replaces part of the input image data with mark data at positions varying among frames according to the moving image data, thereby enabling a button-like portion to move as shown in, for example, FIG. 25, appear on a moving image portion, or appear or disappear as needed.

This enables users to detect an object in contact with or in close proximity to the display device at any position which is arbitrarily shifted on the image display device. Incidentally, the display signal generator 212 determines what type of image is displayed. Thus, when the button-like images composed of the predetermined marks are not displayed, users may avoid using position-detection-processed data in order to prevent erroneous detection.

### Third Embedment

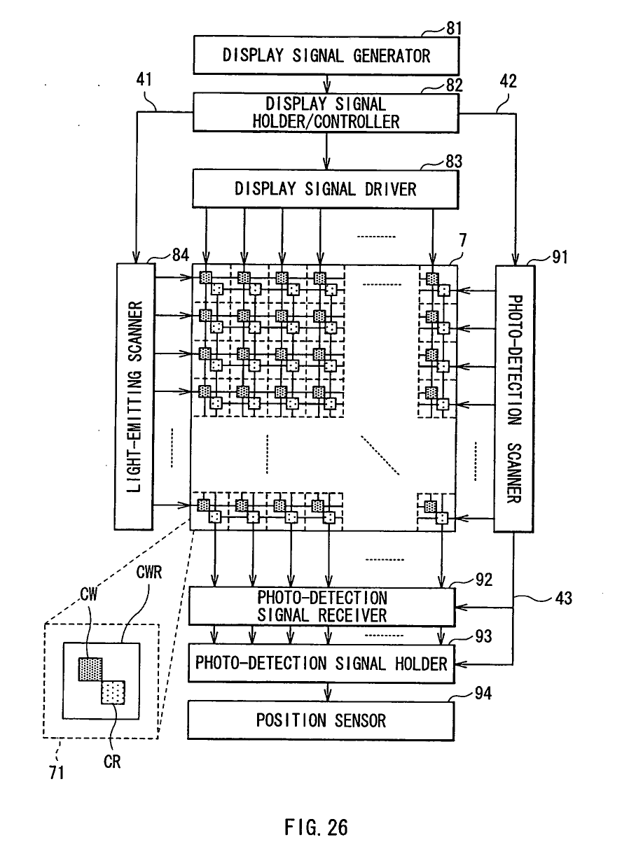

FIG. 26 shows the general configuration of an image display device according to a third embodiment of the invention.

The image display device of the third embodiment includes a display 7, a display signal generator 81, a display signal holder/controller 82, a display signal driver 83, a light-emitting scanner 84, a photo-detection scanner 91, a photo-detection signal receiver 92, a photo-detection signal holder 93, and a position sensor 94.

For example, the display 7 includes an organic or inorganic EL display or LCD including a matrix of a plurality of picture elements 71 over the whole surface. The display 7 provides display of a predetermined graphic or character image or other images, while performing line-sequential operation as will be described later. Each picture element 71 includes a light-emitting/photo-detection cell CWR having a light-emitting cell CW including one light-emitting device and a photo-detection cell CR including one photo-detection device. The picture elements 71 can operate independently of one another to perform light-emitting operation and photo-detection operation, as will be described later.

Upon receipt of feed of data generated by a CPU or the like (not shown), the display signal generator 81 generates a display signal for, for example, each frame (or each field), based on the fed data. The display signal generator 81 outputs the display signal to the display signal holder/controller 82.

The display signal holder/controller 82 has both the functions of holding and controlling as given below. Upon receipt of the display signal outputted by the display signal generator 81, the display signal holder/controller 82 stores and holds the display signal for each frame (or each field) in a field memory including an SRAM or the like, for example. The display signal holder/controller 82 also controls the light-emitting scanner 84 and display signal driver 83 for driving each light-emitting cell CW and the photo-detection scanner 91 for driving each photo-detection cell CR so that they operate in conjunction with one another. Specifically, the display signal holder/controller 82 outputs a light-emission timing control signal 41 and a photo-detection timing control signal 42 to the light-emitting scanner 84 and the photo-detection scanner 91, respectively. The display signal holder/controller 82 also outputs a display signal for one horizontal line to the display signal driver 83 in accordance with a control signal and the display signal held in the field memory. These control and display signals allow line-sequential operation, as will be described later.

The light-emitting scanner 84 has the function of selecting the light-emitting cell CW to be driven in accordance with the light-emission timing control signal 41 outputted by the display signal holder/controller 82. As will be specifically described later, the light-emitting scanner 84 controls a light-emitting device selector switch by feeding a light-emission select signal via a light-emitting gate line connected to each picture element 71 of the display 7. Specifically, when the light-emission select signal is fed to apply a voltage to turn on the light-emitting device selector switch of a picture element, the picture element performs light-emitting operation with brightness according to the voltage fed from the display signal driver 83.

The display signal driver 83 has the function of feeding display data to the light-emitting cell CW to be driven in accordance with the display signal for one horizontal line outputted by the display signal holder/controller 82. As will be specifically described later, the display signal driver 83 feeds a voltage for the display data to the picture element 71 selected by the light-emitting scanner 84 as mentioned above, via a data feed line connected to each picture element 71 of the display 7. The light-emitting scanner 84 and the display signal driver 83 operate in conjunction with each other to perform line-sequential operation, so that the display 7 provides display of an image corresponding to any display data.

The photo-detection scanner 91 has the function of selecting the photo-detection cell CR to be driven in accordance with the photo-detection timing control signal 42 outputted by the display signal holder/controller 82. As will be specifically described later, the photo-detection scanner 91 controls a photo-detection device selector switch by feeding a photo-detection select signal via a photo-detection gate line connected to each picture element 71 of the display 7. Specifically, as in the case of the operation of the light-emitting scanner 84 mentioned above, when the photo-detection select signal is fed to apply a voltage to turn on the photo-detection device selector switch of a picture element, a photo-detection signal detected by the picture element is outputted to the photo-detection signal receiver 92. Thus, a photo-detection cell CR can detect light emitted from a light-emitting cell CW and reflected from an object in contact with or in close proximity to the display device. The photo-detection scanner 91 also has the function of controlling as given below. The photo-detection scanner 91 outputs a photo-detection block control signal 43 to the photo-detection signal receiver 92 and the photo-detection signal holder 93 so as to control these blocks which contribute to photo-detection operation. In the image display device of the third embodiment, the light-emitting gate line and the photo-detection gate line, as mentioned above, are independently connected to each light-emitting/photo-detection cell CWR so that the light-emitting scanner 84 can operate independently of the photo-detection scanner 91.

The photo-detection signal receiver 92 has the function of obtaining the photo-detection signal for one horizontal line outputted by each photo-detection cell CR in accordance with the photo-detection block control signal 43 outputted by the photo-detection scanner 91. The photo-detection signal receiver 92 outputs the obtained photo-detection signal for one horizontal line to the photo-detection signal holder 93.

The photo-detection signal holder 93 has the following function. Upon receipt of the photo-detection signal outputted by the photo-detection signal receiver 92, the photo-detection signal holder 93 reconfigures the photo-detection signal to form a photo-detection signal for each frame (or each field) in accordance with the photo-detection block control signal 43 outputted by the photo-detection scanner 91. The photo-detection signal holder 93 then stores and holds the photo-detection signal for each frame (or each field) in a field memory including an SRAM or the like, for example. The photo-detection signal holder 93 outputs the stored photo-detection signal data to the position sensor 94. Incidentally, the photo-detection signal holder 93 may include any storage device other than the memory. For example, the photo-detection signal holder 93 can hold the photo-detection signal data as analog data. Hereinafter, it is understood that the photo-detection signal is held as analog data unless otherwise specified in the third embodiment.

The position sensor 94 has the following function. The position sensor 94 determines where an object detected by the photo-detection cell CR is situated, by performing signal processing based on the photo-detection signal data outputted by the photo-detection signal holder 93. This makes it possible to determine the position of an object in contact with or in close proximity to the display device. When the photo-detection signal holder 93 stores the photo-detection signal data as analog data as mentioned above, the position sensor 94 performs signal processing after performing A/D conversion.

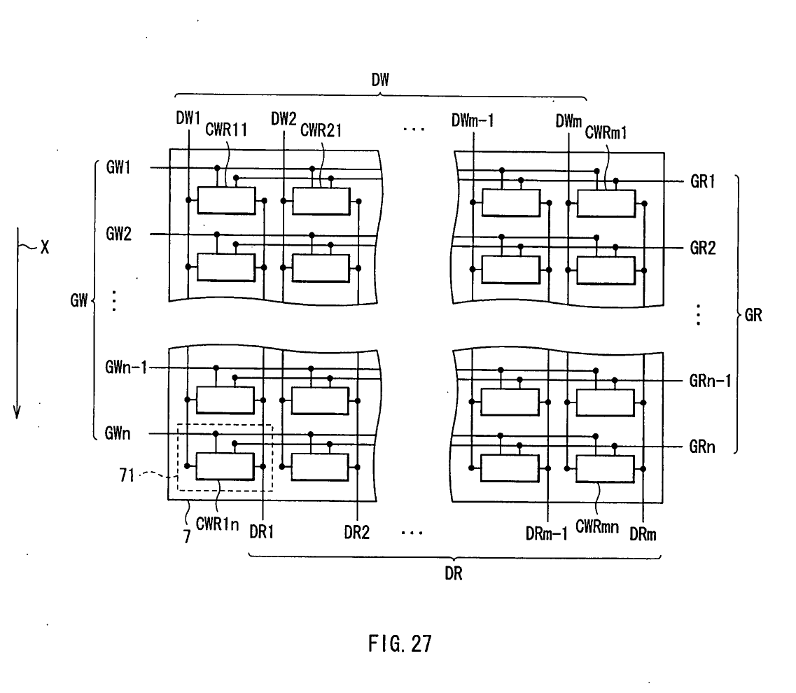

FIG. 27 shows an example of the configuration of the display 7 shown in FIG. 26. The display 7 is configured to have a matrix with a total of (m×n) picture elements 71, in which m picture elements 71 are arranged along each horizontal line and n picture elements 71 are arranged along each vertical line. For example when the display 7 is based on XGA standards which are general standards for displays for PCs and the like, the display 7 has a matrix with a total of 2,359,296 picture elements, in which m(=1024×3(RGB)) picture elements are arranged along each horizontal line and n(=768) picture elements are arranged along each vertical line.

As shown in FIG. 27, the display 7 includes a total of (m×n) picture elements 71, light-emitting/photo-detection cells CWR11 to CWRmn as mentioned above, each of which is included in the picture element 71, m data feed lines DW (DW1 to DWm) and m data read lines DR (DR1 to DRm) which are connected to the corresponding number of picture elements 71, and n light-emitting gate lines GW (GW1 to GWn) and n photo-detection gate lines GR (GR1 to GRn) which are connected to the corresponding number of picture elements 71.

The data feed line DW, the data read line DR, the light-emitting gate line GW and the photo-detection gate line GR are connected to the display signal driver 83, the photo-detection signal receiver 92, the light-emitting scanner 84 and the photo-detection scanner 91 so that the display signal, the light-emission select signal and the photo-detection select signal are fed to each light-emitting/photo-detection cell CWR and that the photo-detection signal is outputted by each light-emitting/photo-detection cell CWR. As shown in FIG. 27, one each of the data feed line DW, the data read line DR, the light-emitting gate line GW and the photo-detection gate line GR is connected to each light-emitting/photo-detection cell CWR. For example, one data feed line DW1 and one data read line DR1 are common and connected to the light-emitting/photo-detection cells from CWR11 to CWR1n belonging to one vertical line. For example, one light-emitting gate line GW and one photo-detection gate line GR are common and connected to the light-emitting/photo-detection cells from CWR11 to CWRm1 belonging to one horizontal line. Incidentally, the arrow X of FIG. 27 indicates the scan direction of the light-emitting gate line GW and the photo-detection gate line GR, as will be described later.

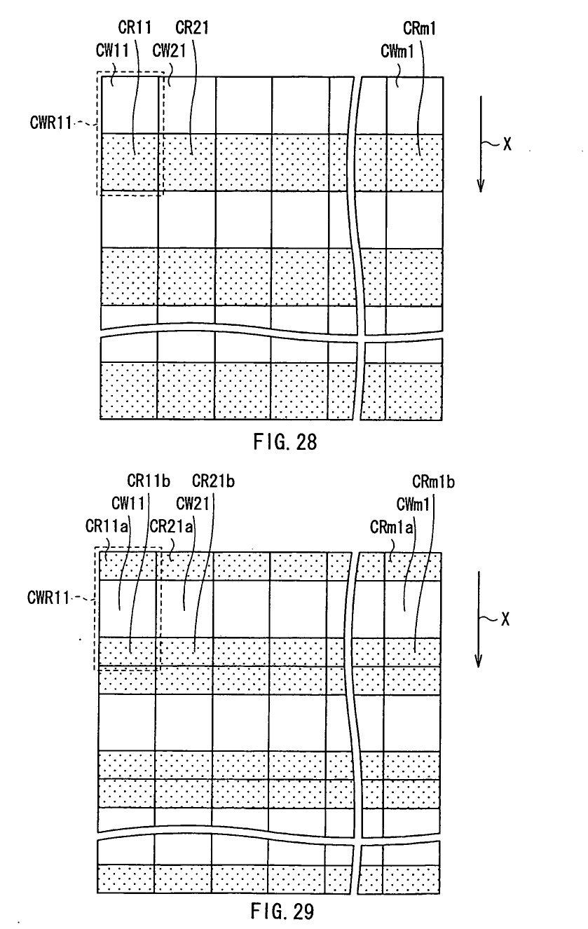

FIGS. 28 to 31 schematically illustrate, in plan view, examples of the arrangement of the light-emitting cell CW and photo-detection cell CR of the display 7 shown in FIG. 26.

FIG. 28 shows an example of the arrangement in which the light-emitting cell CW and the photo-detection cell CR are arranged vertically, that is, in the direction of the vertical line, in each light-emitting/photo-detection cell CWR of the display 7. In this instance, the light-emitting cells CW are arranged adjacent to each other horizontally, that is, in the direction of the horizontal line, and the photo-detection cells CR are arranged in the same manner. Specifically, for example, the light-emitting cells from CW11 to CWm1 are arranged adjacent to each other in the direction of the horizontal line, and the photo-detection cells from CR11 to CRm1 are arranged adjacent to each other in the direction of the horizontal line. In the example shown in FIG. 28, the light-emitting cell CW and the photo-detection cell CR are disposed upward and downward, respectively. Instead, the light-emitting cell CW and the photo-detection cell CR may be disposed downward and upward, respectively.

FIG. 29 shows another example of the arrangement in which the light-emitting cell CW and the photo-detection cell CR are vertically arranged in each light-emitting/photo-detection cell CWR of the display 7, as in the case of the example shown in FIG. 28. In the example shown in FIG. 29, each light-emitting/photo-detection cell CWR includes one light-emitting cell CW and two photo-detection cells CR, and one and the other of the photo-detection cells CR are disposed upward and downward, respectively, relative to the light-emitting cell CW. The upper one of these two photo-detection cells CR is indicated by CRa, and the lower one thereof is indicated by CRb. In this instance, as in the case of the example shown in FIG. 28, the light-emitting cells CW are arranged adjacent to each other horizontally, that is, in the direction of the horizontal line, the photo-detection cells CRa are arranged in the same manner, and the photo-detection cells CRb are arranged in the same manner. Specifically, for example, the light-emitting cells from CW11 to CWm1 are arranged adjacent to each other in the direction of the horizontal line, the photo-detection cells from CR11a to CRm1a are arranged adjacent to each other in the direction of the horizontal line, and the photo-detection cells from CR11b to CRm1b are arranged adjacent to each other in the direction of the horizontal line. Instead of the example shown in FIG. 29, each picture element may be configured in the following manner: each light-emitting/photo-detection cell CWR includes two light-emitting cells CW and one photo-detection cell CR, and one and the other of the light-emitting cells CW are disposed upward and downward, respectively, relative to the photo-detection cell CR.

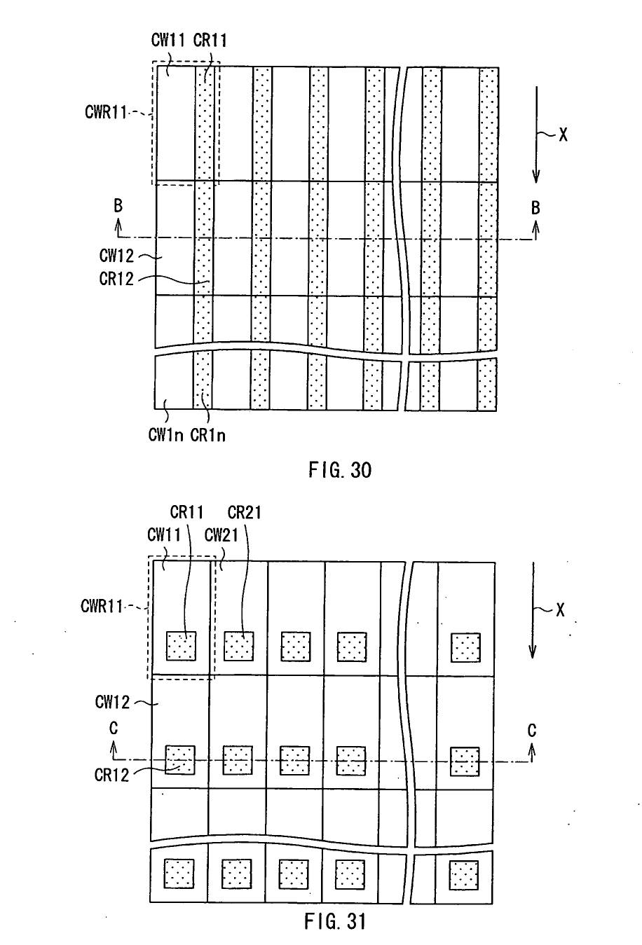

FIG. 30 shows an example of the arrangement in which the light-emitting cell CW and the photo-detection cell CR are arranged horizontally, that is, in the direction of the horizontal line, in each light-emitting/photo-detection cell CWR of the display 7. In this instance, the light-emitting cells CW are arranged adjacent to each other vertically, that is, in the direction of the vertical line, and the photo-detection cells CR are arranged in the same manner. Specifically, for example, the light-emitting cells from CW11 to CW1n are arranged adjacent to each other in the direction of the vertical line, and the photo-detection cells from CR11 to CR1n are arranged adjacent to each other in the direction of the vertical line. In the example shown in FIG. 30, the light-emitting cell CW and the photo-detection cell CR are disposed on the left and right, respectively. Instead, the light-emitting cell CW and the photo-detection cell CR may be disposed on the right and left, respectively.

FIG. 31 shows an example of the arrangement in which the photo-detection cell CR is contained within the light-emitting cell CW in each light-emitting/photo-detection cell CWR of the display 7. In this instance, the light-emitting cells CW are arranged to form a matrix, and the photo-detection cells CR are arranged to form a matrix, as in the case of the picture elements 71.

The arrangement of the light-emitting cell CW and photo-detection cell CR of the display 7 according to the third embodiment is not limited to the arrangements shown in the plan views of FIGS. 28 to 31 but may be any other arrangement.

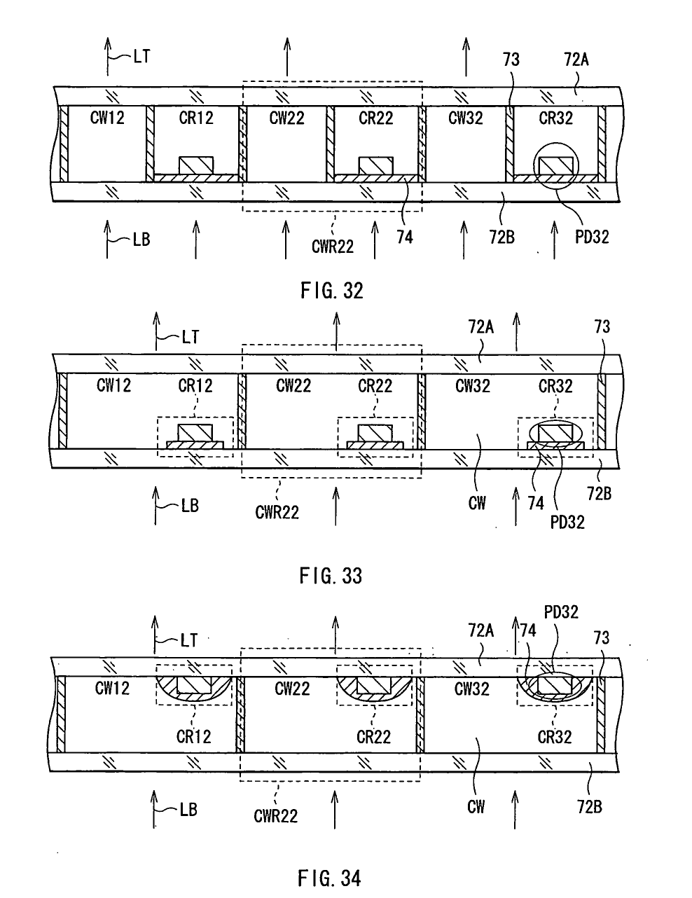

FIGS. 32 to 34 schematically illustrate, in sectional view, examples of the arrangement of the light-emitting cell CW and photo-detection cell CR of the display 7 shown in FIG. 26. In the examples of FIGS. 32 to 34, the light-emitting device included in the light-emitting cell CW is a liquid crystal device, and the display 7 is based on a transmissive liquid crystal display including a pair of transparent substrates and a backlighting light source facing one of the pair of transparent substrates.

FIG. 32 shows an example of the structure in which the light-emitting cell CW including the liquid crystal device which is the light-emitting device is separated by a partition 73 from the photo-detection cell CR including a photo-detection device PD. The sectional view of FIG. 32 corresponds to a horizontal section taken along the arrowed line B-B of the plan view of FIG. 30 and viewed in the direction of the arrow B. The display 7 includes a pair of transparent substrates 72A and 72B, a plurality of light-emitting cells CW (CW12, CW22, CW32, and the like), and a plurality of photo-detection cells CR (CR12, CR22, CR32, and the like). In the display 7, the light-emitting cells CW and the photo-detection cells CR are sandwiched in between the transparent substrates 72A and 72B, and as mentioned above, the light-emitting cells CW are separated from the photo-detection cells CR by the partitions 73 in such a manner that the light-emitting cells CW alternate with the photo-detection cells CR. As described above, the light-emitting cell CW includes the liquid crystal device which acts as the light-emitting device, and the photo-detection cell CR includes the photo-detection device PD (PD12, PD22, PD32, and the like). Incidentally, other layers of a general liquid crystal display are not shown but omitted in FIG. 32. Hereinafter, the same goes for FIGS. 33, 34 and 36. In FIG. 32, there are also shown backlight LB emitted from the backlighting light source (not shown), and transmitted light LT which is the backlight LB passing through the display 7 and exiting from the display 7. In FIG. 32, there is further shown a shield layer 74, which is disposed between the transparent substrate 72B facing the backlighting light source and the photo-detection device PD so as to prevent backlight LB from entering into the photo-detection cell CR. With the structure described above, the photo-detection device PD is not affected by backlight LB and can detect only light entering into the photo-detection device PD from the direction of the transparent substrate 72A opposite to the backlighting light source.

FIG. 33 shows an example of the structure in which the photo-detection cell CR including the photo-detection device PD is contained within the light-emitting cell CW including the liquid crystal device which is the light-emitting device. The sectional view of FIG. 33 corresponds to a horizontal section taken along the arrowed line C-C of the plan view of FIG. 31 and viewed in the direction of the arrow C. The display 7 includes a pair of transparent substrates 72A and 72B, a plurality of light-emitting cells CW (CW12, CW22, CW32, and the like) which are sandwiched in between the transparent substrates 72A and 72B and separated from one another by the partitions 73 as mentioned above, and a plurality of photo-detection cells CR (CR12, CR22, CR32, and the like), each of which is contained within the light-emitting cell. As described above, the light-emitting cell CW includes the liquid crystal device which acts as the light-emitting device, and the photo-detection cell CR includes the photo-detection device PD (PD12, PD22, PD32, and the like). In the example shown in FIG. 33, as in the case of the example shown in FIG. 32, the shield layer 74 is disposed between the transparent substrate 72B facing the backlighting light source and the photo-detection device PD so as to prevent backlight LB from entering into the photo-detection cell CR. Thus, the photo-detection device PD is not affected by backlight LB and detects only light entering into the photo-detection device PD from the direction of the transparent substrate 72A opposite to the backlighting light source.

FIG. 34 shows an example of the structure in which the photo-detection cell CR including the photo-detection device PD is contained within the light-emitting cell CW including the liquid crystal device which is the light-emitting device, as in the case of the example shown in FIG. 33. Likewise, the sectional view of FIG. 34 corresponds to a horizontal section taken along the arrowed line C-C of the plan view of FIG. 31 and viewed in the direction of the arrow C. In FIG. 34, the same structural components as the components shown in FIG. 33 are designated by the same reference characters, and the description of the same components is appropriately omitted. The structure of the display 7 shown in FIG. 34 is different from that of the display 7 shown in FIG. 33 in that the photo-detection cell CR is disposed on the transparent substrate 72A opposite to the backlighting light source. As in the case of the structures shown in FIGS. 32 and 33, the shield layer 74 is disposed facing the backlighting light source so as to prevent backlight LB from entering into the photo-detection device PD. Thus, the photo-detection device PD is not affected by backlight LB and detects only light entering into the photo-detection device PD from the direction of the transparent substrate 72A opposite to the backlighting light source.

The arrangement of the light-emitting cell CW and photo-detection cell CR of the display 7 according to the third embodiment is not limited to the arrangements shown in the sectional views of FIGS. 32 to 34 but may be any other arrangement.

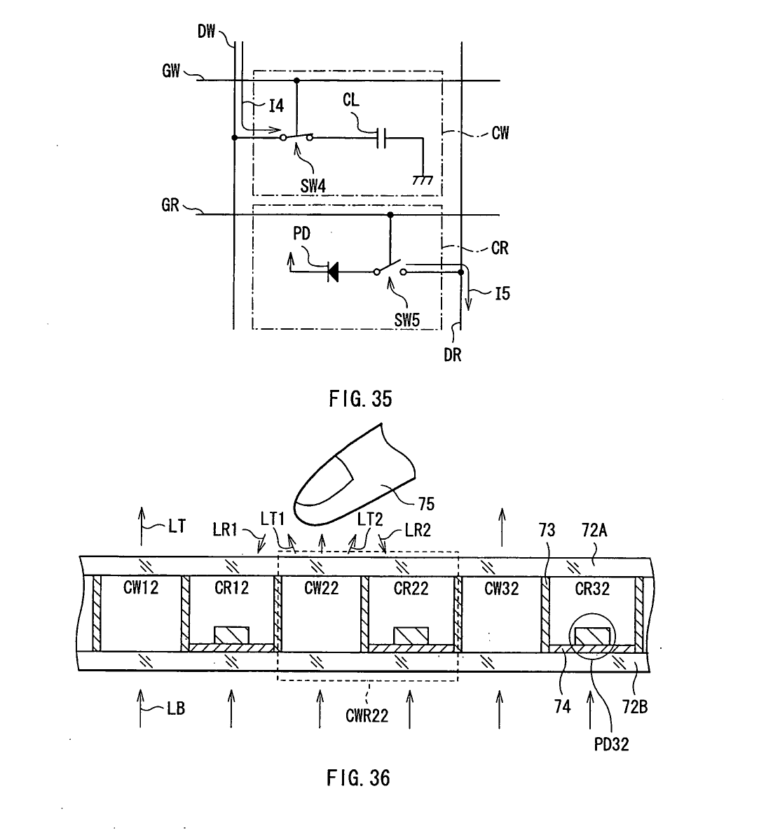

FIG. 35 shows the circuit configuration of the light-emitting/photo-detection cell CWR shown in FIG. 27.

The light-emitting/photo-detection cell CWR includes one light-emitting cell CW having connections to the light-emitting gate line GW and the data feed line DW, and one photo-detection cell CR having connections to the photo-detection gate line GR and the data read line DR. In other words, the light-emitting/photo-detection cell CWR has an added gate line and an added data line for use in photo-detection, as compared to a cell for one picture element, including only a typical light-emitting cell. The light-emitting cell CW includes one light-emitting device CL, and a light-emitting device selector switch SW4 which provides selective conduction between the data feed line DW and one end of the light-emitting device CL in accordance with the light-emission select signal fed via the light-emitting gate line GW. The other end of the light-emitting device CL is grounded. The photo-detection cell CR includes one photo-detection device PD, and a photo-detection device selector switch SW5 which provides selective conduction between one end of the photo-detection device PD and the data read line DR in accordance with the photo-detection select signal fed via the photo-detection gate line GR. The other end of the photo-detection device PD is grounded or connected to a positive bias point (not shown). In the circuit configuration of the light-emitting/photo-detection cell CWR, the light-emitting gate line and the photo-detection gate line are independently connected to each light-emitting/photo-detection cell CWR so that light-emitting operation can occur independently of photo-detection operation, as described above.

The specific description is now given with regard to how each component operates for light-emitting operation and photo-detection operation. The light-emitting operation involves turning on the light-emitting device selector switch SW4 in accordance with the light-emission select signal fed via the light-emitting gate line GW as described above; and charging the light-emitting device CL by feeding a current along a path I4 via the data feed line DW, thereby emitting light with brightness according to the display signal. The photo-detection operation involves turning on the photo-detection device selector switch SW5 in accordance with the photo-detection select signal fed via the photo-detection gate line GR as described above; and feeding a current to the data read line DR along a path I5 according to the amount of light detected by the photo-detection device PD. When neither of the light-emitting and photo-detection operations takes place, both of the light-emitting device selector switch SW4 and the photo-detection device selector switch SW5 are off so that the data feed line DW and the data read line DR are disconnected from the light-emitting device CL and the photo-detection device PD, respectively.

Next, the description is given with regard to how the image display device configured as mentioned above operates to detect an object in contact with or in close proximity to the display device.

Firstly, the description is given with reference to FIG. 36 with regard to how the image display device configured as mentioned above operates to detect an object in contact with or in close proximity to the display device. FIG. 36 shows an example of a process for detecting a target object, which is executed by the image display device shown in FIG. 26. FIG. 36 corresponds to FIG. 32 showing the example of the structure in which the light-emitting cell CW including the liquid crystal device which is the light-emitting device is separated by the partition 73 from the photo-detection cell CR including the photo-detection device PD. In FIG. 36, the same structural components as the components shown in FIG. 32 are designated by the same reference characters, and the description of the same components is appropriately omitted.

As shown in FIG. 36, for example when a target object 75 such as a finger is brought into contact or close proximity with the display 7, transmitted light beams LT1 and LT2 emitted from the light-emitting cell CW22, for example, are reflected by the target object 75. Reflected light beams LR1 and LR2 enter into the photo-detection cell, such as CR12 or CR22, located near the light-emitting cell CW22, but the reflected light beams do not enter into the photo-detection cell located far away from the light-emitting cell CW22. Thus, the photo-detection signal is obtained from only the photo-detection cell CR located near a target object 75. For example, driving is performed in such timing that light, which is emitted from the light-emitting cell CW belonging to the horizontal line driven for light emission and is reflected from the target object 75, is detected by the photo-detection device belonging to the horizontal line which is emitting the light. The photo-detection signal is detected by the photo-detection device close to the target object 75, whereas the photo-detection signal is not detected in the other regions. This makes it possible to sense where the target object 75 is situated on the display 7. Sequential execution of such light-emission driving and photo-detection driving for each horizontal line (hereinafter referred to as “line-sequential driving”) enables detecting the target object 75 while displaying an image throughout the display 7.

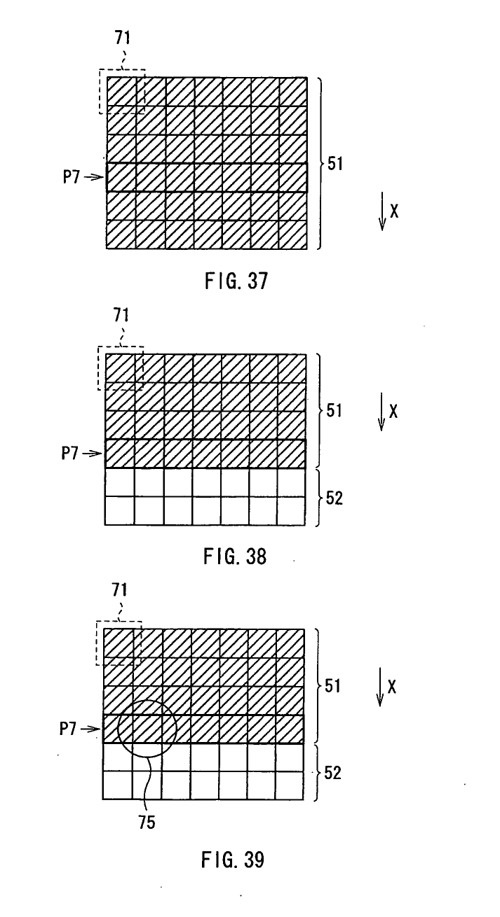

FIGS. 37 and 38 show examples of line-sequential light-emitting operation, which is performed by the image display device shown in FIG. 26. Each of squares shown in FIGS. 37 and 38 represents the picture element 71 of the display 7.

In the example of line-sequential light-emitting operation shown in FIG. 37, one horizontal line at the position indicated by the arrow P7, for example, performs light-emitting operation in sequence in the scan direction X under the control of the light-emitting scanner 84 and the display signal driver 83 as previously mentioned. In this example, one horizontal line at the position indicated by the arrow P7 is kept in a light-emitting state until the completion of a round of rendering of display data on the screen, that is, until next image data is fed by the display signal driver 83. Thus, the overall display 7 acts as the light-emitting region 51. As mentioned above, when one horizontal line at the position indicated by the arrow P7 performs line-sequential light-emitting operation, the whole display 7 can act as the light-emitting region to display image data throughout the display 7.

In the example of line-sequential light-emitting operation shown in FIG. 38, one horizontal line at the position indicated by the arrow P7, for example, performs light-emitting operation in sequence in the scan direction X, as in the case of the example shown in FIG. 37. In the example shown in FIG. 38, one horizontal line at the position indicated by the arrow P7, however, is kept in the light-emitting state until a given time elapses after rendering of display data on the screen, that is, during a given period of time before next image data is fed by the display signal driver 83. Thus, the overall display 7 is divided into the light-emitting region 51 and the non-emitting region 52. Also in this instance, when one horizontal line at the position indicated by the arrow P7 performs line-sequential light-emitting operation, the whole or great part of the display 7 can act as the light-emitting region to display image data throughout the display 7 within the given time during which the horizontal line is kept in the light-emitting state. The time period during which the horizontal line is kept in the light-emitting state is determined by, for example, the capacitance value of the light-emitting device CL in the circuit configuration of the light-emitting cell CW shown in FIG. 35, and the time period can be optionally set. In the example shown in FIG. 38, the non-emitting region 52 is present in the display 7. However, the presence of the non-emitting region 52 presents no problem, because the non-emitting region 52 also moves in a line-sequential fashion and is not visually identified due to the effect of an afterimage phenomenon.

FIG. 39 shows an example of line-sequential photo-detection operation added to either one of the line-sequential light-emitting operations shown in FIGS. 37 and 38, which is performed by the image display device shown in FIG. 26. In the example shown in FIG. 39, line-sequential photo-detection operation is added to the line-sequential light-emitting operation shown in FIG. 38. However, line-sequential photo-detection operation may be added to the line-sequential light-emitting operation shown in FIG. 37.

In the example shown in FIG. 39, one horizontal line at the position indicated by the arrow P7, for example, performs light-emitting operation in sequence in the scan direction X, as in the case of the examples shown in FIGS. 37 and 38. Moreover, one horizontal line at the position indicated by the arrow P7 performs line-sequential photo-detection operation in the scan direction X so as to detect light emitted from the light-emitting region 51 and reflected from the target object 75 as previously mentioned. As mentioned above, one horizontal line at the position indicated by the arrow P7 performs line-sequential light-emitting operation and also performs line-sequential photo-detection operation to detect light emitted from the light-emitting region and reflected from the target object. Thus, the whole display 7 can act as both the light-emitting and photo-detection regions to allow not only displaying image data throughout the display 7, but also detecting the presence or absence of the target object 75 close to the display 7 and detecting the position of the target object 75 if the target object 75 is present, in accordance with the photo-detection signal detected by the photo-detection device. Also in this instance, the light-emitting state is maintained during a given period of time until a given time elapses after rendering of display data on the screen. Thus, the overall display 7 is divided into the light-emitting region 51 and the non-emitting region 52.

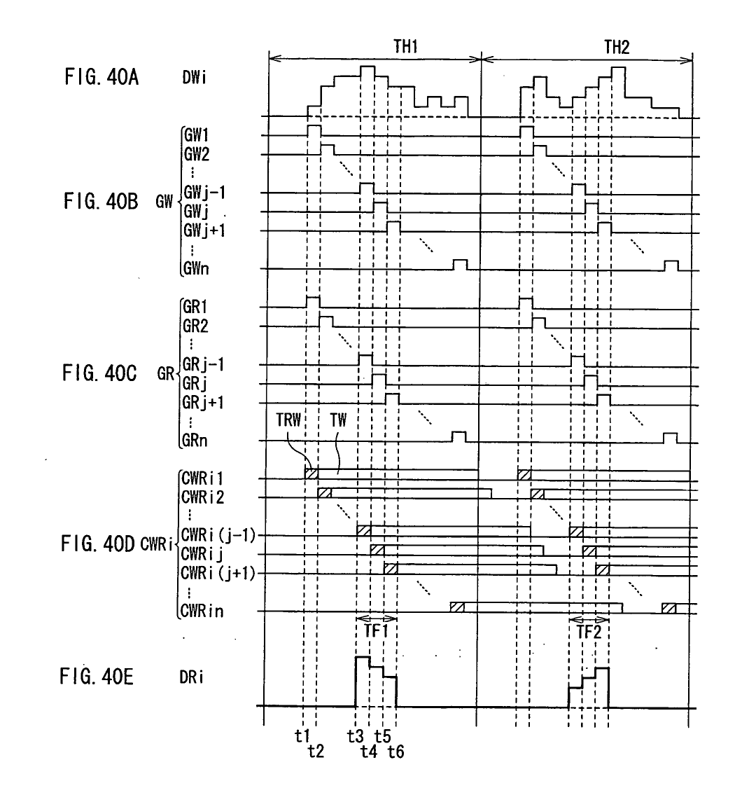

Next, the description is given with reference to FIG. 27, FIGS. 37 to 39 and FIGS. 40A to 40E with regard to the details of the process for detecting the target object 75, which is executed by the image display device shown in FIG. 26. FIGS. 40A to 40E show the process for detecting the target object 75, which is executed by the image display device shown in FIG. 26. FIG. 40D shows one vertical line of light-emitting/photo-detection cells CWRi (CWRi1 to CWRin). FIG. 40A shows a signal on a data feed line DWi connected to the cells CWRi. FIG. 40B shows signals on light-emitting gate lines GW (GW1 to GWn) connected to the cells CWRi. FIG. 40C shows signals on photo-detection gate lines GR (GR1 to GRn) connected to the cells CWRi. FIG. 40E shows a signal on a data read line DRi connected to the cells CWRi. In FIGS. 40A to 40E, each of the reference characters i and j indicating the position represents a given natural number. For example when the display is based on XGA standards as previously set forth (m=1024×3(RGB), n=768), i=1536 and j=384 for, for instance, the center of the display. The same goes for the following timing charts.

In FIGS. 40A to 40E, the horizontal axis indicates time, and vertical periods TH1 and TH2 represent the time required to scan the whole screen of the display 7, specifically the time required for the light-emitting scanner 84 and the photo-detection scanner 91 to scan the light-emitting gate lines GW1 to GWn and the photo-detection gate lines GR1 to GRn, respectively. Assuming that the target object 75 is situated near the light-emitting/photo-detection cells CWRi(j−1), CWRij and CWRi(j+1) of the display 7, the photo-detection signal is detected during the corresponding time period, specifically a time period between time t3 and t6 in the vertical period TH1 (i.e., a photo-detection signal detection period TF1). Likewise, the photo-detection signal is detected during a photo-detection signal detection period TF2 in the vertical period TH2. In FIGS. 40A to 40C and 40E, the vertical axis indicates the voltage of each signal shown in FIGS. 40A to 40C and 40E at each time. In this instance, the signal on the data feed line DWi shown in FIG. 40A is display data corresponding to any brightness for each picture element 71, and thus the display 7 provides display of any image. In FIG. 40D, there are shown a light-emission/photo-detection period TRW and a light-emission period TW of each light-emitting/photo-detection cell CWRi. Any time period other than the light-emission/photo-detection period TRW and the light-emission period TW is an inactive period. The time periods during which the light-emitting device CL emits light (i.e., the light-emission/photo-detection period TRW and the light-emission period TW) are defined in the following manner. The light-emission/photo-detection period TRW is a time period during which driving for light emission takes place based on image data (i.e., a time period during which the light-emitting device selector switch SW1 shown in FIG. 35 is on). The light-emission period TW is a time period during which the light-emitting state is maintained by the capacitance value of the light-emitting device CL shown in FIG. 35.

In the example of the process shown in FIGS. 40A to 40E, the light-emitting scanner 84 and the photo-detection scanner 91 perform scanning for light-emitting operation and scanning for photo-detection operation, respectively, on one and the same horizontal line at the same time in a line-sequential fashion. As previously mentioned, scanning for light-emitting operation can occur independently of scanning for photo-detection operation. In the example of line-sequential light-emitting operation shown in FIGS. 40A to 40E, the light-emitting state is maintained during a given period of time as shown in FIGS. 38 and 39, and the time period can be optionally set as previously mentioned. In the example shown in FIGS. 40A to 40E, the signal on the data read line DRi shown in FIG. 40E is stored as analog data in the photo-detection signal holder 93. However, the signal may be stored as digital data in the photo-detection signal holder 93, as previously set forth.

First, none of the light-emitting gate lines GW and photo-detection gate lines GR provides output of the select signal. Thus, both of the light-emitting device selector switch SW4 and the photo-detection device selector switch SW5 of each light-emitting/photo-detection cell CWR are off, so that the data feed line DW and the data read line DR are disconnected from the light-emitting device CL and the photo-detection device PD, respectively. Thus, during this time period, each light-emitting/photo-detection cell CWR is in an inactive state.

At time t1, the light-emitting gate line GW1 (see FIG. 40B) and the photo-detection gate line GR1 (see FIG. 40C) then provide output of the light-emission select signal and the photo-detection select signal, respectively. Thus, the light-emitting device selector switches SW4 and the photo-detection device selector switches SW5 of the light-emitting/photo-detection cells from CWR11 to CWRm1 connected to these gate lines are turned on at a time. During the light-emission/photo-detection period TRW shown in FIG. 40D, the light-emitting/photo-detection cell CWRi (see FIG. 40D) performs light-emitting operation by charging the light-emitting device CL by feeding a current along the display signal current path I4 shown in FIG. 35, and also performs photo-detection operation by feeding a current to the data read line DRi (see FIG. 40E) along the path I5 according to the amount of light detected by the photo-detection device PD. During this time period (i.e., a time period between time t1 and t2), the photo-detection signal resulting from the target object 75 is not detected, and thus the data read line DRi (see FIG. 40E) does not provide an output signal.

At time t2 and thereafter, in the same manner as above described, the light-emitting gate line GW2 (see FIG. 40B) and the photo-detection gate line GR2 (see FIG. 40C), the light-emitting gate line GW3 (see FIG. 40B), the photo-detection gate line GR3 (see FIG. 40C), and the like undergo the light-emitting and photo-detection operations in a line-sequential fashion. Likewise, the photo-detection signal resulting from the target object 75 is not detected, and thus the data read line DRi (see FIG. 40E) does not provide an output signal. After the end of the light-emission/photo-detection period TRW, each light-emitting/photo-detection cell CWRi is kept in a state of the light-emission period TW during a given period of time, as previously mentioned.

During the time period between time t3 and t6, the light-emitting/photo-detection cells CWRi(j−1), CWRij and CWRi(j+1) (see FIG. 40D) then detect light reflected from the target object 75, convert a current into a voltage according to the amount of light detected as shown in FIGS. 40A to 40E, and output a signal to the data read line DRi (see FIG. 40E) (the photo-detection signal detection period TF1). In this case, the light-emitting/photo-detection cells CWRi(j−1), CWRij and CWRi(j+1) (see FIG. 40D) mainly detect light emitted from these cells in themselves and reflected from the target object 75. Thus, the signal outputted to the data read line DRi (see FIG. 40E) has a value according to the signal on the data feed line DWi (see FIG. 40A).

At time t6 and thereafter, as in the case of the time period between time t1 and t3, the light-emitting gate line GWj+2 (see FIG. 40B) and the photo-detection gate line GRj+2 (see FIG. 40C), the light-emitting gate line GWj+3 (see FIG. 40B), the photo-detection gate line GRj+3 (see FIG. 40C), and the like the light-emitting gate line GWn (see FIG. 40B) and the photo-detection gate line GRn (see FIG. 40C) undergo the light-emitting and photo-detection operations in a line-sequential fashion. Likewise, the photo-detection signal resulting from the target object 75 is not detected, and thus the data read line DRi (see FIG. 40E) does not provide an output signal.

In this manner, in the vertical period TH1, the presence of the target object 75 near the light-emitting/photo-detection cells CWRi(j−1), CWRij and CWRi(j+1) can be detected. In the vertical period TH2 and thereafter, the same operation takes place. For example during the photo-detection signal detection period TF2 in the vertical period TH2, the data read line DRi (see FIG. 40E) provides an output signal. Likewise, this results in detection of the presence of the target object 75 near the light-emitting/photo-detection cells CWRi(j−1), CWRij and CWRi(j+1).

As described above, according to the image display device and the method of driving an image display device of the third embodiment, the image display device includes the display 7 having an arrangement of a plurality of light-emitting/photo-detection cells CWR, each of which has the light-emitting cell CW including one light-emitting device CL and the photo-detection cell CR including one photo-detection device PD. The light-emitting scanner 84 and the display signal driver 83 drive the light-emitting devices CL in accordance with image data generated by the display signal generator 81. The photo-detection scanner 91 drives the photo-detection device PD to detect light emitted from the driven light-emitting device CL and reflected from the target object 75. The position sensor 94 detects the target object 75 in accordance with a photo-detection signal which the photo-detection signal receiver 92 obtains from the driven photo-detection device PD. This eliminates the need for adding a separate component such as a touch panel or an input device and thus provides a simple structure, and also eliminates the need for the passage of light emitted from the display 7 through a separate component such as a touch panel and thus prevents image degradation. Therefore, the device and the method of the third embodiment enable detecting an object position and the like without image degradation, while ensuring a simple structure.

According to the image display device and the method of driving an image display device of the third embodiment, each light-emitting cell CW performs line-sequential light-emitting operation, and each photo-detection cell CR performs line-sequential photo-detection operation. This allows not only displaying image data by normal light-emitting operation, but also detecting an object position and the like.

According to the image display device and the method of driving an image display device of the third embodiment, when a target object such as a finger is brought into contact or close proximity with the display 7, the detecting process takes place to detect its position and the like. This enables users to conveniently operate the device through the same operation as touch panel operation.

According to the image display device and the method of driving an image display device of the third embodiment, the light-emitting gate line GW is independent of the photo-detection gate line GR so that light-emitting operation can occur independently of photo-detection operation. For example, a scan rate for light-emitting operation is set to a rate of 60 frames per second, and a scan rate for photo-detection operation is set to a high rate, specifically a rate of 120 frames per second, which is twice the scan rate for light-emitting operation. This enables more accurate detection of the position and other conditions of an object which moves at high speed. Instead, a scan rate for light-emitting operation is set to a rate of 60 frames per second, and a scan rate for photo-detection operation is set to a low rate, specifically a rate of 30 frames per second, which is half the scan rate for light-emitting operation. This allows an increase in the amount of sense current, thus an increase in an S/N ratio, and thus an improvement in detectivity.

The description is given below with regard to some modified examples of the third embodiment.

### MODIFIED EXAMPLE 6

Firstly, the description is given with regard to a modified example 6. In the modified example 6, the third embodiment is adapted so that the photo-detection scanner 91 performs thinned-out driving relative to the light-emitting scanner 84.

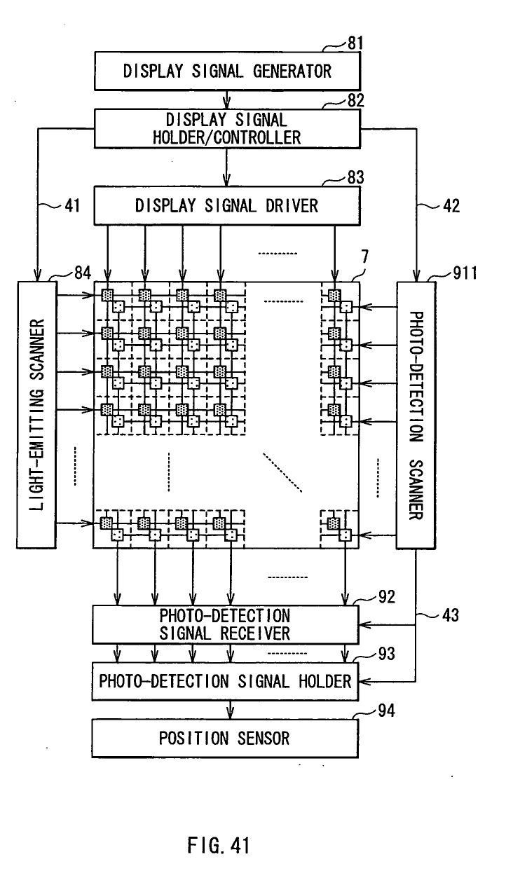

FIG. 41 shows the general configuration of an image display device according to the modified example 6. In FIG. 41, the same structural components as the components shown in FIG. 26 are designated by the same reference characters, and the description of the same components is appropriately omitted. The image display device of the modified example 6 includes a display 7, a display signal generator 81, a display signal holder/controller 82, a display signal driver 83, a light-emitting scanner 84, a photo-detection scanner 911, a photo-detection signal receiver 92, a photo-detection signal holder 93, and a position sensor 94. In short, the image display device includes the photo-detection scanner 911 in place of the photo-detection scanner 91 of the third embodiment shown in FIG. 26.

The photo-detection scanner 911 is the same as the photo-detection scanner 91 in that the photo-detection scanner 911 has the function of selecting the photo-detection cell CR to be driven in accordance with the photo-detection timing control signal 42 outputted by the display signal holder/controller 82. The photo-detection scanner 911 is different from the photo-detection scanner 91 in that the photo-detection scanner 911 performs thinned-out driving relative to the light-emitting scanner 84, as mentioned above. As will be specifically described later, the light-emitting scanner 84 scans the light-emitting gate lines GW, namely, from GW1 to GWn, as in the case of the third embodiment, whereas the photo-detection scanner 911 scans the photo-detection gate lines GR, namely, from GR1 to GRn-1, every other line and does not scan the other photo-detection gate lines from GR2 to GRn. Incidentally, n denotes an even number, taking it into account that the display 7 is based on, for example, XGA standards as previously set forth (m=1024×3(RGB), n=768). For the sake of convenience, j denotes an odd number.

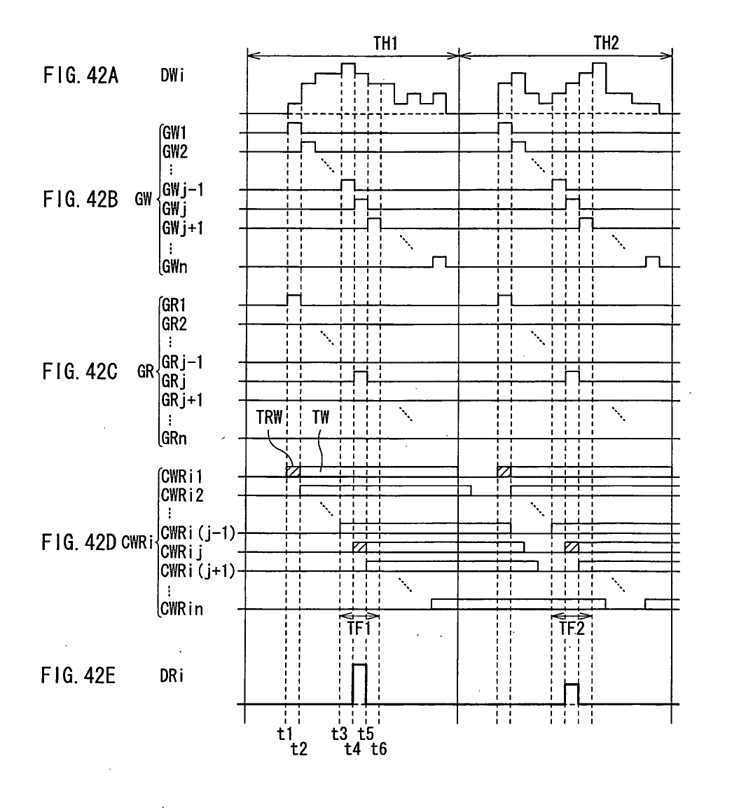

FIGS. 42A to 42E show a process for detecting the target object 75, which is executed by the image display device shown in FIG. 41. Since the basic operation of a method of driving an image display device of the modified example 6 is the same as that of the method of driving an image display device of the third embodiment, the description of the basic operation is omitted, and the description is given with regard to only operation associated with the photo-detection scanner 911.

As shown in FIGS. 42A to 42E and mentioned above, the light-emitting gate lines GW, namely, from GW1 to GWn (see FIG. 42B) provide output of the light-emission select signal as in the case of the third embodiment, whereas the photo-detection gate lines GR, namely, from GR1 to GRn-1 (see FIG. 42C) provide output of the photo-detection select signal every other line, and the other photo-detection gate lines from GR2 to GRn do not receive output of the photo-detection select signal. Correspondingly, the data read line DR also provides thinned-out output according to the photo-detection gate lines GR. Thus, the photo-detection signal is not detected during, for example, time periods between time t1 and t2, between time t3 and t4, and between time t5 and t6, and the photo-detection signal is detected during, for example, a time period between time t4 and t5. This allows reducing the amount of data of the photo-detection signal.

As described above, according to the image display device and the method of driving an image display device of the modified example 6, the photo-detection scanner 911 performs thinned-out driving relative to the light-emitting scanner 84. Thus, the modified example 6 can achieve a reduction in the amount of data of the photo-detection signal, thus a simplification of photo-detection circuits (i.e., the photo-detection scanner 911, the photo-detection signal receiver 92, and the photo-detection signal holder 93), and also a reduction in power consumption, as well as the advantageous effects of the third embodiment. Thus, the modified example 6 is especially effective when there is a desire for a simplification of the circuit configuration and a reduction in power consumption rather than the accuracy of detection of the position of an object in contact with or in close proximity to the display device.

Although the description has been given with regard to the modified example 6 where the odd-numbered photo-detection gate lines alone are scanned, the modified example 6 is not limited to this configuration. The modified example 6 may have any other configuration, provided that it can achieve a simplification of the photo-detection circuits and a reduction in power consumption. For example, the modified example 6 may be configured to scan only the even-numbered photo-detection gate lines instead, or to scan the photo-detection gate lines every two or three lines, for instance.

### MODIFIED EXAMPLE 7

Next, the description is given with regard to a modified example 7. In the modified example 7, the third embodiment is adapted so that four photo-detection cells CR detect light beams emitted from four light-emitting cells CW, add photo-detection signals to form one photo-detection signal, and output the resultant photo-detection signal.

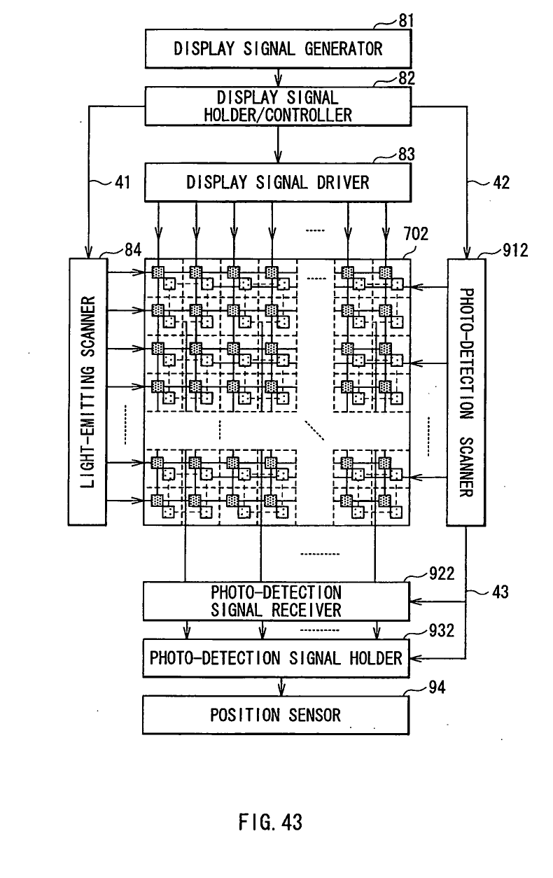

FIG. 43 shows the general configuration of an image display device according to the modified example 7. In FIG. 43, the same structural components as the components shown in FIG. 26 are designated by the same reference characters, and the description of the same components is appropriately omitted. The image display device of the modified example 7 includes a display 702, a display signal generator 81, a display signal holder/controller 82, a display signal driver 83, a light-emitting scanner 84, a photo-detection scanner 912, a photo-detection signal receiver 922, a photo-detection signal holder 932, and a position sensor 94. In short, the display 702, the photo-detection scanner 912, the photo-detection signal receiver 922 and the photo-detection signal holder 932 replace the display 7, the photo-detection scanner 91, the photo-detection signal receiver 92 and the photo-detection signal holder 93, respectively, of the third embodiment shown in FIG. 26.

The display 702 is the same as the display 7 in that the display 702 has a matrix of a plurality of picture elements 71 over the whole surface and provides display of a predetermined graphic or character image or other images while performing line-sequential operation. The display 702 is different from the display 7 in that four photo-detection cells are linked to operate collectively. As specifically described above, four photo-detection cells detect light beams emitted from four light-emitting cells, add photo-detection signals to form one photo-detection signal, and output the resultant photo-detection signal.

The photo-detection scanner 912 is the same as the photo-detection scanner 91 in that the photo-detection scanner 912 has the function of selecting the photo-detection cell CR to be driven in accordance with the photo-detection timing control signal 42 outputted by the display signal holder/controller 82. The photo-detection scanner 912 is different from the photo-detection scanner 91 in that the number of photo-detection gate lines is correspondingly reduced by half because four photo-detection cells disposed on the display 702 are linked to operate collectively as mentioned above. As will be specifically described later, the light-emitting scanner 84 scans the light-emitting gate lines GW, namely, from GW1 to GWn, as in the case of the third embodiment, whereas the photo-detection scanner 912 scans the photo-detection gate lines GR, namely, from GR1 to GRn-1, because of a reduction in the number of photo-detection gate lines by half. In this instance, the photo-detection gate lines are composed of only the odd-numbered photo-detection gate lines as mentioned above, and n denotes an even number as in the case of the modified example 6. Likewise, j denotes an odd number for the sake of convenience.

The photo-detection signal receiver 922 is the same as the photo-detection signal receiver 92 in that the photo-detection signal receiver 922 has the function of obtaining the photo-detection signal for one horizontal line outputted by each photo-detection cell CR in accordance with the control signal outputted by the photo-detection scanner 912. The photo-detection signal receiver 922 is different from the photo-detection signal receiver 92 in that the number of data read lines DR is correspondingly reduced by half because of the configuration of the display 702. Specifically, the data read lines DR are composed of the data read lines from DR1 to DRm-1 because of a reduction in the number of data read lines by half. In this instance, the data read lines are composed of only the odd-numbered data read lines as mentioned above, and m denotes an even number. For the sake of convenience, i denotes an odd number as in the case of j.

The photo-detection signal holder 932 has the same function as the photo-detection signal holder 93. Specifically, upon receipt of the photo-detection signal outputted by the photo-detection signal receiver 922, the photo-detection signal holder 932 reconfigures the photo-detection signal to form a photo-detection signal for each frame in accordance with the photo-detection block control signal 43 outputted by the photo-detection scanner 912, and then stores and holds the photo-detection signal for each frame. The photo-detection signal holder 932 is different from the photo-detection signal holder 93 in that the number of storage devices is reduced and thus the holder 932 is simplified, because of a reduction in the number of data read lines DR by half due to the configuration of the display 702.

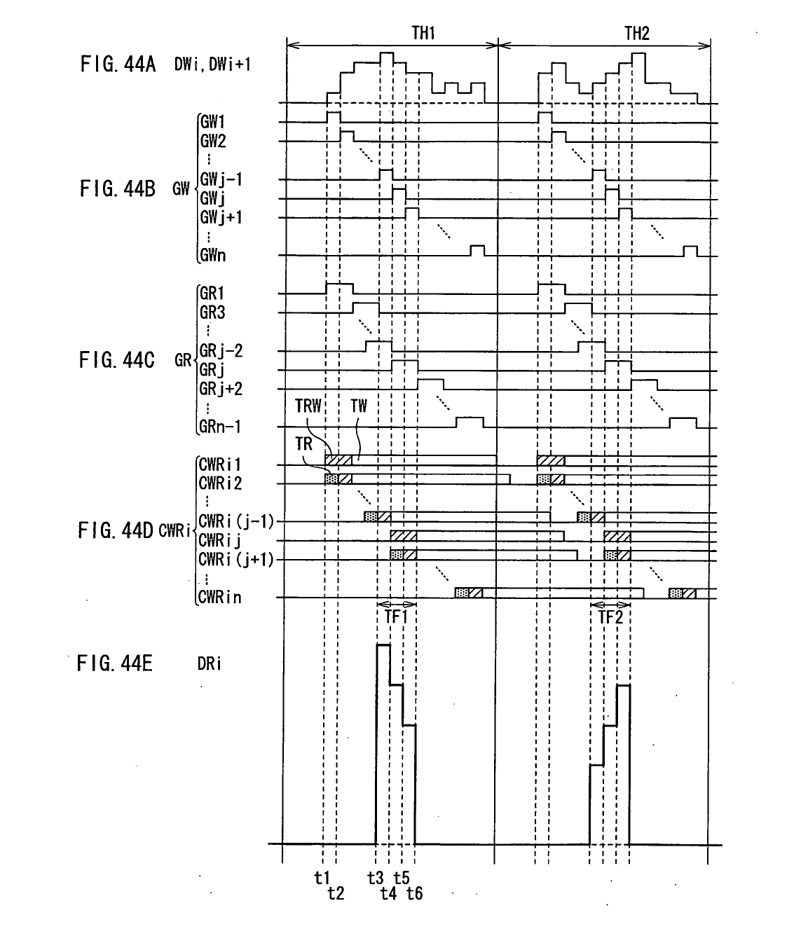

FIGS. 44A to 44E show a process for detecting the target object 75, which is executed by the image display device shown in FIG. 43. Since the basic operation of a method of driving an image display device of the modified example 7 is the same as that of the method of driving an image display device of the third embodiment, the description of the basic operation is omitted, and the description is given with regard to only operation associated with the display 702, the photo-detection scanner 912, the photo-detection signal receiver 922 and the photo-detection signal holder 932. In this instance, the data feed lines DWi and DWi+1 (see FIG. 44A) feed one and the same display data for the sake of convenience, and FIG. 44A shows both the lines DWi and DWi+1 collectively. In FIG. 44D, there are shown the light-emission/photo-detection period TRW, the light-emission period TW and the photo-detection period TR of each light-emitting/photo-detection cell CWRi. Any time period other than the light-emission/photo-detection period TRW, the light-emission period TW and the photo-detection period TR is an inactive period.

As shown in FIGS. 44A to 44E and mentioned above, the light-emitting gate lines GW, namely, from GW1 to GWn (see FIG. 44B) provide output of the light-emission select signal, as in the case of the third embodiment. Because of a reduction in the number of photo-detection gate lines by half, the photo-detection gate lines GR, namely, from GR1 to GRn-1 (see FIG. 44C) provide output of the photo-detection select signal. Moreover, the signal pulse width of the photo-detection gate line GR (see FIG. 44C) is twice that of the light-emitting gate line GW (see FIG. 44B) and that of the gate line GR of the third embodiment shown in FIG. 40C. Thus, the operation of the light-emitting/photo-detection cells from CWRi2 to CWRin is different from the operation of these cells of the third embodiment shown in FIG. 40D. The specific description is given by taking as an example the light-emitting/photo-detection cell CWRi2. In the third embodiment shown in FIG. 40D, the cell CWRi2 is in a state of the inactive period during the time period between time t1 and t2. In the modified example 7, the cell CWRi2 is in a state of the photo-detection period TR during the time period between time t1 and t2. The reason is as follows. In the modified example 7, during the time period between time t1 and t2, the light-emitting gate line GW2 does not provide output of the light-emission select signal, whereas the photo-detection gate line GR1 provides output of the photo-detection select signal to not only the light-emitting/photo-detection cell CWRi1 but also the light-emitting/photo-detection cell CWRi2. Thus, in this instance, the light-emission and photo-detection periods of the light-emitting/photo-detection cells from CWRi1 to CWRin-1 are different from those of the light-emitting/photo-detection cells from CWRi2 to CWRin.

In the modified example 7, as shown in FIG. 43, four photo-detection cells add detected photo-detection signals to form one photo-detection signal, and output the resultant photo-detection signal to the data read line DR. Thus, for example, during a time period between time t4 and t5, four light-emitting/photo-detection cells CWRij, CWRi(j+1), CWR(i+1)j and CWR(i+1)(j+1) add detected photo-detection signals to form one signal, and output the resultant signal to the data read line DRi (see FIG. 44E). Thus, in this example, the amount of photo-detection signal on the data read line DRi (see FIG. 44E) is about four times the amount of photo-detection signal of the third embodiment shown in FIG. 40E, because the data feed lines DWi and DWi+1 (see FIG. 44A) feed one and the same display data. In this manner, the modified example 7 can reduce the amount of data of the photo-detection signal and also increase the amount of photo-detection signal.

As described above, according to the image display device and the method of driving an image display device of the modified example 7, four photo-detection cells detect light beams emitted from four light-emitting cells, add photo-detection signals to form one photo-detection signal, and output the resultant photo-detection signal. Thus, the modified example 7 can achieve a reduction in the amount of data of the photo-detection signal, thus a simplification of photo-detection circuits (i.e., the photo-detection scanner 912, the photo-detection signal receiver 922 and the photo-detection signal holder 932), and also a reduction in power consumption, as well as the advantageous effects of the third embodiment. In the modified example 7, four photo-detection signals are added to form one photo-detection signal, and the resultant photo-detection signal is outputted to the photo-detection signal receiver 922. Therefore, the modified example 7 can also increase the amount of output signal, thus increase an S/N ratio, and thus improve detectivity.

The description has been given with regard to the modified example 7 where light beams emitted from four light-emitting cells are outputted as one photo-detection signal and the photo-detection gate lines and the data read lines are composed of only the odd-numbered photo-detection gate lines and only the odd-numbered data read lines, respectively. However, the modified example 7 is not limited to this configuration. The modified example 7 may have any other configuration, provided that it can achieve a simplification of the photo-detection circuits and a reduction in power consumption. For example, the photo-detection gate lines and the data read lines may be composed of only the even-numbered photo-detection gate lines and only the even-numbered data read lines, respectively. For example, light beams emitted from six or nine light-emitting cells may be outputted as one photo-detection signal.

### MODIFIED EXAMPLE 8

Next, the description is given with regard to a modified example 8. In the modified example 8, the third embodiment is adapted so that the photo-detection cells CR in themselves are thinned out relative to the light-emitting cells CW.

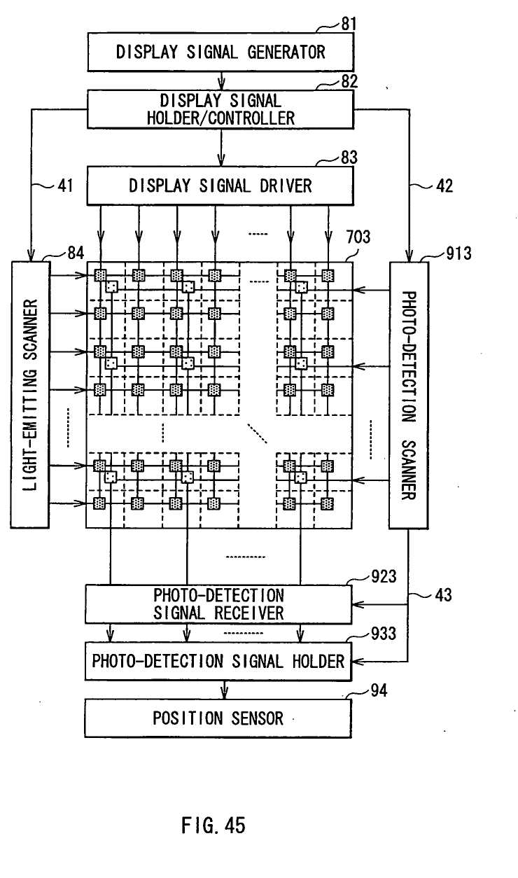

FIG. 45 shows the general configuration of an image display device according to the modified example 8. In FIG. 45, the same structural components as the components shown in FIG. 26 are designated by the same reference characters, and the description of the same components is appropriately omitted. The image display device of the modified example 8 includes a display 703, a display signal generator 81, a display signal holder/controller 82, a display signal driver 83, a light-emitting scanner 84, a photo-detection scanner 913, a photo-detection signal receiver 923, a photo-detection signal holder 933, and a position sensor 94. In short, the display 703, the photo-detection scanner 913, the photo-detection signal receiver 923 and the photo-detection signal holder 933 replace the display 7, the photo-detection scanner 91, the photo-detection signal receiver 92 and the photo-detection signal holder 93, respectively, of the third embodiment shown in FIG. 26.

The display 703 is the same as the display 7 in that the display 703 has a matrix of a plurality of picture elements 71 over the whole surface and provides display of a predetermined graphic or character image or other images while performing line-sequential operation. The display 703 is different from the display 7 in that the photo-detection cells CR in themselves are thinned out relative to the light-emitting cells CW. Specifically, one photo-detection cell CR is provided for four light-emitting cells CW.

The photo-detection scanner 913 is the same as the photo-detection scanner 91 in that the photo-detection scanner 913 has the function of selecting the photo-detection cell CR to be driven in accordance with the photo-detection timing control signal 42 outputted by the display signal holder/controller 82. The photo-detection scanner 913 is different from the photo-detection scanner 91 in that the number of photo-detection gate lines GR is correspondingly reduced by half because the photo-detection cells CR disposed on the display 703 are thinned out relative to the light-emitting cells CW as mentioned above. As will be specifically described later, the light-emitting scanner 84 scans the light-emitting gate lines GW, namely, from GW1 to GWn, as in the case of the third embodiment, whereas the photo-detection scanner 913 scans the photo-detection gate lines GR, namely, from GR1 to GRn-1, because of a reduction in the number of photo-detection gate lines by half. In this instance, the photo-detection gate lines are composed of only the odd-numbered photo-detection gate lines as in the case of the modified example 7 as mentioned above, and n denotes an even number as in the case of the modified examples 6 and 7. Likewise, j denotes an odd number for the sake of convenience.

The photo-detection signal receiver 923 is the same as the photo-detection signal receiver 92 in that the photo-detection signal receiver 923 has the function of obtaining the photo-detection signal for one horizontal line outputted by each photo-detection cell CR in accordance with the control signal outputted by the photo-detection scanner 913. The photo-detection signal receiver 923 is different from the photo-detection signal receiver 92 in that the number of data read lines DR is correspondingly reduced by half because of the configuration of the display 703. Specifically, the data read lines DR include the data read lines from DR1 to DRm-1 because of a reduction in the number of data read lines by half. In this instance, the data read lines include only the odd-numbered data read lines as mentioned above, and m denotes an even number. For the sake of convenience, i denotes an odd number as in the case of j.

The photo-detection signal holder 933 has the same function as the photo-detection signal holder 93. Specifically, upon receipt of the photo-detection signal outputted by the photo-detection signal receiver 923, the photo-detection signal holder 933 reconfigures the photo-detection signal to form a photo-detection signal for each frame in accordance with the photo-detection block control signal 43 outputted by the photo-detection scanner 913, and then stores and holds the photo-detection signal for each frame. The photo-detection signal holder 933 is different from the photo-detection signal holder 93 in that the number of storage devices is reduced and thus the holder 933 is simplified, because of a reduction in the number of data read lines DR by half due to the configuration of the display 703.

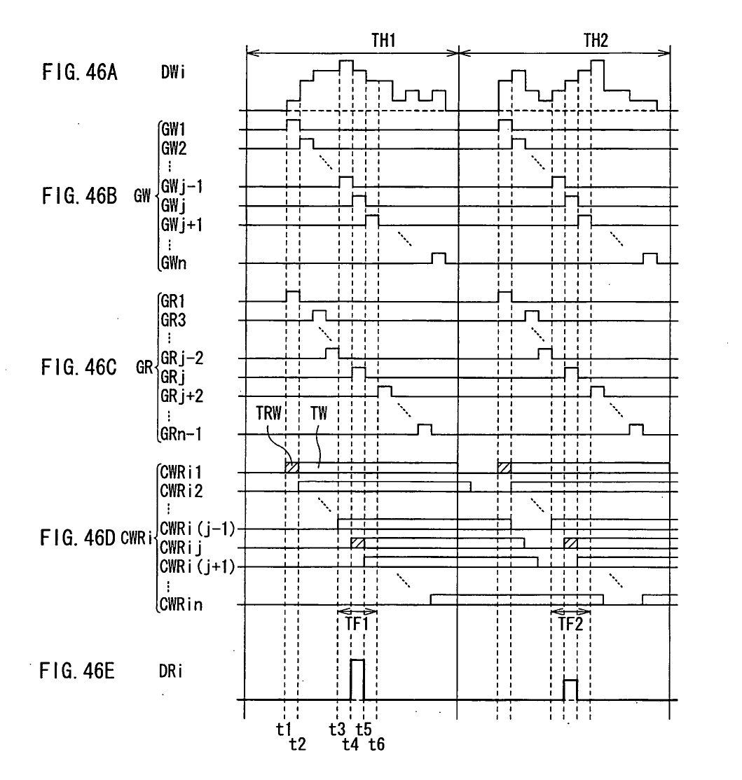

FIGS. 46A to 46E show a process for detecting the target object 75, which is executed by the image display device shown in FIG. 45. Since the basic operation of a method of driving an image display device of the modified example 8 is the same as that of the method of driving an image display device of the third embodiment, the description of the basic operation is omitted, and the description is given with regard to only operation associated with the display 703, the photo-detection scanner 913, the photo-detection signal receiver 923 and the photo-detection signal holder 933.

As shown in FIGS. 46A to 46E, the operation of the modified example 8 is basically the same as the operation shown in FIGS. 40A to 40E. The reason is as follows. In the example shown in FIGS. 40A to 40E, thinned-out scanning takes place to scan the photo-detection gate lines GR, and in the modified example 8, the photo-detection gate lines GR in themselves are thinned out. Thus, the data read line also provides thinned-out output according to the photo-detection gate lines GR. Thus, the modified example 8 can reduce the amount of data of the photo-detection signal, as in the case of the example shown in FIGS. 40A to 40E.

As described above, according to the image display device and the method of driving an image display device of the modified example 8, the photo-detection cells CR in themselves are thinned out relative to the light-emitting cells CW. Thus, the modified example 8 can achieve a reduction in the amount of data of the photo-detection signal, thus a simplification of photo-detection circuits (i.e., the photo-detection scanner 913, the photo-detection signal receiver 923 and the photo-detection signal holder 933), and also a reduction in power consumption, as well as the advantageous effects of the third embodiment.

The description has been given with regard to the modified example 8 where one photo-detection cell CR is provided for four light-emitting cells CW and the photo-detection gate lines and the data read lines include only the odd-numbered photo-detection gate lines and only the odd-numbered data read lines, respectively. However, the modified example 8 is not limited to this configuration. The modified example 8 may have any other configuration, provided that it can achieve a simplification of the photo-detection circuits and a reduction in power consumption. For example, the photo-detection gate lines and the data read lines may include only the even-numbered photo-detection gate lines and only the even-numbered data read lines, respectively. For example, one photo-detection cell CR may be provided for six or nine light-emitting cells CW. For example, a plurality of photo-detection cells CR, such as two or three cells CR, may be provided for four light-emitting cells CW so as to output detected photo-detection signals as one photo-detection signal. In short, the modified example 8 may be combined with the modified example 7.

### MODIFIED EXAMPLE 9

Next, the description is given with regard to a modified example 9. In the modified example 9, the third embodiment is adapted so that a plurality of photo-detection cells CR are provided for one light-emitting cell CW in contrast to the modified example 8.

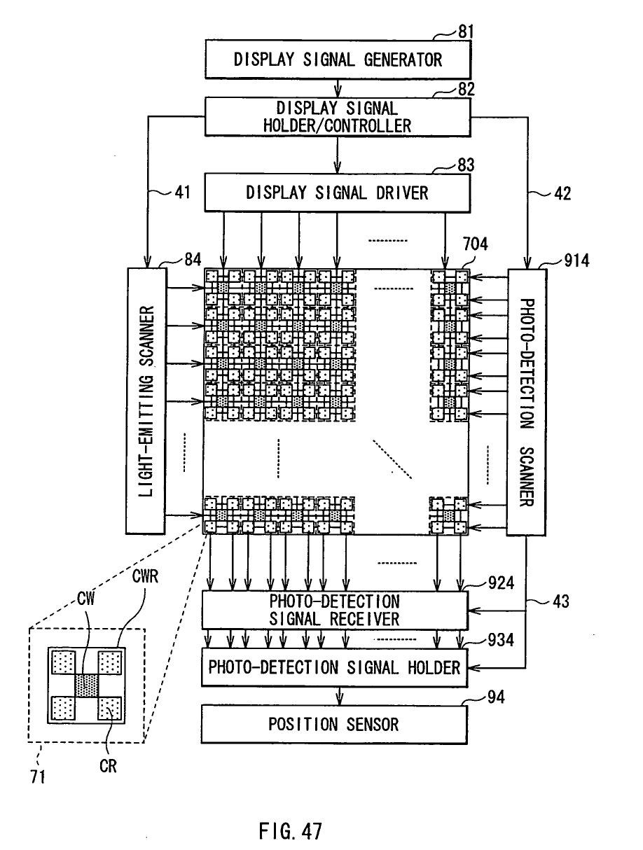

FIG. 47 shows the general configuration of an image display device according to the modified example 9. In FIG. 47, the same structural components as the components shown in FIG. 26 are designated by the same reference characters, and the description of the same components is appropriately omitted. The image display device of the modified example 9 includes a display 704, a display signal generator 81, a display signal holder/controller 82, a display signal driver 83, a light-emitting scanner 84, a photo-detection scanner 914, a photo-detection signal receiver 924, a photo-detection signal holder 934, and a position sensor 94. In short, the display 704, the photo-detection scanner 914, the photo-detection signal receiver 924 and the photo-detection signal holder 934 replace the display 7, the photo-detection scanner 91, the photo-detection signal receiver 92 and the photo-detection signal holder 93, respectively, of the third embodiment shown in FIG. 26.

The display 704 is the same as the display 7 in that the display 704 has a matrix of a plurality of picture elements 71 over the whole surface and provides display of a predetermined graphic or character image or other images while performing line-sequential operation. The display 704 is different from the display 7 in that a plurality of photo-detection cells CR are provided for one light-emitting cell CW. Specifically, four photo-detection cells CR are provided for one light-emitting cell CW.

The photo-detection scanner 914 is the same as the photo-detection scanner 91 in that the photo-detection scanner 914 has the function of selecting the photo-detection cell CR to be driven in accordance with the photo-detection timing control signal 42 outputted by the display signal holder/controller 82. The photo-detection scanner 914 is different from the photo-detection scanner 91 in that the number of photo-detection gate lines is correspondingly doubled because four photo-detection cells CR are provided for one light-emitting cell CW on the display 704 as mentioned above. As will be specifically described later, the light-emitting scanner 84 scans the light-emitting gate lines GW, namely, from GW1 to GWn, as in the case of the third embodiment, whereas the photo-detection scanner 914 scans the photo-detection gate lines GR, namely, from GR1 to GR2n, because of the doubled number of photo-detection gate lines.

The photo-detection signal receiver 924 is the same as the photo-detection signal receiver 92 in that the photo-detection signal receiver 924 has the function of obtaining the photo-detection signal for one horizontal line outputted by each photo-detection cell CR in accordance with the control signal outputted by the photo-detection scanner 914. The photo-detection signal receiver 924 is different from the photo-detection signal receiver 92 in that the number of data read lines DR is correspondingly doubled because of the configuration of the display 704. Specifically, the data read lines DR include the data read lines from DR1 to DR2m because of the doubled number of data read lines.

The photo-detection signal holder 934 has the same function as the photo-detection signal holder 93. Specifically, upon receipt of the photo-detection signal outputted by the photo-detection signal receiver 924, the photo-detection signal holder 934 reconfigures the photo-detection signal to form a photo-detection signal for each frame in accordance with the photo-detection block control signal 43 outputted by the photo-detection scanner 914, and then stores and holds the photo-detection signal for each frame. The photo-detection signal holder 934 is different from the photo-detection signal holder 93 in that the number of storage devices is increased because of the doubled number of data read lines DR due to the configuration of the display 704.

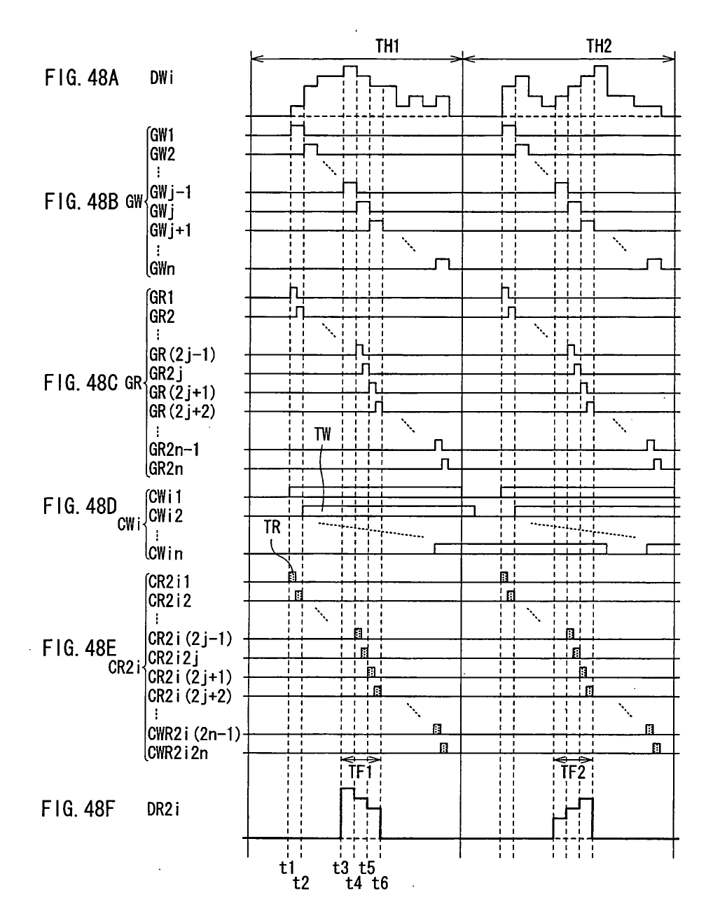

FIGS. 48A to 48F show a process for detecting the target object 75, which is executed by the image display device shown in FIG. 47. FIG. 48D shows light-emitting cells CWi (CWi1 to CWin) for one vertical line. FIG. 48E shows photo-detection cells CR2i (CR2i1 to CR2i2n) for the same vertical line. FIG. 48A shows a signal on a data feed line DWi connected to the cells CWi and CR2i. FIG. 48B shows signals on light-emitting gate lines GW (GW1 to GWn) connected to the cells CWi and CR2i. FIG. 48C shows signals on photo-detection gate lines GR (GR1 to GR2n) connected to the cells CWi and CR2i. FIG. 48F shows a signal on a data read line DR2i connected to the cells CWi and CR2i. Since the basic operation of a method of driving an image display device of the modified example 9 is the same as that of the method of driving an image display device of the third embodiment, the description of the basic operation is omitted, and the description is given with regard to only operation associated with the display 704, the photo-detection scanner 914, the photo-detection signal receiver 924 and the photo-detection signal holder 934.

As shown in FIGS. 48A to 48F and mentioned above, the light-emitting gate lines GW, namely, from GW1 to GWn (see FIG. 48B) provide output of the light-emission select signal, as in the case of the third embodiment. Because of the doubled number of photo-detection gate lines, the photo-detection gate lines GR, namely, from GR1 to GR2n (see FIG. 48C) provide output of the photo-detection select signal. Moreover, the signal pulse width of the photo-detection gate line GR (see FIG. 48C) is half that of the light-emitting gate line GW (see FIG. 48B) and that of the gate line GR of the third embodiment shown in FIG. 40C.

In the modified example 9, as shown in FIG. 47, four photo-detection cells are independently provided for one light-emitting cell so as to output four photo-detection signals to the data read lines DR. Thus, for example, during a time period between time t4 and t5, four photo-detection cells CR(2i−1)(2j−1), CR(2i−1)2j, CR2i(2j−1) and CR2i2j (see FIG. 48E) output four detected photo-detection signals to the data read lines DR(2i−1) and DR2i (see FIG. 48F). Thus, the modified example 9 can achieve a 4-times resolution to detect an object in contact with or in close proximity to the display device, as compared to the third embodiment shown in FIGS. 40A to 40E.

As described above, according to the image display device and the method of driving an image display device of the modified example 9, a plurality of photo-detection cells are provided for one light-emitting cell. Thus, the modified example 9 can achieve more accurate detection of the position of the object in contact with or in close proximity to the display device, as well as the advantageous effects of the third embodiment.

Although the description has been given with regard to the modified example 9 where four photo-detection cells CR are provided for one light-emitting cell CW, the modified example 9 is not limited to this configuration. The modified example 9 may have any other configuration, provided that it can achieve more accurate detection of the position of the object in contact with or in close proximity to the display device. For example, six or nine photo-detection cells CR may be provided for one light-emitting cell CW.

### Fourth Embodiment

Next, the description is given with regard to a fourth embodiment of the invention.

By referring to the above-mentioned third embodiment, the description has been given with regard to the image display device and the method of driving an image display device in which the light-emitting gate line GW and the photo-detection gate line GR are independently connected to each light-emitting/photo-detection cell CWR. By referring to the fourth embodiment, the description is given with regard to an image display device and a method of driving an image display device in which a common gate line G, which is a combination of the light-emitting gate line GW and the photo-detection gate line GR, is connected to each light-emitting/photo-detection cell CWR.

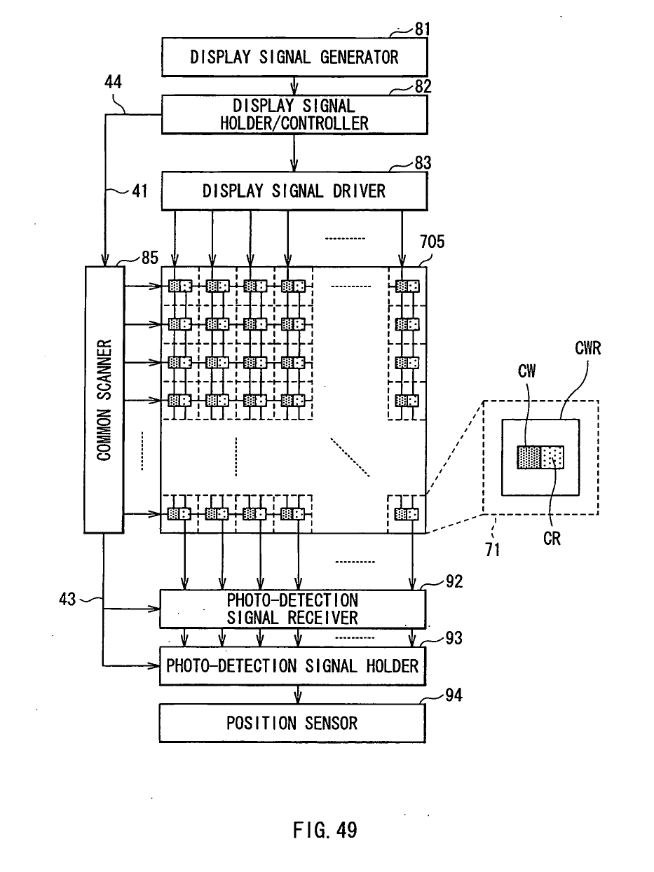

FIG. 49 shows the general configuration of an image display device according to the fourth embodiment of the invention. In FIG. 49, the same structural components as the components of the image display device according to the third embodiment shown in FIG. 26 are designated by the same reference characters, and the description of the same components is appropriately omitted. The image display device of the fourth embodiment includes a display 705, a display signal generator 81, a display signal holder/controller 82, a display signal driver 83, a common scanner 85, a photo-detection signal receiver 92, a photo-detection signal holder 93, and a position sensor 94. In short, the display 705 and the common scanner 85 replace the display 7 and the light-emitting and photo-detection scanners 84 and 91, respectively, of the third embodiment shown in FIG. 26.

The display 705 is the same as the display 7 in that the display 705 has a matrix of a plurality of picture elements 71 over the whole surface and provides display of a predetermined graphic or character image or other images while performing line-sequential operation. The display 705 is different from the display 7 in that the common gate line G, which is a combination of the light-emitting gate line GW and the photo-detection gate line GR of the third embodiment, is connected to each light-emitting/photo-detection cell CWR, as mentioned above.

The common scanner 85 has both the functions of the light-emitting gate line GW and the photo-detection gate line GR of the third embodiment. Specifically, the common scanner 85 has the function of selecting both the light-emitting cell CW to be driven and the photo-detection cell CR to be driven in accordance with a common timing control signal 44 outputted by the display signal holder/controller 82. As will be specifically described later, the common scanner 85 controls the light-emitting device selector switch and the photo-detection device selector switch by feeding a select signal via the common gate line connected to each picture element 71 of the display 705. Specifically, when the select signal is fed to apply a voltage to turn on the light-emitting device selector switch and the photo-detection device selector switch of a picture element, the picture element performs light-emitting operation with brightness according to the voltage fed from the display signal driver 83, and moreover, the picture element detects a photo-detection signal and outputs the photo-detection signal to the photo-detection signal receiver 92. The common scanner 85 also has the function of controlling as given below. The common scanner 85 outputs the photo-detection block control signal 43 to the photo-detection signal receiver 92 and the photo-detection signal holder 93 so as to control these blocks which contribute to photo-detection operation. In the image display device of the fourth embodiment, the common gate line G, which is a combination of the light-emitting gate line GW and the photo-detection gate line GR of the third embodiment, is connected to each light-emitting/photo-detection cell CWR, as mentioned above. Thus, light-emitting operation and photo-detection operation can occur in a line-sequential fashion at the same time.

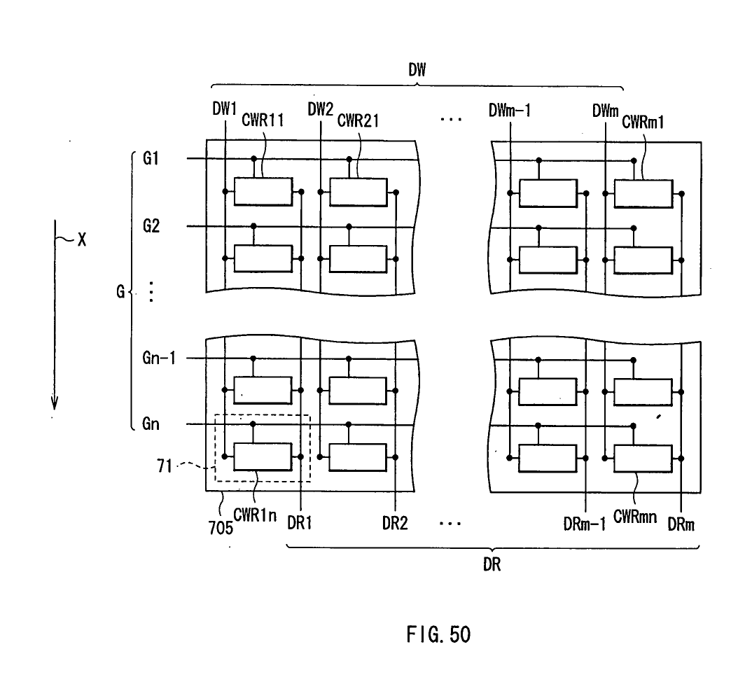

FIG. 50 shows an example of the configuration of the display 705 shown in FIG. 49. FIG. 50 corresponds to FIG. 27 for the third embodiment. The display 705 is configured to have a matrix with a total of (m×n) picture elements 71, in which m picture elements 71 are arranged along each horizontal line and n picture elements 71 are arranged along each vertical line, as in the case of the configuration shown in FIG. 27.

As shown in FIG. 50, the display 705 includes a total of (m×n) picture elements 71, light-emitting/photo-detection cells CWR11 to CWRmn as mentioned above, each of which is included in the picture element 71, m data feed lines DW (DW1 to DWm) and m data read lines DR (DR1 to DRm) which are connected to the corresponding number of picture elements 71, and n common gate lines G (G1 to Gn) connected to the corresponding number of picture elements 71.

The data feed line DW, the data read line DR and the common gate line G are connected to the display signal driver 83, the photo-detection signal receiver 92 and the common scanner 85 so that the display and select signals are fed to each light-emitting/photo-detection cell CWR and that the photo-detection signal is outputted by each light-emitting/photo-detection cell CWR. One each of the data feed line DW, the data read line DR and the common gate line G is connected to each light-emitting/photo-detection cell CWR. For example, one data feed line DW1 and one data read line DR1 are common and connected to the light-emitting/photo-detection cells from CWR11 to CWR1n belonging to one vertical line. For example, one common gate line G1 is common and connected to the light-emitting/photo-detection cells from CWR11 to CWRm1 belonging to one horizontal line.

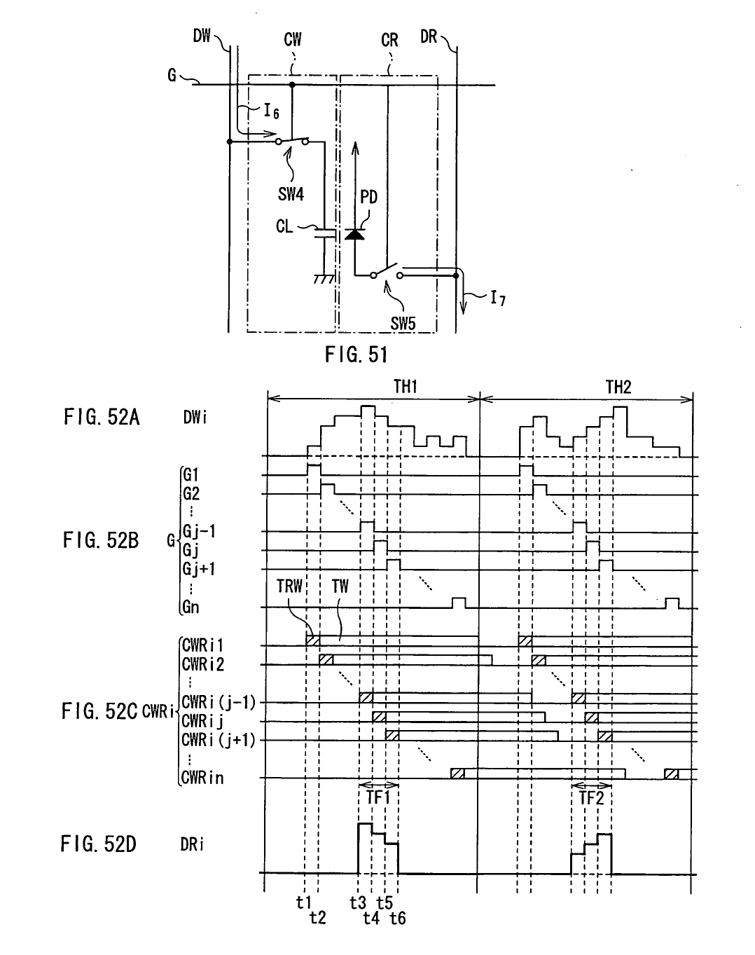

FIG. 51 shows the circuit configuration of the light-emitting/photo-detection cell CWR shown in FIG. 50. FIG. 51 corresponds to FIG. 35 for the third embodiment.

The light-emitting/photo-detection cell CWR includes one light-emitting cell CW and one photo-detection cell CR. The common gate line G is connected to the light-emitting cell CW and the photo-detection cell CR, the data feed line DW is connected to the light-emitting cell CW, and the data read line DR is connected to the photo-detection cell CR. In other words, the light-emitting/photo-detection cell CWR has an added data line for use in photo-detection, as compared to a cell for one picture element, including only a typical light-emitting cell. The light-emitting cell CW includes one light-emitting device CL, and the light-emitting device selector switch SW4 which provides selective conduction between the data feed line DW and one end of the light-emitting device CL in accordance with the select signal fed via the common gate line G. The other end of the light-emitting device CL is grounded. The photo-detection cell CR includes one photo-detection device PD, and the photo-detection device selector switch SW5 which provides selective conduction between one end of the photo-detection device PD and the data read line DR in accordance with the select signal fed via the common gate line G. The other end of the photo-detection device PD is grounded or connected to a positive bias point (not shown). In the circuit configuration of the light-emitting/photo-detection cell CWR, the gate line common to light emission and photo-detection is connected to each light-emitting/photo-detection cell CWR as mentioned above so that light-emitting operation and photo-detection operation can occur at the same time.

The specific description is now given with regard to how each component operates for light-emitting operation and photo-detection operation. The operation for light emission and photo-detection involves turning on the light-emitting device selector switch SW4 and the photo-detection device selector switch SW5 in accordance with the select signal fed via the common gate line G as described above; charging the light-emitting device CL by feeding a current along a path I6 via the data feed line DW, thereby emitting light with brightness according to the display signal (that is, light-emitting operation); and feeding a current to the data read line DR along a path I7 according to the amount of light detected by the photo-detection device PD (that is, photo-detection operation). When the common operation for light emission and photo-detection takes place, both of the light-emitting device selector switch SW4 and the photo-detection device selector switch SW5 are off so that the data feed line DW and the data read line DR are disconnected from the light-emitting device CL and the photo-detection device PD, respectively.

FIGS. 52A to 52D show a process for detecting a target object, which is executed by the image display device shown in FIG. 49. FIGS. 52A to 52D correspond to FIGS. 40A to 40E for the third embodiment. FIG. 52C shows one vertical line of light-emitting/photo-detection cells CWRi (CWRi1 to CWRin). FIG. 52A shows a signal on a data feed line DWi connected to the cells CWRi. FIG. 52B shows signals on common gate lines G (G1 to Gn) connected to the cells CWRi. FIG. 52D shows a signal on a data read line DRi connected to the cells CWRi.

The basic operation of a method of driving an image display device of the fourth embodiment is the same as that of the method of driving an image display device of the third embodiment. The fourth embodiment is different from the third embodiment in that the common gate line G is used to select both the light-emitting device CL and the photo-detection device PD simultaneously. Thus, the photo-detection signal is obtained during the photo-detection signal detection periods TF1 and TF2, resulting in detection of the presence of the target object 75 near the light-emitting/photo-detection cells CWRi(j−1), CWRij and CWRi(j+1), as in the case of the third embodiment shown in FIGS. 40A to 40E.

As described above, according to the image display device and the method of driving an image display device of the fourth embodiment, the image display device includes the display 705 having an arrangement of a plurality of light-emitting/photo-detection cells CWR, each of which has the light-emitting cell CW including one light-emitting device CL and the photo-detection cell CR including one photo-detection device PD. The common scanner 85 and the display signal driver 83 drive the light-emitting devices CL in accordance with image data generated by the display signal generator 81. The common scanner 85 also drives the photo-detection device PD to detect light emitted from the driven light-emitting device CL and reflected from the target object 75. The position sensor 94 detects the target object 75 in accordance with a photo-detection signal which the photo-detection signal receiver 92 obtains from the driven photo-detection device PD. This eliminates the need for adding a separate component such as a touch panel or an input device and thus provides a simple structure, and also eliminates the need for the passage of light emitted from the display 705 through a separate component such as a touch panel and thus prevents image degradation. Therefore, the device and the method of the fourth embodiment enable detecting an object position and the like without image degradation while ensuring a simple structure, as in the case of the device and the method of the third embodiment.

According to the image display device and the method of driving an image display device of the fourth embodiment, when a target object such as a finger is brought into contact or close proximity with the display 705, the detecting process takes place to detect its position and the like. This enables users to conveniently operate the device through the same operation as touch panel operation, as in the case of the third embodiment.

According to the image display device and the method of driving an image display device of the fourth embodiment, each light-emitting cell CW performs line-sequential light-emitting operation, and each photo-detection cell CR performs line-sequential photo-detection operation. This allows not only displaying image data by normal light-emitting operation, but also detecting an object position and the like, as in the case of the third embodiment.

According to the image display device and the method of driving an image display device of the fourth embodiment, the gate line common to light emission and photo-detection is connected to each light-emitting/photo-detection cell CWR. Thus, the image display device can perform light-emitting operation and photo-detection operation at the same time. When one data line (i.e., the data read line DR), rather than a gate line, is simply added to an image display device designed solely for normal light emission, the image display device is capable of light emission and photo-detection.

### Fifth Embodiment

Next, the description is given with regard to a fifth embodiment of the invention.

By referring to the fifth embodiment, the description is given with regard to an image display device and a method of driving an image display device in which a common data line D, which is a combination of the data feed line DW and the data read line DR, is connected to each light-emitting/photo-detection cell CWR, in addition to the configuration of the fourth embodiment.

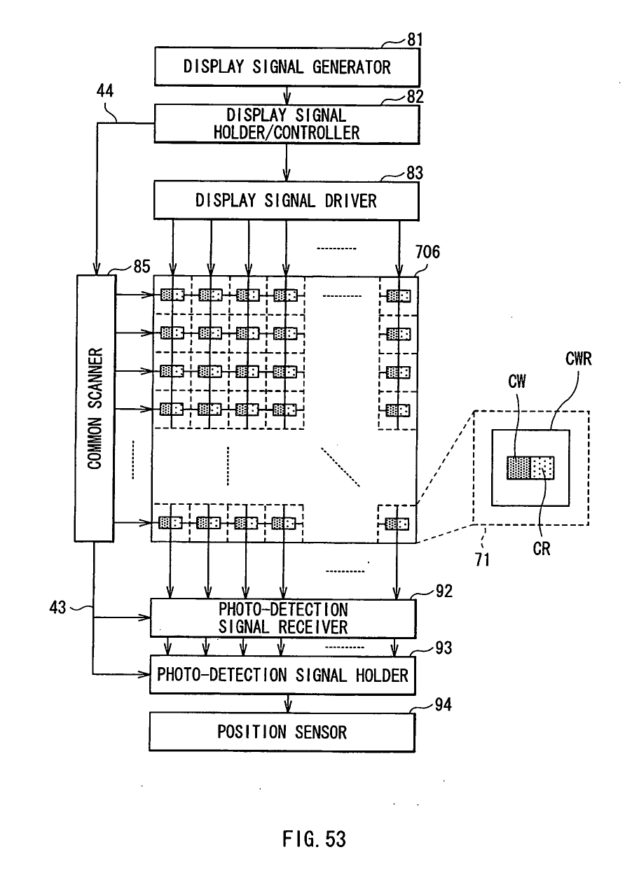

FIG. 53 shows the general configuration of an image display device according to the fifth embodiment of the invention. In FIG. 53, the same structural components as the components of the image display devices according to the third and fourth embodiments shown in FIGS. 26 and 49, respectively, are designated by the same reference characters, and the description of the same components is appropriately omitted. The image display device of the fifth embodiment includes a display 706, a display signal generator 81, a display signal holder/controller 82, a display signal driver 83, a common scanner 85, a photo-detection signal receiver 92, a photo-detection signal holder 93, and a position sensor 94. In short, the image display device includes the display 706 in place of the display 705 of the fourth embodiment shown in FIG. 49.

The display 706 is the same as the display 705 in that the display 706 has a matrix of a plurality of picture elements 71 over the whole surface and provides display of a predetermined graphic or character image or other images while performing line-sequential operation. The display 706 is different from the display 705 in that the common data line D, which is a combination of the data feed line DW and the data read line DR of the fourth embodiment, is connected to each light-emitting/photo-detection cell CWR, as mentioned above.

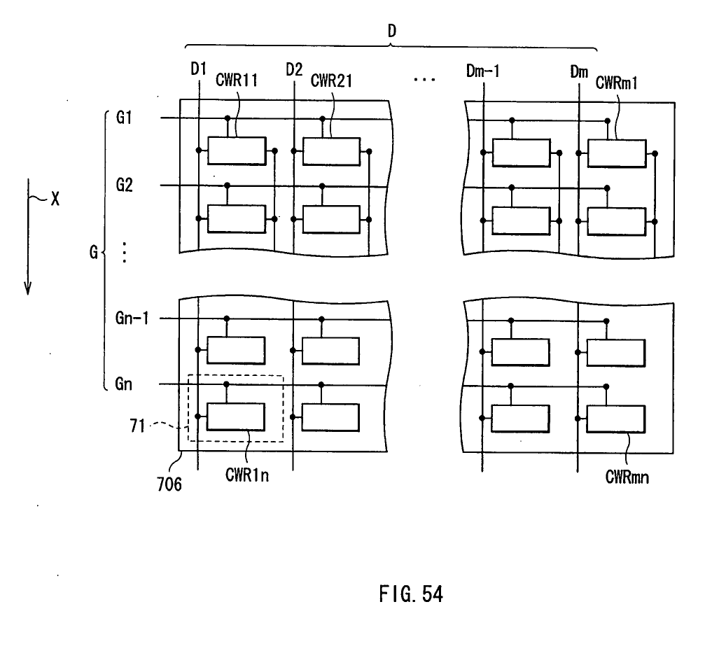

FIG. 54 shows an example of the configuration of the display 706 shown in FIG. 53. FIG. 54 corresponds to FIGS. 27 and 50 showing the third and fourth embodiments, respectively. The display 706 is configured to have a matrix with a total of (m×n) picture elements 71, in which m picture elements 71 are arranged along each horizontal line and n picture elements 71 are arranged along each vertical line, as in the case of the configurations shown in FIGS. 27 and 50.

As shown in FIG. 54, the display 706 includes a total of (m×n) picture elements 71, light-emitting/photo-detection cells CWR11 to CWRmn as mentioned above, each of which is included in the picture element 71, m common data lines D (D1 to Dm) connected to the corresponding number of picture elements 71, and n common gate lines G (G1 to Gn) connected to the corresponding number of picture elements 71.

The common data line D and the common gate line G are connected to the display signal driver 83, the photo-detection signal receiver 92 and the common scanner 85 so that the display and select signals are fed to each light-emitting/photo-detection cell CWR and that the photo-detection signal is outputted by each light-emitting/photo-detection cell CWR. As shown in FIG. 54, one each of the common data line D and the common gate line G is connected to each light-emitting/photo-detection cell CWR. For example, one common data line D1 is common and connected to the light-emitting/photo-detection cells from CWR11 to CWR1n belonging to one vertical line. For example, one common gate line G1 is common and connected to the light-emitting/photo-detection cells from CWR11 to CWRm1 belonging to one horizontal line.

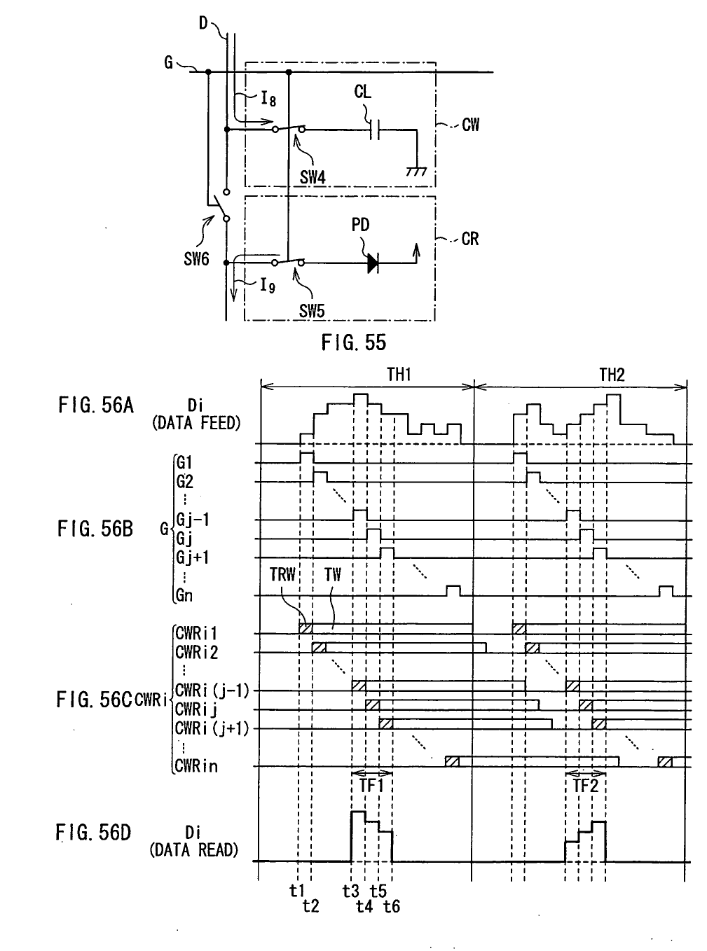

FIG. 55 shows the circuit configuration of the light-emitting/photo-detection cell CWR shown in FIG. 54. FIG. 55 corresponds to FIGS. 35 and 51 showing the third and fourth embodiments, respectively.

The light-emitting/photo-detection cell CWR includes one light-emitting cell CW and one photo-detection cell CR, and the common gate line G and the common data line D are connected to the light-emitting cell CW and the photo-detection cell CR. In other words, the light-emitting/photo-detection cell CWR has basically the same configuration as a cell for one picture element, including only a typical light-emitting cell. The light-emitting/photo-detection cell CWR further includes a selector switch SW6 which switches the common data line D between data feed mode and data read mode in accordance with the select signal fed via the common gate line G. The light-emitting cell CW includes one light-emitting device CL, and the light-emitting device selector switch SW4 which provides selective conduction between the common data line D and one end of the light-emitting device CL in accordance with the select signal fed via the common gate line G. The other end of the light-emitting device CL is grounded. The photo-detection cell CR includes one photo-detection device PD, and the photo-detection device selector switch SW5 which provides selective conduction between one end of the photo-detection device PD and the common data line D in accordance with the select signal fed via the common gate line G. The other end of the photo-detection device PD is grounded or connected to a positive bias point (not shown).

The specific description is now given with regard to how each component operates for light-emitting operation and photo-detection operation. The operation for light emission and photo-detection involves turning on the light-emitting device selector switch SW4 and the photo-detection device selector switch SW5 and turning off the selector switch SW6 in accordance with the select signal fed via the common gate line G as described above; charging the light-emitting device CL by feeding a current along a path I8 via the common data line D, thereby emitting light with brightness according to the display signal (that is, light-emitting operation); and feeding a current to the common data line D along a path I9 according to the amount of light detected by the photo-detection device PD (that is, photo-detection operation). When the common operation for light emission and photo-detection takes place, both of the light-emitting device selector switch SW4 and the photo-detection device selector switch SW5 are off and the selector switch SW6 is on so that the common data line D is disconnected from the light-emitting device CL and the photo-detection device PD.

FIGS. 56A to 56D show a process for detecting a target object 75, which is executed by the image display device shown in FIG. 53. FIGS. 56A to 56D correspond to FIGS. 40A to 40E and FIGS. 52A to 52D showing the third and fourth embodiments, respectively. FIG. 56C shows one vertical line of light-emitting/photo-detection cells CWRi (CWRi1 to CWRin). FIG. 56A shows a signal on a common data line Di (for data feed) connected to the cells CWRi. FIG. 56B shows signals on common gate lines G (G1 to Gn) connected to the cells CWRi. FIG. 56D shows a signal on a common data line Di (for data read) connected to the cells CWRi.

The basic operation of a method of driving an image display device of the fifth embodiment is the same as that of the methods of driving an image display device of the third and fourth embodiments. The fifth embodiment is different from the third and fourth embodiments in that the common gate line G is used to select both the light-emitting device CL and the photo-detection device PD simultaneously and the common data line D is used for both data feed and data read. Thus, the photo-detection signal is obtained during the photo-detection signal detection periods TF1 and TF2, resulting in detection of the presence of the target object 75 near the light-emitting/photo-detection cells CWRi(j−1), CWRij and CWRi(j+1), as in the case of the third and fourth embodiments shown in FIGS. 40A to 40E and FIGS. 52A to 52D, respectively.

As described above, according to the image display device and the method of driving an image display device of the fifth embodiment, the image display device includes the display 706 having an arrangement of a plurality of light-emitting/photo-detection cells CWR, each of which has the light-emitting cell CW including one light-emitting device CL and the photo-detection cell CR including one photo-detection device PD. The common scanner 85 and the display signal driver 83 drive the light-emitting devices CL in accordance with image data generated by the display signal generator 81. The common scanner 85 also drives the photo-detection device PD to detect light emitted from the driven light-emitting device CL and reflected from the target object 75. The position sensor 94 detects the target object 75 in accordance with a photo-detection signal which the photo-detection signal receiver 92 obtains from the driven photo-detection device PD. This eliminates the need for adding a separate component such as a touch panel or an input device and thus provides a simple structure, and also eliminates the need for the passage of light emitted from the display 706 through a separate component such as a touch panel and thus prevents image degradation. Therefore, the device and the method of the fifth embodiment enable detecting an object position and the like without image degradation while ensuring a simple structure, as in the case of the devices and the methods of the third and fourth embodiments.

According to the image display device and the method of driving an image display device of the fifth embodiment, when a target object 75 such as a finger is brought into contact or close proximity with the display 706, the detecting process takes place to detect its position and the like. This enables users to conveniently operate the device through the same operation as touch panel operation, as in the case of the third and fourth embodiments.

According to the image display device and the method of driving an image display device of the fifth embodiment, each light-emitting cell CW performs line-sequential light-emitting operation, and each photo-detection cell CR performs line-sequential photo-detection operation. This allows not only displaying image data by normal light-emitting operation, but also detecting an object position and the like, as in the case of the third and fourth embodiments.

According to the image display device and the method of driving an image display device of the fifth embodiment, the gate line and data line common to light emission and photo-detection are connected to each light-emitting/photo-detection cell CWR. Thus, the image display device can perform light-emitting operation and photo-detection operation at the same time. The image display device is capable of light emission and photo-detection, using the same configuration as an image display device designed solely for normal light emission, rather than the configuration having a connect line added thereto.

The description is given below with regard to some modified examples common to the third, fourth and fifth embodiments. Although these modified examples are applicable to any of the third, fourth and fifth embodiments, the following description is given based on the third embodiment.

### MODIFIED EXAMPLE 10

Firstly, the description is given with regard to a modified example 10 common to the third, fourth and fifth embodiments. In the modified example 10, any of the third, fourth and fifth embodiments is adapted to include a comparator 95, which is interposed between the photo-detection signal receiver 92 and the photo-detection signal holder 93. The modified example 10 corresponds to the modified example 2 common to the first and second embodiments.

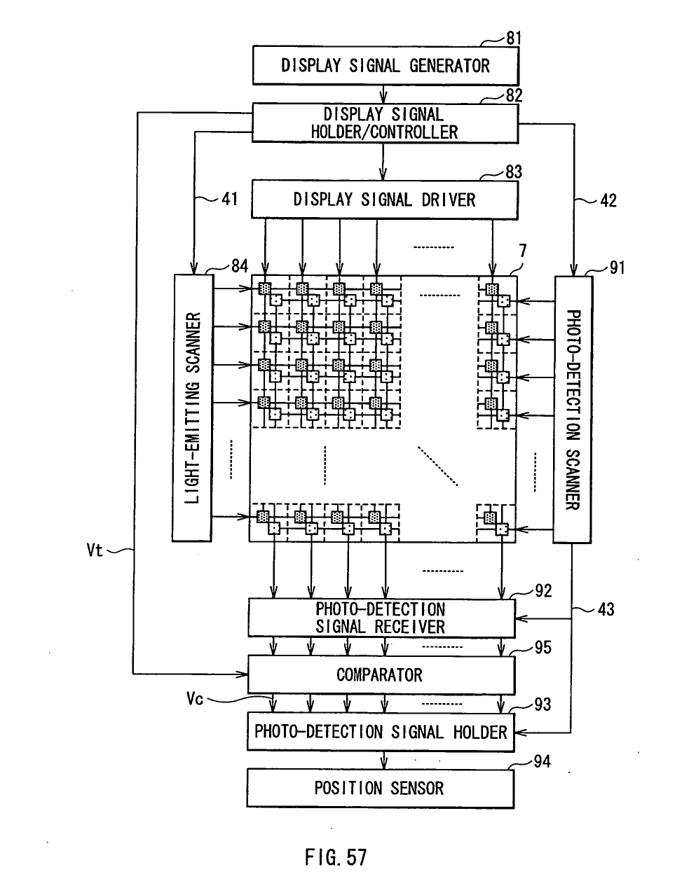

FIG. 57 shows the general configuration of an image display device according to the modified example 10. FIG. 57 corresponds to FIG. 26 for the third embodiment. In FIG. 57, the same structural components as the components shown in FIG. 26 are designated by the same reference characters, and the description of the same components is appropriately omitted. The image display device of the modified example 10 includes a display 7, a display signal generator 81, a display signal holder/controller 82, a display signal driver 83, a light-emitting scanner 84, a photo-detection scanner 91, a photo-detection signal receiver 92, a comparator 95, a photo-detection signal holder 93, and a position sensor 94.

The comparator 95 has the function of comparing and converting as given below. The comparator 95 compares the photo-detection signal outputted by the photo-detection signal receiver 92 to a threshold voltage signal Vt, which is a predetermined voltage, outputted by the display signal holder/controller 82. The comparator 95 then performs A/D conversion based on the result of comparison. As will be specifically described later, for example, the comparator 95 converts the photo-detection signal into digital data “1” when the photo-detection signal has a higher voltage than the threshold voltage signal Vt, or the comparator 95 converts the photo-detection signal into digital data “0” when the photo-detection signal has a lower voltage than the threshold voltage signal Vt. The comparator 95 outputs the digital data (i.e., a comparator output signal Vc) to the photo-detection signal holder 93.

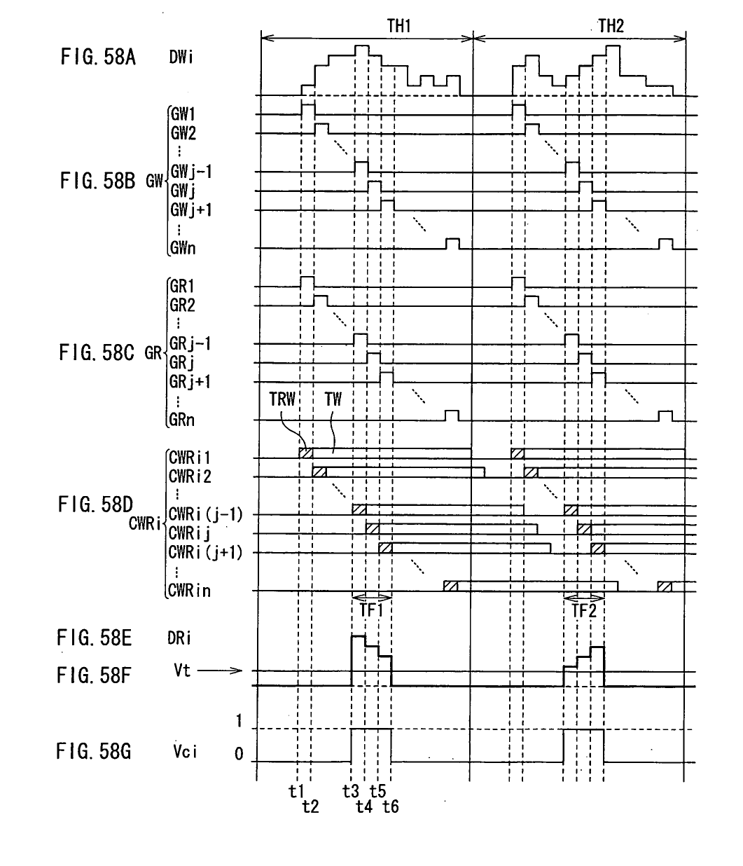

FIGS. 58A to 58G show a process for detecting a target object, which is executed by the image display device shown in FIG. 57. FIGS. 58A to 58E correspond to FIGS. 40A to 40E for the third embodiment. FIG. 58D shows one vertical line of light-emitting/photo-detection cells CWRi (CWRi1 to CWRin). FIG. 58A shows a signal on a data feed line DWi connected to the cells CWRi. FIG. 58B shows signals on light-emitting gate lines GW (GW1 to GWn) connected to the cells CWRi. FIG. 58C shows signals on signals on photo-detection gate lines GR (GR1 to GRn) connected to the cells CWRi. FIG. 58E shows a signal on a data read line DRi connected to the cells CWRi. FIG. 58F shows a threshold voltage signal Vt connected to the cells CWRi. FIG. 58G shows a comparator output signal Vci connected to the cells CWRi.

The basic operation of a method of driving an image display device of the modified example 10 is the same as that of the method of driving an image display device of the third embodiment. The modified example 10 is different from the third embodiment in the following respect. As mentioned above, the comparator 95 is interposed between the photo-detection signal receiver 92 and the photo-detection signal holder 93, so that the comparator output signal Vc is inputted as digital data to the photo-detection signal holder 93. Thus, the comparator output signal Vci (see FIG. 58G) is “1” when the amount of signal on the data read line DRi (see FIG. 58E) is larger than the predetermined threshold voltage signal Vt (see FIG. 58F), or the comparator output signal Vci (see FIG. 58G) is “0” when the amount of signal on the data read line DRi (see FIG. 58E) is smaller than the predetermined threshold voltage signal Vt (see FIG. 58F). Thus, the photo-detection signal is obtained during the photo-detection signal detection periods TF1 and TF2, as in the case of the third embodiment shown in FIG. 40D. This results in detection of the presence of the target object 15 near the light-emitting/photo-detection cells CWRi(j−1), CWRij and CWRi(j+1).

As described above, according to the image display device and the method of driving an image display device of the modified example 10, the comparator 95 is interposed between the photo-detection signal receiver 92 and the photo-detection signal holder 93, so that digital data is inputted to and handled by the photo-detection signal holder 93 and the position sensor 94. Thus, the modified example 10 can achieve a reduction in process loads on these blocks and thus a simplification of the circuit configuration and a reduction in power consumption, as well as the advantageous effects of the third embodiment.

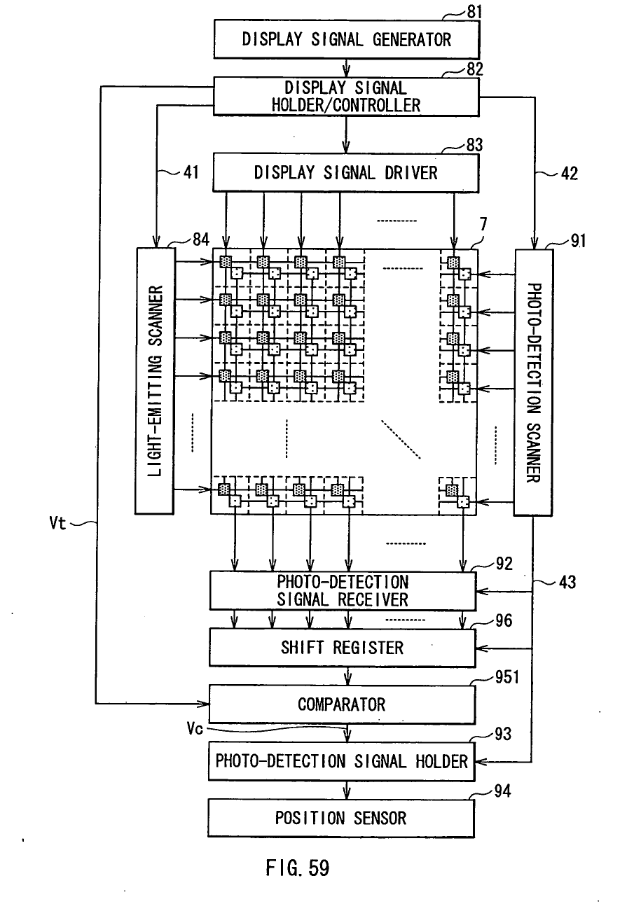

FIG. 59 shows another example of the general configuration of the image display device according to the modified example 10. In the example of FIG. 59, the modified example 10 shown in FIG. 57 is adapted to further include a shift register 96, which is interposed between the photo-detection signal receiver 92 and the comparator 95. In FIG. 59, the same structural components as the components shown in FIG. 57 are designated by the same reference characters, and the description of the same components is appropriately omitted. The image display device shown in FIG. 59 includes a display 7, a display signal generator 81, a display signal holder/controller 82, a display signal driver 83, a light-emitting scanner 84, a photo-detection scanner 91, a photo-detection signal receiver 92, a shift register 96, a comparator 951, a photo-detection signal holder 93, and a position sensor 94.

The shift register 96 has the following function. The shift register 96 selects, in order, the photo-detection signal outputted by the photo-detection signal receiver 92 in accordance with the photo-detection block control signal 43 outputted by the photo-detection scanner 91. Then, the shift register 96 performs parallel-serial conversion and outputs serial data to the comparator 951. Specifically, the shift register 96 converts the photo-detection signal, which is parallel data for m outputs, into serial data for one output, and outputs the serial data to the comparator 951. Thus, the configuration shown in FIG. 59 can reduce the number of comparators from m to 1, as compared to the configuration shown in FIG. 57.

The comparator 951 has the same function as the comparator 95. Specifically, the comparator 951 compares the photo-detection signal, which is outputted by the shift register 96 after undergoing parallel-serial conversion as mentioned above, to the threshold voltage signal Vt, which is a predetermined voltage, outputted by the display signal holder/controller 82. The comparator 951 then performs A/D conversion based on the result of comparison. The comparator 951 outputs resultant digital data (i.e., the comparator output signal Vc) to the photo-detection signal holder 93.

As described above, according to the image display device and the method of driving an image display device of the example of FIG. 59, the modified example 10 shown in FIG. 57 is adapted to further include the shift register 96, which is interposed between the photo-detection signal receiver 92 and the comparator 951. Therefore, the example of FIG. 59 can achieve a reduction in the number of comparators, thus a reduction in process loads on these blocks, and thus a further simplification of the circuit configuration and a further reduction in power consumption, as well as the advantageous effects of the modified example 10. Since the description has been given with regard to the advantageous effects of varying threshold voltages Vt by referring to the modified example 2 common to the first and second embodiments (see FIG. 16 and FIGS. 17A to 17C), the description thereof is omitted.

### MODIFIED EXAMPLE 11

Next, the description is given with regard to a modified example 11 common to the third, fourth and fifth embodiments. The amount of light reflected from an object in contact with or in close proximity to the display device is large when a large amount of light is emitted from the light-emitting cell CW, or the amount of reflected light is small when a small amount of light is emitted from the light-emitting cell CW. Thus, the photo-detection cell CR detects various amounts of photo-detection signals according to what amount of light is emitted from the light-emitting cell CW. In the modified example 11, any of the third, fourth and fifth embodiments is thus adapted to include the shift register 96, the comparator 951, and a threshold voltage generator 97, which are interposed between the photo-detection signal receiver 92 and the photo-detection signal holder 93. The threshold voltage generator 97 acts to generate the threshold voltage Vt of the comparator 951 in accordance with the display signal 45 outputted by the display signal holder/controller 82. In short, the threshold voltage generator 97 for generating the threshold voltage Vt is added to the image display device shown in FIG. 59. The modified example 11 corresponds to the modified example 3 common to the first and second embodiments.

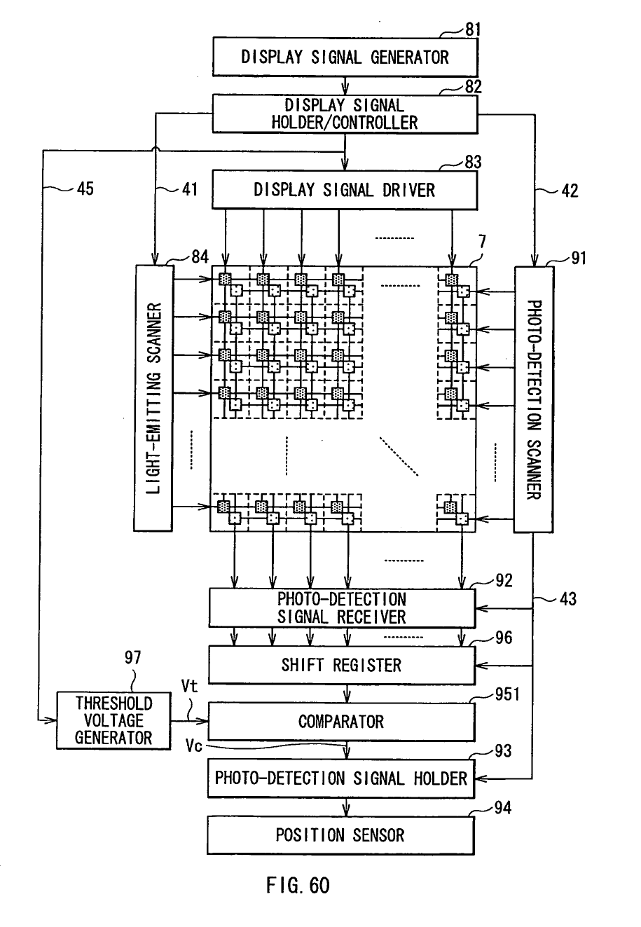

FIG. 60 shows the general configuration of an image display device according to the modified example 11. FIG. 60 corresponds to FIG. 26 for the third embodiment. In FIG. 60, the same structural components as the components shown in FIGS. 26 and 59 are designated by the same reference characters, and the description of the same components is appropriately omitted. The image display device of the modified example 11 includes a display 7, a display signal generator 81, a display signal holder/controller 82, a display signal driver 83, a light-emitting scanner 84, a photo-detection scanner 91, a photo-detection signal receiver 92, a shift register 96, a comparator 951, a threshold voltage generator 97, a photo-detection signal holder 93, and a position sensor 94.

The threshold voltage generator 97 has the following function. The threshold voltage generator 97 generates the threshold voltage Vt of the comparator 951 in accordance with the display signal 45 of each picture element 71 outputted by the display signal holder/controller 82, and outputs the threshold voltage Vt to the comparator 951. This allows the comparator 951 to set the threshold voltage Vt for each picture element according to light emitted from the light-emitting cell CW of each picture element 71.

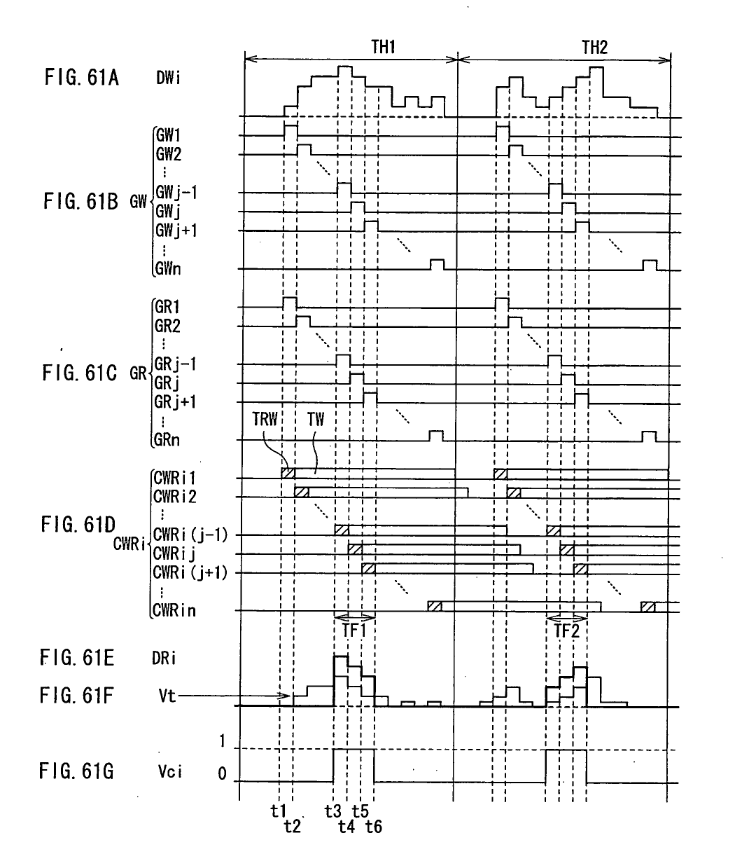

FIGS. 61A to 61G show a process for detecting a target object, which is executed by the image display device shown in FIG. 60. FIGS. 61A to 61E correspond to FIGS. 40A to 40E for the third embodiment, and FIGS. 61A to 61G correspond to FIGS. 58A to 58G for the modified example 10. FIG. 61D shows one vertical line of light-emitting/photo-detection cells CWRi (CWRi1 to CWRin), as in the case of FIG. 58D. FIG. 61A shows a signal on a data feed line DWi connected to the cells CWRi, as in the case of FIG. 58A. FIG. 61B shows signals on light-emitting gate lines GW (GW1 to GWn) connected to the cells CWRi, as in the case of FIG. 58B. FIG. 61C shows signals on photo-detection gate lines GR (GR1 to GRn) connected to the cells CWRi, as in the case of FIG. 58C. FIG. 61E shows a signal on a data read line DRi connected to the cells CWRi, as in the case of FIG. 58E. FIG. 61F shows a threshold voltage signal Vt connected to the cells CWRi, as in the case of FIG. 58F. FIG. 61G shows a comparator output signal Vci connected to the cells CWRi, as in the case of FIG. 58G. Since the basic operation of a method of driving an image display device of the modified example 11 is the same as the operation shown in FIGS. 58A to 58G, the description of the same operation is omitted, and the description is given with regard to only operation associated with the threshold voltage generator 97 and the comparator 951.

The basic operation of the method of driving an image display device of the modified example 11 is the same as that of the driving method of the modified example 10 shown in FIGS. 58A to 58G. The modified example 11 is different from the modified example 10 in that the threshold voltage generator 97 generates the threshold voltage Vt of the comparator 951 in accordance with the display signal 45 of each picture element 71 outputted by the display signal holder/controller 82, as mentioned above. Thus, in the modified example 11, the threshold voltage signal Vt is variable according to the data feed line DWi (see FIG. 61A), although the threshold voltage Vt is fixed in the modified example 10 shown in FIG. 58F. Of course, also in this case, the comparator output signal Vci (see FIG. 61G) is “1” when the amount of signal on the data read line DRi (see FIG. 61E) is larger than the predetermined threshold voltage signal Vt (see FIG. 61F), or the comparator output signal Vci (see FIG. 61G) is “0” when the amount of signal on the data read line DRi (see FIG. 61E) is smaller than the predetermined threshold voltage signal Vt (see FIG. 61F). Thus, the photo-detection signal is obtained during the photo-detection signal detection periods TF1 and TF2, as in the case of the third embodiment shown in FIG. 40D. This results in detection of the presence of the target object 75 near the light-emitting/photo-detection cells CWRi(j−1), CWRij and CWRi(j+1).

As described above, according to the image display device and the method of driving an image display device of the modified example 11, the threshold voltage generator 97 is added to the image display device shown in FIG. 59 so as to change the threshold voltage Vt of the comparator 951 according to the display signal of each picture element, specifically so as to set a high threshold voltage when the amount of light emitted from an adjacent picture element is large, or so as to set a low threshold voltage when the amount of emitted light is small. Thus, the modified example 11 can achieve more accurate detection of the position of the object in contact with or in close proximity to the display device, as well as the advantageous effects of the image display device shown in FIG. 59.

### MODIFIED EXAMPLE 12

Next, the description is given with regard to a modified example 12 common to the third, fourth and fifth embodiments. The surface of the display 7 of the image display device is irradiated with and exposed to ambient light, as well as light reflected from an object in contact with or in close proximity to the display device. In the modified example 12, any of the third, fourth and fifth embodiments is thus adapted to include the comparator 95 and a threshold voltage generator 971, which are interposed between the photo-detection signal receiver 92 and the photo-detection signal holder 93. The threshold voltage generator 971 acts to generate the threshold voltage Vt of the comparator 95 in accordance with the photo-detection signal VR outputted by the photo-detection signal receiver 92. In short, the threshold voltage generator 971 is added to the modified example 10 shown in FIG. 57 so that a process for eliminating the effect of ambient light takes place when the photo-detection device detects the photo-detection signal. The modified example 12 corresponds to the modified example 4 common to the first and second embodiments.

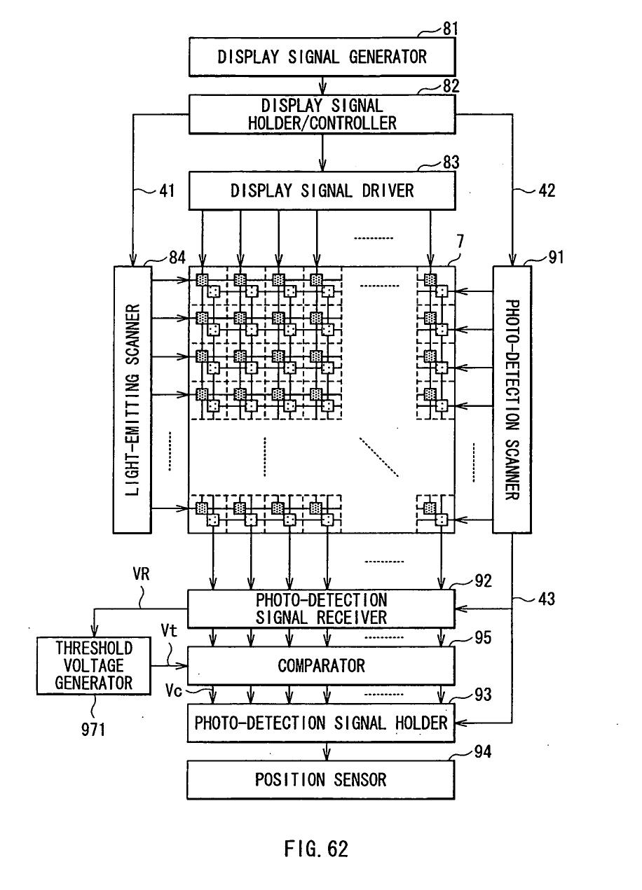

FIG. 62 shows the general configuration of an image display device according to the modified example 12. FIG. 62 corresponds to FIG. 26 for the third embodiment. In FIG. 62, the same structural components as the components shown in FIGS. 26 and 57 are designated by the same reference characters, and the description of the same components is appropriately omitted. The image display device of the modified example 12 includes a display 7, a display signal generator 81, a display signal holder/controller 82, a display signal driver 83, a light-emitting scanner 84, a photo-detection scanner 91, a photo-detection signal receiver 92, a comparator 95, a threshold voltage generator 971, a photo-detection signal holder 93, and a position sensor 94.

The threshold voltage generator 971 has the following function. The threshold voltage generator 971 generates the threshold voltage Vt of the comparator 95 in accordance with the photo-detection signal VR, outputted by the photo-detection signal receiver 92, of each of picture elements 71 constituting one horizontal line. The threshold voltage generator 971 outputs the threshold voltage Vt to the comparator 95. This allows the comparator 95 to set the threshold voltage Vt for each picture element according to light reflected onto the photo-detection cell CR of each picture element 71.

The comparator 95 has the following function. The comparator 95 compares the photo-detection signal outputted by the photo-detection signal receiver 92 to the threshold voltage signal Vt outputted by the threshold voltage generator 971, and performs A/D conversion based on the result of comparison. The comparator 95 outputs resultant digital data (i.e., the comparator output signal Vc) to the photo-detection signal holder 93.

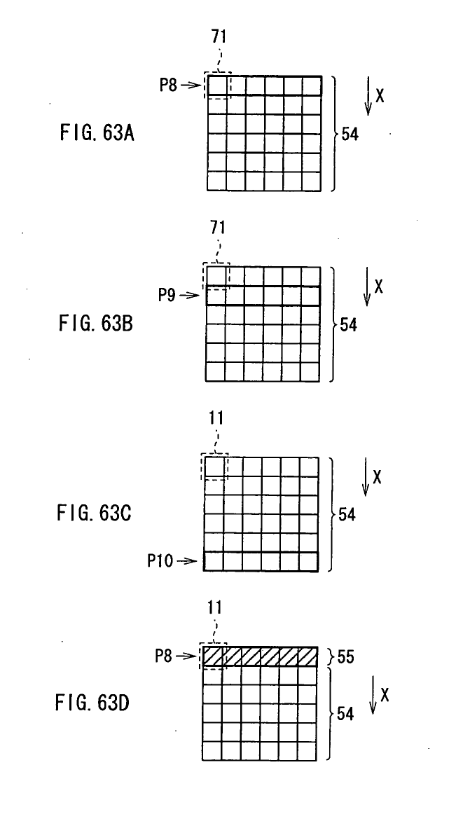

FIGS. 63A to 63D show an example of the process for eliminating the effect of ambient light, which is executed by the image display device shown in FIG. 62. This process includes processes shown in FIGS. 63A to 63D. Each of squares shown in FIGS. 63A to 63D represents the picture element 71 of the display 7, as in the case of FIGS. 37 and 38.

Referring first to FIG. 63A, the overall display 7 is preset to the black display region 54 so that the light-emitting cell CW emits light with the lowest brightness. Thus, the photo-detection cell CR detects little light emitted from the light-emitting cell CW and reflected from the object in contact with or in close proximity to the display device. During a series of processes for eliminating the effect of ambient light, an object, such as reflects light, must not be placed near the image display device so that the photo-detection cell CR detects only ambient light. Under such conditions, one horizontal line at the position indicated by the arrow P8, for example, performs line-sequential light-emitting operation and line-sequential photo-detection operation in the scan direction X, as previously mentioned.

Then, one horizontal line at the position indicated by each of the arrows P9 and P10 shown in FIGS. 63B and 63C performs line-sequential light-emitting operation and line-sequential photo-detection operation in the same manner so as to detect a screenful of light on the display 7. The photo-detection signal detected by each photo-detection cell CR is outputted to the photo-detection signal receiver 92, which then outputs the photo-detection signal VR for one horizontal line to the threshold voltage generator 971. Then, the threshold voltage generator 971 generates the threshold voltage Vt of the comparator 95 in accordance with the photo-detection signal VR and outputs the threshold voltage Vt to the comparator 95, as mentioned above.

After the completion of the process for detecting a screenful of ambient light, one horizontal line at the position indicated by the arrow P8 of FIG. 63D starts normal display operation so that the normal display region 55 is widened in the scan direction X in the same manner. The comparator 95 performs A/D conversion on the photo-detection signal of each picture element 71, using the threshold voltage Vt generated allowing for the photo-detection signal VR resulting from ambient light obtained through the processes shown in FIGS. 63A to 63C. This enables the elimination of the effect of ambient light.

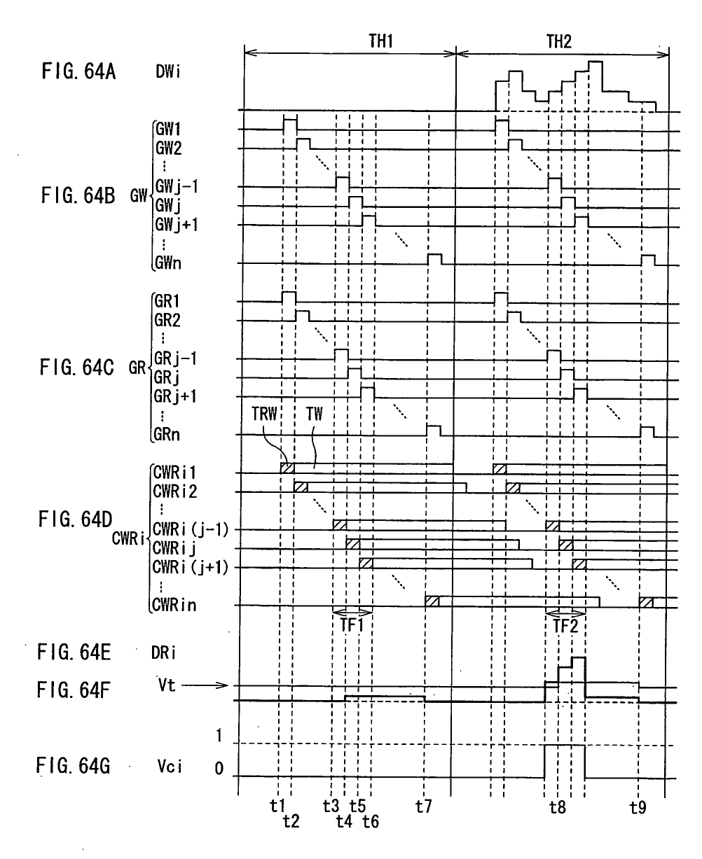

FIGS. 64A to 64G show the process for eliminating the effect of ambient light. FIGS. 64A to 64E correspond to FIGS. 40A to 40E for the third embodiment, and FIGS. 64A to 64G correspond to FIGS. 58A to 58G for the modified example 10. FIG. 64D shows one vertical line of light-emitting/photo-detection cells CWRi (CWRi1 to CWRin), as in the case of FIG. 58D. FIG. 64A shows a signal on a data feed line DWi connected to the cells CWRi, as in the case of FIG. 58A. FIG. 64B shows signals on light-emitting gate lines GW (GW1 to GWn) connected to the cells CWRi, as in the case of FIG. 58B. FIG. 64C shows signals on photo-detection gate lines GR (GR1 to GRn) connected to the cells CWRi, as in the case of FIG. 58C. FIG. 64E shows a signal on a data read line DRi connected to the cells CWRi, as in the case of FIG. 58E. FIG. 64F shows a threshold voltage signal Vt connected to the cells CWRi, as in the case of FIG. 58F. FIG. 64G shows a comparator output signal Vci connected to the cells CWRi, as in the case of FIG. 58G. Since the basic operation of a method of driving an image display device of the modified example 12 is the same as the operation shown in FIGS. 58A to 58G, the description of the same operation is omitted, and the description is given with regard to only operation associated with the threshold voltage generator 971 and the comparator 95.

In the vertical period TH1, the black display region 54 first appears throughout the display 7 as mentioned above, and thus the amount of signal on the data feed line DWi (see FIG. 64A) has the minimum value. During a time period between time t4 and t7, the photo-detection signal outputted via the data read line DRi (see FIG. 64E) is thus regarded as the photo-detection signal resulting from ambient light. During a time period between time t8 and t9 in the vertical period TH2 corresponding to the time period between time t4 and t7 in the vertical period TH1, the threshold voltage Vt is then set higher, allowing for the photo-detection signal resulting from ambient light detected in the vertical period TH1. In this manner, the threshold is set allowing for the effect of ambient light.

As described above, according to the image display device and the method of driving an image display device of the modified example 12, the threshold voltage generator 971 is added to the modified example 10 shown in FIG. 57 so that the process for eliminating the effect of ambient light takes place when the photo-detection device detects the photo-detection signal. Thus, the modified example 12 enables detection allowing for the effect of ambient light, thus achieving more accurate detection of the position of the object in contact with or in close proximity to the display device, as well as the advantageous effects of the modified example 10.

Although the description has been given with regard to the modified example 12 where an original threshold voltage Vt has a fixed value, the modified example 12 may be applied to the configuration in which the threshold voltage Vt has a variable value generated according to the display signal 45 as in the case of the modified example 11 shown in FIG. 60 and FIGS. 61A to 61G. In this case, the threshold voltage Vt is generated according to both the display signal 45 and the photo-detection signal VR.

### MODIFIED EXAMPLE 13

Next, the description is given with regard to a modified example 13 common to the third, fourth and fifth embodiments. In the modified example 13, the image display device is adapted to detect a plurality of objects placed simultaneously at arbitrary positions and also to detect an object at any position which is arbitrarily shifted. The modified example 13 corresponds to the modified example 5 common to the first and second embodiments.

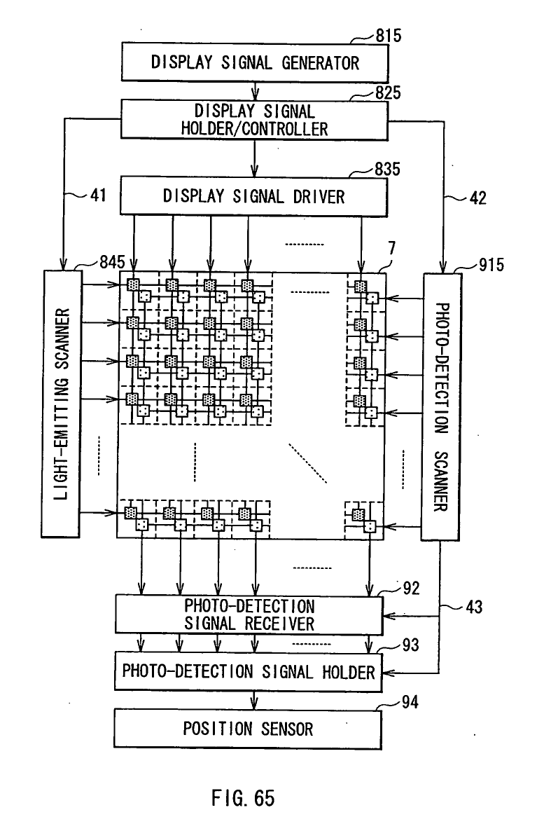

FIG. 65 shows the general configuration of an image display device according to the modified example 13. FIG. 65 corresponds to FIG. 26 for the third embodiment. In FIG. 65, the same structural components as the components shown in FIG. 26 are designated by the same reference characters, and the description of the same components is appropriately omitted. The image display device of the modified example 13 includes a display 7, a display signal generator 815, a display signal holder/controller 825, a display signal driver 835, a light-emitting scanner 845, a photo-detection scanner 915, a photo-detection signal receiver 92, a photo-detection signal holder 93, and a position sensor 94.

The description of the same operations is omitted because the basic operations of the display signal generator 815, the display signal holder/controller 825, the display signal driver 835, the light-emitting scanner 845 and the photo-detection scanner 915 are the same as those of the display signal generator 81, the display signal holder/controller 82, the display signal driver 83, the light-emitting scanner 84 and the photo-detection scanner 91 shown in FIG. 26.

The display signal generator 815 further has the following function. The display signal generator 815 replaces part of input image data with mark data for displaying a predetermined mark and superimposes the image data on a display signal, as will be described later. The display signal holder/controller 825, the display signal driver 835, the light-emitting scanner 845 and the photo-detection scanner 915 operate so that the light-emitting cell CW emits light according to the mark data and the photo-detection cell CR in the light-emitting/photo-detection cell CWR corresponding to the position of the light-emitting cell CW detects the emitted light and detects a photo-detection signal. In this manner, an object in contact with or in close proximity to the display device can be detected in a region where the predetermined mark is displayed.

In the modified example 13, light emitted from the light-emitting cell CW of the display 7 is used as a light source for use in detection of reflected light. Thus, light reflected from an object in contact with or in close proximity to the display device can be detected at any position on the display 7. The modified example 13 can achieve advantageous effects comparable to those of a touch panel, for example when button-like images composed of the predetermined marks 61 to 64 are displayed at arbitrary positions on the display 7 as previously mentioned (see FIGS. 24 and 25) so that light reflected from the object is detected in each mark region. The modified example 13 also enables detection of the positions of a plurality of objects placed simultaneously, because detection of an object position occurs based on the photo-detection signal reconfigured by the photo-detection signal holder 93. This enables users to detect a plurality of objects in contact with or in close proximity to the display device, which are placed simultaneously at arbitrary positions on the image display device.

When the input image data is moving image data composed of a plurality of frames, the display signal generator 815 replaces part of the input image data with mark data at positions varying among frames according to the moving image data, thereby enabling a button-like portion to move, appear on a moving image portion, or appear or disappear as needed.

This enables users to detect an object in contact with or in close proximity to the display device at any position which is arbitrarily shifted on the image display device. Incidentally, the display signal generator 815 determines what type of image is displayed. Thus, when the button-like images composed of the predetermined marks are not displayed, users may avoid using position-detection-processed data in order to prevent erroneous detection.

It should be understood by those skilled in the art that various modifications, combinations, sub-combinations and alterations may occur depending on design requirements and other factors insofar as they are within the scope of the appended claims or the equivalents thereof.

1. An image display device comprising:
a plurality of light-emitting/photo-detection devices each having both light-emitting and photo-detection functions;
light-emission driving means for driving the light-emitting/photo-detection devices for light emission in accordance with image data;
photo-detection driving means for driving one or more light-emitting/photo-detection devices for photo-detection, other than a light-emitting/photo-detection device which is emitting light in accordance with the image data, so that the one or more light-emitting/photo-detection devices detect light emitted from the light-emitting/photo-detection device and reflected from a target object; and
detecting means for detecting the target object in accordance with one or more photo-detection signals obtained from the one or more light-emitting/photo-detection devices.

2. An image display device according to claim 1, wherein the detecting means detects at least either the position or size of the target object in accordance with the photo-detection signal.

3. An image display device according to claim 1, wherein the detecting means detects a plurality of target objects, which are placed simultaneously, in accordance with the photo-detection signal.

4. An image display device according to claim 1, wherein the detecting means sets a threshold according to the contents of a displayed image, and detects the target object by comparing the photo-detection signal to the threshold.

5. An image display device according to claim 1, wherein the detecting means sets a threshold according to the properties of the target object or the purpose of detection or accuracy of detection, and detects the target object by comparing the photo-detection signal to the threshold.

6. An image display device according to claim 1, wherein the detecting means determines the intensity of ambient light in accordance with one or more photo-detection signals, which are obtained from one or more light-emitting/photo-detection devices, other than one or more light-emitting/photo-detection devices which are emitting light, when black display occurs in the absence of the target object near the light-emitting/photo-detection devices, and the detecting means performs detection of the target object, allowing for the effect of the ambient light.

7. An image display device according to claim 1, wherein the plurality of light-emitting/photo-detection devices are arranged to form a matrix,
the light-emission driving means drives the plurality of light-emitting/photo-detection devices in a line-sequential fashion, and
the photo-detection driving means drives light-emitting/photo-detection devices, other than the light-emitting/photo-detection devices which are emitting light, in a line-sequential fashion in synchronization with line-sequential light-emitting operation of the light-emitting/photo-detection devices.

8. An image display device according to claim 7, wherein the photo-detection driving means drives the light-emitting/photo-detection device located at the corresponding position belonging to a line next to a line including the light-emitting/photo-detection device under light-emitting operation.

9. An image display device according to claim 7, wherein the light-emission driving means drives the light-emitting/photo-detection devices belonging to two lines adjacent to both sides of a line including the light-emitting/photo-detection devices driven by the photo-detection driving means.

10. An image display device according to claim 1, wherein the light-emitting/photo-detection device is an organic EL device.

11. An image display device according to claim 1, wherein the light-emission driving means and the photo-detection driving means drive each light-emitting/photo-detection device so that light-emitting operation of one light-emitting/photo-detection device corresponds to photo-detection operation of another light-emitting/photo-detection device.

12. An image display device according to claim 1, wherein the light-emission driving means and the photo-detection driving means drive each light-emitting/photo-detection device so that light-emitting operation of a plurality of light-emitting/photo-detection devices corresponds to photo-detection operation of another light-emitting/photo-detection device.

13. An image display device according to claim 1, wherein each light-emitting/photo-detection device has connections to:
a light-emitting gate line for selecting the light-emitting/photo-detection device to be driven;
a data feed line for feeding the image data to the light-emitting/photo-detection device;
a data read line for reading out the photo-detection signal from the light-emitting/photo-detection device; and
a switch line for switching the driving mode of the light-emitting/photo-detection device between light emission mode and photo-detection mode.

14. An image display device according to claim 13, further comprising, for each of the light-emitting/photo-detection devices:
a capacitor;
a first switch which provides selective conduction between the data feed line and one end of the capacitor in accordance with a select signal fed via the light-emitting gate line;
a second switch which provides selective conduction between the other end of the capacitor and the light-emitting/photo-detection device in accordance with a switch signal fed via the switch line; and
a third switch which provides selective conduction between the light-emitting/photo-detection device and the data read line in accordance with the switch signal.

15. An image display device according to claim 14, wherein the capacitor keeps each light-emitting/photo-detection device driven for light emission until immediately before the start of driving for photo-detection.

16. An image display device according to claim 1, further comprising image superimposing means for replacing part of input image data with mark data for displaying a predetermined mark, thereby superimposing the image data,
wherein the light-emission driving means and the photo-detection driving means drive each of the light-emitting/photo-detection devices so that one or more light beams emitted from one or more light-emitting/photo-detection devices driven according to the mark data of the image data are detected by one or more light-emitting/photo-detection devices located corresponding to the one or more light-emitting/photo-detection devices driven according to the mark data, and
the detecting means detects whether or not the target object is close to the displayed mark in accordance with one or more photo-detection signals obtained from the one or more light-emitting/photo-detection devices which detect the one or more light beams emitted from the one or more light-emitting/photo-detection devices driven according to the mark data.

17. An image display device according to claim 16, wherein the image superimposing means replaces part of the input image data with mark data for displaying the marks at a plurality of positions, and
the detecting means detects which mark of the marks displayed at the plurality of positions is close to the target object, in accordance with the one or more photo-detection signals obtained from the one or more light-emitting/photo-detection devices which detect the one or more light beams emitted from the one or more light-emitting/photo-detection devices driven according to the mark data.

18. An image display device according to claim 16, wherein the input image data is moving image data composed of a plurality of frames, and the image superimposing means replaces part of the input image data with the mark data for each frame.

19. An image display device according to claim 18, wherein the image superimposing means replaces part of the input image data with the mark data at positions varying among frames.

20. An image display device according to claim 19, wherein the image superimposing means replaces part of the input image data with the mark data at positions varying among frames according to the contents of the input image data.

21. A method of driving an image display device, including:
arranging a plurality of light-emitting/photo-detection devices each having both light-emitting and photo-detection functions;
driving the light-emitting/photo-detection devices for light emission in accordance with image data;
driving one or more light-emitting/photo-detection devices for photo-detection, other than a light-emitting/photo-detection device which is emitting light in accordance with the image data, so that the one or more light-emitting/photo-detection devices detect light emitted from the light-emitting/photo-detection device and reflected from a target object; and
detecting the target object in accordance with one or more photo-detection signals obtained from the one or more light-emitting/photo-detection devices.

22. An image display device comprising:
a plurality of light-emitting devices;
a plurality of photo-detection devices;
light-emission driving means for driving the light-emitting devices in accordance with image data;
photo-detection driving means for driving the photo-detection devices so as to detect light emitted from one or more light-emitting devices and reflected from a target object; and
detecting means for detecting the target object in accordance with one or more photo-detection signals obtained from one or more photo-detection devices.

23. An image display device according to claim 22, wherein the detecting means detects at least either the position or size of the target object in accordance with the photo-detection signal.

24. An image display device according to claim 22, wherein the detecting means detects a plurality of target objects, which are placed simultaneously, in accordance with the photo-detection signal.

25. An image display device according to claim 22, wherein the detecting means sets a threshold according to the contents of a displayed image, and detects the target object by comparing the photo-detection signal to the threshold.

26. An image display device according to claim 22, wherein the detecting means sets a threshold according to the properties of the target object or the purpose of detection or accuracy of detection, and detects the target object by comparing the photo-detection signal to the threshold.

27. An image display device according to claim 22, wherein the detecting means determines the intensity of ambient light in accordance with one or more photo-detection signals which are obtained from one or more photo-detection devices when black display occurs in the absence of the target object near the photo-detection devices, and the detecting means performs detection of the target object, allowing for the effect of the ambient light.

28. An image display device according to claim 22, wherein the plurality of light-emitting devices are arranged to form a matrix,
the plurality of photo-detection devices are arranged to form a matrix,
the light-emission driving means drives the plurality of light-emitting devices in a line-sequential fashion, and
the photo-detection driving means drives the plurality of photo-detection devices in a line-sequential fashion in synchronization with the line-sequential light-emitting operation of the plurality of light-emitting devices.

29. An image display device according to claim 22, wherein the light-emitting device is a liquid crystal device.

30. An image display device according to claim 29, wherein the photo-detection device is separated by a partition from the liquid crystal device.

31. An image display device according to claim 29, wherein the liquid crystal device includes a pair of transparent substrates facing each other, and a liquid crystal layer sandwiched in between the transparent substrates, and
the photo-detection device is disposed within the liquid crystal layer.

32. An image display device according to claim 31, wherein the photo-detection device is disposed on the transparent substrate through which display light exits.

33. An image display device according to claim 29, further comprising a backlighting light source which is used to emit backlight, which passes through the liquid crystal device and is outputted as display light,
the liquid crystal device includes a pair of transparent substrates facing each other, and a liquid crystal layer sandwiched in between the transparent substrates, and
a shield is disposed between the photo-detection device and the transparent substrate facing the backlighting light source.

34. An image display device according to claim 22, wherein each light-emitting device and each photo-detection device are arranged in a one-to-one correspondence with each other, and a pair of the light-emitting device and the photo-detection device configures one light-emitting/photo-detection cell.

35. An image display device according to claim 34, wherein the light-emission driving means and the photo-detection driving means drive each light-emitting device and each photo-detection device so that the light-emitting device and the photo-detection device of each light-emitting/photo-detection cell operate in a one-to-one correspondence with each other.

36. An image display device according to claim 34, wherein the light-emission driving means and the photo-detection driving means drive each light-emitting device and each photo-detection device so that the photo-detection device of one light-emitting/photo-detection cell performs photo-detection driving in accordance with the driving of the light-emitting devices of a plurality of light-emitting/photo-detection cells.

37. An image display device according to claim 34, wherein each light-emitting/photo-detection cell has connections to:
a light-emitting gate line for selecting the light-emitting device to be driven;
a photo-detection gate line for selecting the photo-detection device to be driven;
a data feed line for feeding the image data to the light-emitting device; and
a data read line for reading out the photo-detection signal from the photo-detection device.

38. An image display device according to claim 37, further comprising, for each of the light-emitting/photo-detection cells:
a light-emitting device selector switch which provides selective conduction between the data feed line and the light-emitting device in accordance with a light-emission select signal fed via the light-emitting gate line; and
a photo-detection device selector switch which provides selective conduction between the photo-detection device and the data read line in accordance with a photo-detection select signal fed via the photo-detection gate line,
wherein the light-emission driving means and the photo-detection driving means actuate the light-emitting device selector switch and the photo-detection device selector switch in different timings.

39. An image display device according to claim 34, wherein each light-emitting/photo-detection cell has connections to:
a common gate line for selecting the light-emitting device to be driven and the photo-detection device to be driven;
a data feed line for feeding the image data to the light-emitting device; and
a data read line for reading out the photo-detection signal from the photo-detection device.

40. An image display device according to claim 39, further comprising, for each of the light-emitting/photo-detection cells:
a light-emitting device selector switch which provides selective conduction between the data feed line and the light-emitting device in accordance with a select signal fed via the common gate line; and
a photo-detection device selector switch which provides selective conduction between the photo-detection device and the data read line in accordance with a select signal fed via the common gate line,
wherein the light-emission driving means and the photo-detection driving means actuate the light-emitting device selector switch and the photo-detection device selector switch in the same timing.

41. An image display device according to claim 34, wherein each light-emitting/photo-detection cell has connections to:
a common gate line for selecting the light-emitting device to be driven and the photo-detection device to be driven; and
a common data line for feeding the image data to the light-emitting device and reading out the photo-detection signal from the photo-detection device.

42. An image display device according to claim 41, further comprising, for each of the light-emitting/photo-detection cells:
a selector switch which switches the common data line between data feed mode and data read mode in accordance with a select signal fed via the common gate line;
a light-emitting device selector switch which provides selective conduction between the common data line and the light-emitting device in accordance with a select signal fed via the common gate line; and
a photo-detection device selector switch which provides selective conduction between the photo-detection device and the common data line in accordance with a select signal fed via the common gate line,
wherein the light-emission driving means and the photo-detection driving means actuate the selector switch, the light-emitting device selector switch, and the photo-detection device selector switch in the same timing.

43. An image display device according to claim 22, wherein one or more photo-detection devices are provided for a plurality of light-emitting devices,
the light-emission driving means and the photo-detection driving means drive each light-emitting device and each photo-detection device so that the one or more photo-detection devices detect display light obtained by driving the light-emitting devices and reflected from the target object and generate one photo-detection signal.

44. An image display device according to claim 22, wherein a plurality of photo-detection devices are provided for one light-emitting device,
the light-emission driving means and the photo-detection driving means drive each light-emitting device and each photo-detection device so that the plurality of photo-detection devices detect display light obtained by driving the one light-emitting device and reflected from the target object and generate a plurality of photo-detection signals.

45. An image display device according to claim 22, further comprising image superimposing means for replacing part of input image data with mark data for displaying a predetermined mark, thereby superimposing the image data,
wherein the light-emission driving means and the photo-detection driving means drive each light-emitting device and each photo-detection device so that one or more light beams emitted from one or more light-emitting devices driven according to the mark data of the image data are detected by one or more photo-detection devices located corresponding to the one or more light-emitting devices, and
the detecting means detects whether or not the target object is close to the displayed mark in accordance with one or more photo-detection signals obtained from the one or more photo-detection devices which detect the one or more light beams emitted from the one or more light-emitting devices driven according to the mark data.

46. An image display device according to claim 45, wherein the image superimposing means replaces part of the input image data with mark data for displaying the marks at a plurality of positions, and
the detecting means detects which mark of the marks displayed at the plurality of positions is close to the target object, in accordance with the one or more photo-detection signals obtained from the one or more photo-detection devices which detect the one or more light beams emitted from the one or more light-emitting devices driven according to the mark data.

47. An image display device according to claim 45, wherein the input image data is moving image data composed of a plurality of frames, and the image superimposing means replaces part of the input image data with the mark data for each frame.

48. An image display device according to claim 47, wherein the image superimposing means replaces part of the input image data with the mark data at positions varying among frames.

49. An image display device according to claim 48, wherein the image superimposing means replaces part of the input image data with the mark data at positions varying among frames according to the contents of the input image data.

50. A method of driving an image display device, comprising:
arranging a plurality of light-emitting devices and a plurality of photo-detection devices;
driving the light-emitting devices in accordance with image data;
driving the photo-detection devices so as to detect light emitted from one or more light-emitting devices and reflected from a target object; and
detecting the target object in accordance with one or more photo-detection signals obtained from one or more photo-detection devices.

51. An image display device comprising:
a plurality of light-emitting/photo-detection devices each having both light-emitting and photo-detection functions;
light-emission driving section driving the light-emitting/photo-detection devices for light emission in accordance with image data;
photo-detection driving section driving one or more light-emitting/photo-detection devices for photo-detection, other than a light-emitting/photo-detection device which is emitting light in accordance with the image data, so that the one or more light-emitting/photo-detection devices detect light emitted from the light-emitting/photo-detection device and reflected from a target object; and
detecting section detecting the target object in accordance with one or more photo-detection signals obtained from the one or more light-emitting/photo-detection devices.

52. An image display device comprising:
a plurality of light-emitting devices;
a plurality of photo-detection devices;
light-emission driving section driving the light-emitting devices in accordance with image data;
photo-detection driving section driving the photo-detection devices so as to detect light emitted from one or more light-emitting devices and reflected from a target object; and
detecting section detecting the target object in accordance with one or more photo-detection signals obtained from one or more photo-detection devices.
